(19) United States
(12) Patent Application Publication
(10) Pub. No.: US 2026/0279312 A1
(43) Pub. Date: Sep. 17, 2026

(54) STRINGED MUSICAL INSTRUMENT WITH FRETTING APPENDAGE

(71) Applicant: Polyphonic Chromaticism, Inc., Sandstone, MN (US)

(72) Inventor: Benjamin M. RANSON, Sandstone, MN (US)

(21) Appl. No.: 19/571,195

(22) Filed: Mar. 18, 2026

Related U.S. Application Data
(63) Continuation of application No. PCT/US26/18991, filed on Mar. 12, 2026.
(60) Provisional application No. 63/856,176, filed on Aug. 1, 2025.
(60) Provisional application No. 63/856,170, filed on Aug. 1, 2025.
(60) Provisional application No. 63/771,375, filed on Mar. 13, 2025.

(51) Int. Cl. G10D 3/147; G10D 1/08; G10D 3/04; G10D 3/06; G10D 3/12

(52) U.S. Cl. CPC G10D 3/147; G10D 1/08; G10D 3/04; G10D 3/06; G10D 3/12

(57) ABSTRACT

A fretting appendage with a string contactable fretting crown is coupled to a body of a stringed musical instrument. The fretting crown is positioned under a string between a saddle and a neck of the stringed musical instrument. A player uses the wrist of the picking hand to depress the string between the saddle and the fretting crown until the string contacts the fretting crown. A length of the string extending from the fretting crown to a nut on the neck may be sounded by plucking with the thumb of the picking hand.

### CROSS-REFERENCE TO RELATED APPLICATIONS

The entire contents of the following application are incorporated by reference herein: U.S. Provisional Patent Application No. 63/771,375; filed Mar. 13, 2025; and entitled COUNTER-FRETTING DEVICES AND METHODS.

The entire contents of the following application are incorporated by reference herein: U.S. Provisional Patent Application No. 63/856,170; filed Aug. 1, 2025; and entitled WRIST FRETTING ASSEMBLIES AND STRINGED MUSICAL INSTRUMENTS.

The entire contents of the following application are incorporated by reference herein: U.S. Provisional Patent Application No. 63/856,176; filed Aug. 1, 2025; and entitled FRET APPENDAGE.

The entire contents of the following application are incorporated by reference herein: PCT Application No. PCT/US2026/018991; filed Mar. 12, 2026; and entitled STRINGED MUSICAL INSTRUMENT WITH FRETTING APPENDAGE.

### BACKGROUND

### Technical Field

The present disclosure relates to a stringed musical instrument.

### Description of Related Art

A guitar includes a neck, a body, and strings. Frets are located on a fingerboard connected to the neck. The pitch of a string may be changed by depressing the string against a fingerboard fret with the fretting hand. This action is called fretting.

A player uses the fretting hand to fret along the neck, and uses the picking hand to pluck a string near the body. Fretting shortens the sounding length of the string in one direction; the end of the sounding length at the bridge stays the same, while the location of the end of the sounding length opposite the bridge is changed. As the fretting hand moves toward the body, the pitches of fretted fingerboard notes get higher.

A player may fret multiple fretted fingerboard notes with the fretting hand. Note combinations and articulation are constrained by the physical challenge of fretting multiple strings and by the limited number of open notes.

The most common forms of the guitar are unchanged since the 1960s. As a consequence of the unchanged form of the instrument, the techniques of the guitar and bass guitar have advanced little since the 1970s.

The styles of guitar performance developed in the mid twentieth century rely on open strings. However, open notes available on open strings are of little use in some keys, and retuning strings to alter open notes is impractical while playing. Thus, fretting hand position forms a longstanding technical barrier which prevents the use of some combinations of notes, restricts the range of chords, and limits expression during polyphonic play.

### SUMMARY

Included in the present disclosure is a stringed musical instrument including a body. In some embodiments, the stringed musical instrument includes a neck including a longitudinally rearward end connected to the body and a longitudinally forward end located away from the body. According to some embodiments, the stringed musical instrument includes a fingerboard connected to the neck. The stringed musical instrument may include a sequence of fingerboard frets on the fingerboard. In some embodiments, the stringed musical instrument includes a nut disposed on the longitudinally forward end of the neck. According to some embodiments, the stringed musical instrument includes a saddle means positioned on the body. The stringed musical instrument may include a proto string contacting the nut, extending above the fingerboard, and contacting the saddle means. In some embodiments, the stringed musical instrument includes a deutero string contacting the nut, extending above the fingerboard, and contacting the saddle means. The deutero string may be laterally spaced from and consecutive to the proto string. According to some embodiments, the stringed musical instrument includes a laterally proximal block having a first fretting crown. The laterally proximal block may be adjustably positionable on the body such that i) the first fretting crown is longitudinally forward of the saddle means, ii) the first fretting crown is under the proto string, and iii) the first fretting crown is positionable to define a wrist fretable note a semitone above an open note of the proto string. In some embodiments, the stringed musical instrument includes a laterally distal block including a second fretting crown. According to some embodiments, the laterally distal block is adjustably positionable on the body such that i) the second fretting crown is longitudinally forward of the saddle means, ii) the second fretting crown is under the deutero string, and iii) the second fretting crown is positionable to define a wrist fretable note a semitone above an open note of the deutero string.

A longitudinal position of the laterally proximal block may be adjustable relative to the saddle means and relative to the laterally distal block. In some embodiments, a vertical position of the first fretting crown is adjustable relative to the proto string and relative to the laterally distal block.

According to some embodiments, the stringed musical instrument further includes a fastener configured to lock the longitudinal position of the laterally proximal block. The stringed musical instrument may include a fastener configured to lock the vertical position of the first fretting crown. In some embodiments, the stringed musical instrument further includes a height screw configured to adjust the vertical position of the first fretting crown.

According to some embodiments, the body is hollow and includes a soundboard. The laterally proximal block may be configured to couple to the soundboard. In some embodiments, the laterally distal block is configured to couple to the soundboard.

According to some embodiments, the first fretting crown is oriented at a first fingerboard matching angle that matches a first fingerboard angle relative to the proto string. The second fretting crown may be oriented at a second fingerboard matching angle that matches a second fingerboard angle relative to the deutero string.

Also included in the present disclosure is a method, performable by a human, of sounding a note on a stringed musical instrument. In some embodiments, the method includes providing the stringed musical instrument. According to some embodiments, the stringed musical instrument includes: a body; a neck including a longitudinally rearward end connected to the body and a longitudinally forward end located away from the body; a fingerboard connected to the neck; a sequence of fingerboard frets on the fingerboard; a nut disposed on the longitudinally forward end of the neck; a saddle means positioned on the body; and a plurality of laterally spaced strings contacting the nut, extending above the fingerboard, and contacting the saddle means. The method may include coupling a fretting appendage including a fretting crown to the body, with the fretting crown disposed under a proto string of the plurality of strings, such that a longitudinal position of the fretting crown is adjustable relative to the saddle means. In some embodiments, the method includes adjusting the longitudinal position of the fretting crown such that the fretting crown defines a wrist fretable note above an open note of the proto string. According to some embodiments, the method includes positioning a pisiform bone wrist area of a picking hand above the proto string, between the saddle means and the fretting crown. The method may include directly contacting the proto string with the pisiform bone wrist area. In some embodiments, the method includes depressing the proto string with the pisiform bone wrist area until the proto string contacts the fretting crown. According to some embodiments, the method includes plucking the proto string with a first digit of the picking hand, at a location longitudinally forward of the fretting crown.

The method may further include depressing a deutero string of the plurality of strings against a fingerboard fret of the sequence of fingerboard frets with a first digit of a fretting hand. In some embodiments, the method further includes plucking the deutero string with a second digit of the picking hand.

Also included in the present disclosure is a stringed musical instrument, including a body. In some embodiments, the stringed musical instrument includes a neck including a longitudinally rearward end connected to the body and a longitudinally forward end located away from the body. According to some embodiments, the stringed musical instrument includes a fingerboard connected to the neck. The stringed musical instrument may include a sequence of fingerboard frets on the fingerboard. In some embodiments, the stringed musical instrument includes a nut disposed on the longitudinally forward end of the neck. According to some embodiments, the stringed musical instrument includes a saddle means positioned on the body. The stringed musical instrument may include a laterally spaced plurality of strings contacting the nut, extending above the fingerboard, and contacting the saddle means. In some embodiments, the stringed musical instrument includes a pickup coupled to the body. The pickup may have a laterally proximal coil and a laterally distal coil. According to some embodiments, the stringed musical instrument includes a fretting appendage having a fretting crown. The pickup may be positioned i) on the body, ii) longitudinally forward of the saddle means, iii) with at least a portion of the pickup within 70 millimeters (mm) of the saddle means, iv) with the laterally proximal coil under a laterally outermost proximal string of the plurality of strings, v) with the laterally distal coil under a laterally outermost distal string of the plurality of strings, and vi) such that a distance from the nut to the laterally proximal coil is less than a distance from the nut to the laterally distal coil. In some embodiments, the fretting appendage is adjustably positionable on the body i) with the fretting crown longitudinally forward of the saddle means, ii) with the fretting crown longitudinally rearward of the proximal coil, iii) with the fretting crown laterally proximal to the laterally distal coil, iv) with the fretting crown under the laterally outermost proximal string, and v) such that the fretting crown is configurable to define a wrist fretable note a semitone above an open note of the laterally outermost proximal string.

According to some embodiments, a longitudinal position of the fretting appendage is adjustable relative to the saddle means, and a vertical position of the fretting crown is adjustable relative to the laterally outermost proximal string.

Also included in the present disclosure is an assembly for a stringed musical instrument, including a first fretting appendage and a saddle means, both of which may be coupled to a common support. In some embodiments, the first fretting appendage includes a first fretting crown. According to some embodiments, the support is coupleable to a body of the stringed musical instrument. A vertical position of the first fretting crown may be adjustable relative to the support. In some embodiments, the saddle means is configured to direct a proto string of the stringed musical instrument at a wrist fretable vertical distance above the first fretting crown, toward a neck of the stringed musical instrument connected to the body of the stringed musical instrument.

According to some embodiments, the assembly further includes a height screw configured to adjust the vertical position of the fretting crown. The support may include a pickup opening. In some embodiments, the fretting appendage is configured to couple to the support between the saddle means and the pickup opening. According to some embodiments, a position of the first fretting crown is adjustable towards and away from the saddle means. The assembly may include a fastener configured to couple the fretting appendage to the support. In some embodiments, the assembly includes a fastener configured to lock the vertical position of the first fretting crown. According to some embodiments, the saddle means is configured to adjust a position of a critical contact point of the proto string on the saddle means relative to the support.

The assembly may further include a second fretting appendage coupled to the support. In some embodiments, the second fretting appendage includes a second fretting crown. According to some embodiments, a vertical position of the second fretting crown is adjustable relative to the support. The saddle means may be further configured to direct a deutero string of the stringed musical instrument at a wrist fretable vertical distance above the second fretting crown, toward the neck of the stringed musical instrument. In some embodiments, the deutero string of the stringed musical instrument is laterally spaced from the proto string of the stringed musical instrument.

Also included in the present disclosure is a stringed musical instrument including a body. In some embodiments, the stringed musical instrument includes a neck having a longitudinally rearward end connected to the body and a longitudinally forward end located away from the body. According to some embodiments, the stringed musical instrument includes a fingerboard connected to the neck. The stringed musical instrument may include a sequence of fingerboard frets on the fingerboard. In some embodiments, the stringed musical instrument includes a nut disposed on the longitudinally forward end of the neck. According to some embodiments, the stringed musical instrument includes a saddle means positioned on the body. The stringed musical instrument may include a fretting appendage, including a fretting crown. In some embodiments, the fretting appendage is adjustably positionable on the body. According to some embodiments, the stringed musical instrument includes a proto string contacting the nut, extending above the fingerboard and the fretting crown, and contacting the saddle means. The stringed musical instrument may include a deutero string contacting the nut, extending above the fingerboard, and contacting the saddle means. In some embodiments, the deutero string is consecutive to and laterally spaced from the proto string. According to some embodiments, a vertical position of the fretting crown is adjustable relative to the proto string. The fretting crown may be positionable to define a wrist fretable note above an open note of the proto string. In some embodiments, a first lateral side of the fretting appendage is laterally between the proto string and the deutero string.

According to some embodiments, the stringed musical instrument further includes a trito string. The trito string may contact the nut, extend above the fingerboard, and contact the saddle means. In some embodiments, the trito string is consecutive to and laterally spaced from the proto string. According to some embodiments, the deutero string is laterally proximal to the proto string. The trito string may be laterally distal to the proto string. In some embodiments, the fretting appendage further includes a second lateral side. According to some embodiments, the second lateral side of the fretting appendage is laterally between the trito string and the proto string.

A longitudinal position of the fretting appendage may be adjustable relative to the saddle means. In some embodiments, the stringed musical instrument includes a fastener configured to lock the vertical position of the fretting crown. According to some embodiments, the stringed musical instrument further includes a height screw configured to adjust the vertical position of the fretting crown. The body may be hollow and include a soundboard. In some embodiments, the fretting appendage is coupled to the soundboard.

According to some embodiments, the fretting crown is positionable to define a wrist fretable note a semitone above an open note of the proto string. The stringed musical instrument may include a fastener configured to couple the fretting appendage to the body.

Also included in the present disclosure is a stringed musical instrument including a body having a cavity therewithin. In some embodiments, the stringed musical instrument includes a neck having a longitudinally rearward end connected to the body and a longitudinally forward end located away from the body. According to some embodiments, the stringed musical instrument includes a fingerboard connected to the neck. The stringed musical instrument may include a sequence of fingerboard frets on the fingerboard. In some embodiments, the stringed musical instrument includes a nut disposed on the longitudinally forward end of the neck. According to some embodiments, the stringed musical instrument includes a support coupled to the body. The stringed musical instrument may include a block having a fretting crown. In some embodiments, the block is adjustably coupled to the support. According to some embodiments, the stringed musical instrument includes a string contacting the nut, extending above the fingerboard and the fretting crown, and coupling to the body. A vertical position of the fretting crown may be adjustable relative to the string. In some embodiments, the fretting crown is positionable to define a wrist fretable note above an open note of the string. According to some embodiments, an aperture to the cavity of the body provides access to the support for positional adjustment of the fretting crown.

The stringed musical instrument may further include a height screw configured to adjust a vertical position of the fretting crown. In some embodiments, the aperture to the cavity of the body provides access to the height screw. According to some embodiments, the stringed musical instrument includes a fastener configured to couple the block to the support. The aperture to the cavity of the body may provide access to the fastener. In some embodiments, the fretting crown is positionable to define a wrist fretable note a semitone above an open note of the string.

Also included in the present disclosure is a stringed musical instrument including a body. In some embodiments, the stringed musical instrument includes a neck having a longitudinally rearward end connected to the body and a longitudinally forward end located away from the body. According to some embodiments, the stringed musical instrument includes a fingerboard connected to the neck. The stringed musical instrument may include a sequence of fingerboard frets on the fingerboard. In some embodiments, the stringed musical instrument includes a nut disposed on the longitudinally forward end of the neck. According to some embodiments, the stringed musical instrument includes a saddle means positioned on the body. The stringed musical instrument may include a block having a fretting crown. In some embodiments, the stringed musical instrument includes a plurality of strings, each i) contacting the nut, ii) extending above the fingerboard, and iii) contacting the saddle means. According to some embodiments, the plurality of strings are laterally spaced from one another. A lateral string spacing may be defined by a spacing, at the saddle means, between two consecutive strings of the plurality of strings. In some embodiments, the block is adjustably positionable on the body, with the fretting crown disposed i) longitudinally forward of the saddle means and ii) under a proto string of the plurality of strings. According to some embodiments, a longitudinal position of the block is adjustable relative to the saddle means. The block may have a lateral width less than 200% of the lateral string spacing. In some embodiments, the block is positionable such that the fretting crown is configured to define a wrist fretable note a semitone above an open note of the proto string.

According to some embodiments, the stringed musical instrument further includes a support coupled to the body and an insert connected to the support. The block may further include a slot configured to receive the insert. In some embodiments, with the insert inserted in the slot, the longitudinal position of the block is adjustable by manipulating the block, via the slot, along the insert.

According to some embodiments, the stringed musical instrument further includes a support coupled to the body. The support may include a substantially longitudinal slot. In some embodiments, the longitudinal position of the block is adjustable by manipulating the block along the slot. According to some embodiments, the body is hollow and includes a soundboard. The block may be configured to couple to the soundboard. In some embodiments, a vertical position of the fretting crown is adjustable relative to the proto string.

According to some embodiments, the stringed musical instrument further includes a height screw configured to adjust a vertical position of the fretting crown relative to the proto string. The block may further include a pivot longitudinally spaced from the fretting crown. In some embodiments, a vertical position of the fretting crown is adjustable relative to the proto string by pivoting the block on the pivot. The pivot may be located longitudinally between the fretting crown and the saddle means. In some embodiments, the pivot is located longitudinally between the fretting crown and the neck. According to some embodiments, the height screw is configured to pivot the block on the pivot.

The stringed musical instrument may further include a shim configured to adjust a vertical position of the fretting crown relative to the body. In some embodiments, the shim is coupled to the body under the block.

According to some embodiments, the stringed musical instrument further includes a fastener configured to lock the longitudinal position of the block. The stringed musical instrument may include a fastener configured to lock the vertical position of the fretting crown. In some embodiments, the stringed musical instrument includes a fastener configured to couple the block to the body.

Also included in the present disclosure is an assembly for a guitar, including a block having a fretting end and a pivot longitudinally spaced from the fretting end. In some embodiments, the block is adjustably positionable on a body of the guitar with the fretting end under a longitudinally extending string of the guitar that is coupled to the body of the guitar. According to some embodiments, a vertical position of the fretting end is adjustable relative to the string of the guitar by pivoting the block on the pivot. The fretting end may be positionable at a wrist fretable vertical distance under the string of the guitar.

In some embodiments, the assembly further includes a height screw configured to pivot the block on the pivot. According to some embodiments, a longitudinal position of the block is adjustable relative to the body of the guitar. The assembly may include a fastener configured to lock the vertical position of the fretting end. In some embodiments, the assembly includes a fastener configured to couple the block to the body of the guitar.

Also included in the present disclosure is an assembly for a guitar, including a support coupleable to a body of the guitar. In some embodiments, the assembly includes a block adjustably coupleable to the support. According to some embodiments, the block includes a fretting end and a pivot. The assembly may include a height screw extending between the block and the support. In some embodiments, the support is configured to dispose the block on the body of the guitar, under a string of the guitar, wherein the string is coupled to the body of the guitar. According to some embodiments, the height screw is configured to adjust a vertical position of the fretting end relative to the support and relative to the string of the guitar by pivoting the block on the pivot. The fretting end may be positionable at a wrist fretable vertical distance under the string of the guitar.

In some embodiments, a position of the block is adjustable on the support in a direction that the string of the guitar extends. According to some embodiments, the support further includes a height adjustment hole disposed under the block. The height screw may be configured to insert into the height adjustment hole and to adjust the vertical position of the fretting end by pushing against a downward surface of the block.

In some embodiments, the block includes a height adjustment hole disposed above the support. According to some embodiments, the height screw is configured to insert into the height adjustment hole and to adjust the vertical position of the fretting end by pushing against the support. The assembly may include a fastener configured to couple the block to the support.

Also included in the present disclosure is a stringed musical instrument including a body. In some embodiments, the stringed musical instrument includes a neck having a longitudinally rearward end connected to the body and a longitudinally forward end located away from the body. According to some embodiments, the stringed musical instrument includes a fingerboard connected to the neck. The stringed musical instrument may include a sequence of fingerboard frets on the fingerboard. In some embodiments, the stringed musical instrument includes a nut disposed on the longitudinally forward end of the neck. According to some embodiments, the stringed musical instrument includes a saddle means positioned on the body. The stringed musical instrument may include a block having a fretting end. According to some embodiments, the block is adjustably positionable on the body. In some embodiments, the stringed musical instrument includes a string contacting the nut, extending above the fingerboard and the fretting end, and contacting the saddle means. According to some embodiments, the stringed musical instrument includes a height screw configured to adjust a vertical position of the fretting end. Turning the height screw in a first direction may adjust the vertical position of the fretting end upward, moving the fretting end toward the string. Turning the height screw in a second direction may adjust the vertical position of the fretting end downward, moving the fretting end away from the string. According to some embodiments, a longitudinal position of the block is adjustable relative to the saddle means. The height screw may be configured to support the vertical position of the fretting end during adjustment of the longitudinal position of the block. In some embodiments, the fretting end is positionable to define a wrist fretable note a semitone above an open note of the string.

According to some embodiments, the stringed musical instrument further includes a support coupled to the body. The block may further include a height adjustment hole disposed above the support. In some embodiments, the height screw is configured to insert into the height adjustment hole and to adjust the vertical position of the fretting end by pushing against the support.

According to some embodiments, the stringed musical instrument further includes a support coupled to the body. The support may include a height adjustment hole disposed under the block. In some embodiments, the height screw is configured to insert into the height adjustment hole and to adjust the vertical position of the fretting end by pushing against a downward surface of the block.

According to some embodiments, the stringed musical instrument further includes a support. The stringed musical instrument may further include an insert connected to the support. In some embodiments, the support is coupled to the body. According to some embodiments, the block further includes a slot configured to receive the insert. With the insert inserted in the slot, the longitudinal position of the block may be adjustable by manipulating the block, via the slot, along the insert.

In some embodiments, the stringed musical instrument further includes a support coupled to the body. According to some embodiments, the support includes a substantially longitudinal slot. The longitudinal position of the block may be adjustable by manipulating the block along the slot. In some embodiments, the slot is centered under the string.

According to some embodiments, the block further includes a pivot longitudinally spaced from the fretting end. The height screw may be configured to adjust the vertical position of the fretting end by pivoting the block on the pivot. In some embodiments, the pivot is located longitudinally between the fretting end and the saddle means. According to some embodiments, the pivot is located longitudinally between the fretting end and the neck.

The stringed musical instrument may further include a fastener configured to lock the longitudinal position of the block and the vertical position of the fretting end. In some embodiments, the body is hollow and includes a soundboard. According to some embodiments, the block is disposed on the soundboard.

Also included in the present disclosure is an assembly for a guitar, including a block having a fretting crown. In some embodiments, the assembly includes a height screw configured to adjust a vertical position of the fretting crown. According to some embodiments, the block is adjustably positionable i) on a body of the guitar, ii) with the fretting crown under a longitudinally extending string of the guitar which connects to the body of the guitar, and iii) such that a longitudinal position of the block is adjustable relative to the string of the guitar. Turning the height screw in a first direction may adjust the vertical position of the fretting crown toward the string of the guitar. Turning the height screw in a second direction adjusts the vertical position of the fretting crown away from the string of the guitar. According to some embodiments, the height screw is configured to support the vertical position of the fretting crown during adjustment of the longitudinal position of the block. The fretting crown may be positionable at a wrist fretable vertical distance under the string of the guitar.

In some embodiments, the block further includes a pivot longitudinally spaced from the fretting crown. According to some embodiments, the height screw is configured to adjust the vertical position of the fretting crown by pivoting the block on the pivot. The assembly may include a fastener configured to lock the vertical position of the fretting crown.

In some embodiments, the assembly includes a fastener configured to lock the longitudinal position of the block. According to some embodiments, the assembly includes a fastener configured to lock the vertical position of the fretting crown.

Also included in the present disclosure is a stringed musical instrument including a body. In some embodiments, the stringed musical instrument includes a neck having a longitudinally rearward end connected to the body and a longitudinally forward end located away from the body. According to some embodiments, the stringed musical instrument includes a fingerboard connected to the neck. The stringed musical instrument may include a sequence of fingerboard frets on the fingerboard. In some embodiments, the stringed musical instrument includes a nut disposed on the longitudinally forward end of the neck. According to some embodiments, the stringed musical instrument includes a saddle means positioned on the body. The stringed musical instrument may include a block adjustably positionable on the body. In some embodiments, the block includes a fretting end and a pivot longitudinally spaced from the fretting end. According to some embodiments, the stringed musical instrument includes a string contacting the nut, extending above the fingerboard and the fretting end, and contacting the saddle means. A vertical position of the fretting end may be adjustable relative to the string by pivoting the block on the pivot. In some embodiments, the fretting end is positionable to define a wrist fretable note a semitone above an open note of the string.

According to some embodiments, the pivot is located longitudinally between the fretting end and the saddle means. In additional or alternative embodiments, the pivot is located longitudinally between the fretting end and the neck. In some embodiments, an axis of rotation of the pivot is substantially perpendicular to a direction that the string extends. According to some embodiments, the pivot is configured to support the block on the body at least at two points. In additional or alternative embodiments, the pivot is configured to support the block on the body at least at a first point. In some embodiments, the first point is within 80 millimeters (mm) of a longitudinally rearward critical contact point of the string on the saddle means. According to some embodiments, a longitudinal position of the block is adjustable relative to the saddle means. The pivot may be configured to support the block during adjustment of the longitudinal position of the block.

In some embodiments, the stringed musical instrument further includes a height screw configured to adjust the vertical position of the fretting end by pivoting the block on the pivot. According to some embodiments, the stringed musical instrument further includes a support positioned on the body. The block may further include a height adjustment hole disposed above the support. In some embodiments, the height screw is configured to insert into the height adjustment hole and adjust the vertical position of the fretting end upward by pushing against the support.

According to some embodiments, the stringed musical instrument further includes a support positioned on the body. The support may further include a height adjustment hole disposed under the block. In some embodiments, the height screw is configured to insert into the height adjustment hole and to adjust the vertical position of the fretting end upward by pushing against a downward surface of the block.

According to some embodiments, the stringed musical instrument includes a fastener configured to lock the height screw to the support. The stringed musical instrument may include a fastener configured to lock the block to the height screw.

In some embodiments, the stringed musical instrument includes a fastener configured to lock the vertical position of the fretting end. According to some embodiments, the stringed musical instrument includes a fastener configured to lock the longitudinal position of the block and the vertical position of the fretting end.

The stringed musical instrument may further include a support coupled to the body. In some embodiments, the support includes a substantially longitudinal slot. According to some embodiments, a longitudinal position of the block is adjustable by manipulating the block along the slot.

The stringed musical instrument may further include a support and an insert connected to the support. In some embodiments, the support is coupled to the body. According to some embodiments, the block further includes a slot configured to receive the insert. With the insert inserted in the slot, a longitudinal position of the block may be adjustable by manipulating the block, via the slot, along the insert.

In some embodiments, the slot is centered under the string. According to some embodiments, the string is a proto string, The stringed musical instrument may further include a deutero string consecutive to and laterally spaced from the proto string. In some embodiments, the deutero string contacts the nut and extends above the fingerboard to the saddle means. According to some embodiments, the slot is laterally between the proto string and the deutero string.

The string may be a proto string. In some embodiments, the stringed musical instrument further includes a deutero string consecutive to and laterally spaced from the proto string. According to some embodiments, the deutero string contacts the nut and extends above the fingerboard to the saddle means. A first lateral side of the block may be laterally between the proto string and the deutero string.

Also included in the present disclosure is a stringed musical instrument, including a body. In some embodiments, the stringed musical instrument includes a neck having a longitudinally rearward end connected to the body and a longitudinally forward end located away from the body. According to some embodiments, the stringed musical instrument includes a fingerboard connected to the neck. The stringed musical instrument may include a sequence of fingerboard frets on the fingerboard. In some embodiments, the stringed musical instrument includes a nut disposed on the longitudinally forward end of the neck. According to some embodiments, the stringed musical instrument includes a saddle means positioned on the body. The stringed musical instrument may include a string contacting the nut, extending above the fingerboard, and contacting the saddle means. In some embodiments, the stringed musical instrument includes a block having a fretting end. According to some embodiments, the stringed musical instrument includes a fastener configurable in a non locking configuration and in a locking configuration. The block may be adjustably positionable on the body such that the fretting end is i) under the string and ii) longitudinally forward of the saddle means. In some embodiments, when the fastener is in the non locking configuration, a longitudinal position of the block is adjustable relative to the saddle means, and a vertical position of the fretting end is adjustable relative to the string. According to some embodiments, when the fastener is in the locking configuration, the fastener fixes the longitudinal position of the block and the vertical position of the fretting end. The fretting end may be positionable to define a wrist fretable note a semitone above an open note of the string.

In some embodiments, the stringed musical instrument further includes a support and an insert connected to the support. According to some embodiments, the support is coupled to the body. The block may further include a slot configured to receive the insert. In some embodiments, with the insert inserted in the slot, the longitudinal position of the block is adjustable by manipulating the block, via the slot, along the insert.

According to some embodiments, the stringed musical instrument further includes a support coupled to the body. The support may include an opening configured to receive the fastener. In some embodiments, the block further includes a slot. According to some embodiments, the fastener inserts through the slot into the opening. With the fastener in the non locking configuration, the longitudinal position of the block may be adjustable by manipulating the block, via the slot, along the fastener.

In some embodiments, the stringed musical instrument further includes a support coupled to the body. According to some embodiments, the support includes a substantially longitudinal slot. With the fastener in the non locking configuration, a longitudinal position of the block may be adjustable by manipulating the block along the slot.

In some embodiments, the stringed musical instrument further includes a support coupled to the body. According to some embodiments, the support includes a substantially longitudinal slot. The block may further include an opening configured to receive the fastener. In some embodiments, the fastener inserts through the slot and into the opening. According to some embodiments, with the fastener in the non locking configuration, the longitudinal position of the block is adjustable by manipulating the block along the slot.

The body may be hollow and include a soundboard. In some embodiments, the fastener is configurable to couple the block to the soundboard. According to some embodiments, the block further includes a pivot longitudinally spaced from the fretting end. Pivoting the block on the pivot may adjust the vertical position of the fretting end relative to the string.

In some embodiments, the stringed musical instrument includes a height screw configured to adjust the vertical position of the fretting end. According to some embodiments, the stringed musical instrument includes a height screw configured to adjust the vertical position of the fretting end by pivoting the block on the pivot. The stringed musical instrument may include a shim configured to adjust the vertical position of the fretting end by inserting it between the body and the block.

Also included in the present disclosure is a stringed musical instrument including a body. In some embodiments, the stringed musical instrument includes a neck having a longitudinally rearward end connected to the body and a longitudinally forward end located away from the body. According to some embodiments, the stringed musical instrument includes a fingerboard connected to the neck. The stringed musical instrument may include a sequence of fingerboard frets on the fingerboard. In some embodiments, the stringed musical instrument includes a nut disposed on the longitudinally forward end of the neck. According to some embodiments, the stringed musical instrument includes a saddle means positioned on the body. The stringed musical instrument may include a proto string contacting the nut, extending above the fingerboard, and contacting the saddle means. In some embodiments, the stringed musical instrument includes a fretting appendage having a fretting crown. According to some embodiments, the fretting appendage is adjustably positionable on the body. The fretting crown may be disposed under the proto string and longitudinally forward of the saddle means. According to some embodiments, the stringed musical instrument includes a fastener configurable in a non locking configuration and a locking configuration. When the fastener is in the non locking configuration, a longitudinal position of the fretting appendage may be adjustable relative to the saddle means, and a vertical position of the fretting crown may be adjustable relative to the proto string. In some embodiments, when the fastener is in the locking configuration, the fastener fixes the longitudinal position of the fretting appendage and the vertical position of the fretting crown. According to some embodiments, the fretting crown is positionable to define a wrist fretable note a semitone above an open note of the proto string.

The fretting appendage may have a lateral width equal to or less than 20 millimeters (mm). In some embodiments, the body is hollow and includes a soundboard. According to some embodiments, the fastener is configurable to couple the fretting appendage to the soundboard.

The stringed musical instrument may further include a deutero string laterally spaced from the proto string. In some embodiments, the deutero string contacts the nut, extends above the fingerboard, and contacts the saddle means. According to some embodiments, a first lateral side of the fretting appendage is laterally between the proto string and the deutero string.

The stringed musical instrument may further include a deutero string consecutive to and laterally spaced from the proto string. In some embodiments, the deutero string contacts the nut, extends above the fingerboard, and contacts the saddle means. According to some embodiments, a lateral string spacing is defined by a spacing, at the saddle means, between the proto string and the deutero string. The fretting appendage may have a lateral width equal to or less than 200% of the lateral string spacing.

In some embodiments, the stringed musical instrument further includes a height screw configured to adjust the vertical position of the fretting crown. According to some embodiments, the height screw is configured to support the vertical position of the fretting crown during adjustment of the longitudinal position of the fretting appendage.

The fretting appendage may further include a pivot longitudinally spaced from the fretting crown. In some embodiments, the vertical position of the fretting crown is adjustable by pivoting the fretting appendage on the pivot. According to some embodiments, the fretting crown is oriented at a fingerboard matching angle that matches a fingerboard angle of the fingerboard relative to the proto string.

Also included in the present disclosure is an assembly for a guitar, including a block having a fretting end. In some embodiments, the assembly includes a fastener configurable in a non locking configuration and in a locking configuration. According to some embodiments, the block is adjustably positionable i) on a body of the guitar, ii) with the fretting end under a longitudinally extending string of the guitar which connects to the body of the guitar. When the fastener is in the non locking configuration, a longitudinal position of the block may be adjustable relative to the string of the guitar, and a vertical position of the fretting end may be adjustable relative to the string of the guitar. In some embodiments, the fretting end is positionable at a wrist fretable vertical distance under the string. According to some embodiments, when the fastener is in the locking configuration, the fastener fixes the longitudinal position of the block and the vertical position of the fretting end.

The block may further include a pivot longitudinally spaced from the fretting end. In some embodiments, the vertical position of the fretting end is adjustable by pivoting the block on the pivot. According to some embodiments, the assembly includes a height screw configured to adjust the vertical position of the fretting end. The assembly may include a height screw configured to adjust the vertical position of the fretting end by pivoting the block on the pivot.

Also included in the present disclosure is a stringed musical instrument including a body. In some embodiments, the stringed musical instrument includes a neck having a longitudinally rearward end connected to the body and a longitudinally forward end located away from the body. According to some embodiments, the stringed musical instrument includes a fingerboard connected to the neck. The stringed musical instrument may include a sequence of fingerboard frets on the fingerboard. In some embodiments, the sequence of fingerboard frets includes a first fingerboard fret, a twelfth fingerboard fret, and an eighteenth fingerboard fret. According to some embodiments, the stringed musical instrument includes a nut disposed on the longitudinally forward end of the neck. The stringed musical instrument may include a saddle means positioned on the body. In some embodiments, the stringed musical instrument includes a fretting appendage having a fretting crown. The fretting appendage may be adjustably positionable on the body. According to some embodiments, the stringed musical instrument includes a string contacting the nut at a longitudinally forward critical contact point, extending above the fingerboard and the fretting crown, and contacting the saddle means at a longitudinally rearward critical contact point. A distance from the longitudinally rearward critical contact point to the twelfth fret may be greater than a distance from the longitudinally forward critical contact point to the twelfth fret. In some embodiments, a vertical position of the fretting crown is adjustable relative to the string. According to some embodiments, the fretting crown is positionable such that i) a vertical distance between the string and the first fingerboard fret is less than a vertical distance between the string and the fretting crown, ii) a distance from the first fingerboard fret to the longitudinally rearward critical contact point of the string is less than a distance from the fretting crown to the longitudinally forward critical contact point of the string, iii) the eighteenth fingerboard fret defines a fingerboard fretted note an octave and a tritone above an open note of the string, iii) the first fingerboard fret defines a fingerboard fretted note a semitone above an open note of the string, and iv) the fretting crown is configured to define a wrist fretable note a semitone above an open note of the string.

Also included in the present disclosure is a stringed musical instrument including a body. In some embodiments, the stringed musical instrument includes a neck having a longitudinally rearward end connected to the body and a longitudinally forward end located away from the body. According to some embodiments, the stringed musical instrument includes a fingerboard connected to the neck. The stringed musical instrument may include a sequence of fingerboard frets on the fingerboard. In some embodiments, the stringed musical instrument includes a nut disposed on the longitudinally forward end of the neck. According to some embodiments, the stringed musical instrument includes a saddle means positioned on the body. The stringed musical instrument may include a fretting appendage having a fretting crown. In some embodiments, the fretting appendage is adjustably positionable on the body. According to some embodiments, the stringed musical instrument includes a proto string contacting the nut, extending above the fingerboard and the fretting crown, and contacting the saddle means. A vertical position of the fretting crown may be adjustable relative to the proto string. In some embodiments, the fretting crown is positionable to define a wrist fretable note a semitone above an open note of the proto string.

According to some embodiments, the stringed musical instrument further includes a vibrato mechanism configured to alter a pitch of the proto string. The stringed musical instrument may include a pickup coupled to the body. In some embodiments, at least a portion of the pickup is located at least 85% of a neck scale length from the nut.

According to some embodiments, the saddle means includes a first saddle. The proto string may contact the saddle. In some embodiments, a longitudinal position of the first saddle is adjustable relative to the fretting crown. The fretting crown may include a rounded edge where an upper surface of the fretting appendage and a longitudinally forward surface of the fretting appendage meet.

In some embodiments, the fretting crown includes a fingerboard matching angle matching a fingerboard angle of the fingerboard relative to the proto string. According to some embodiments, the body is hollow and includes a soundboard. The fretting appendage may be configured to couple to the soundboard.

In some embodiments, a lateral width of the fretting appendage is equal to or less than 30 millimeters (mm). According to some embodiments, a lateral width of the fretting appendage is equal to or less than 20 mm. The stringed musical instrument may further include a height screw configured to adjust the vertical position of the fretting crown.

In some embodiments, the fretting appendage further includes a pivot longitudinally spaced from the fretting crown. According to some embodiments, the vertical position of the fretting crown is adjustable by pivoting the fretting appendage on the pivot. The pivot may be located longitudinally between the fretting crown and the saddle means. In some embodiments, the pivot is located longitudinally between the fretting crown and the fingerboard.

According to some embodiments, the fretting appendage pivots on an axis of rotation substantially perpendicular to a direction that the proto string extends. The pivot may support the fretting appendage at least a first point and a second point. In some embodiments, the stringed musical instrument further includes a height screw. According to some embodiments, the height screw is configured to adjust the vertical position of the fretting crown by pivoting the fretting appendage on the pivot.

The stringed musical instrument may further include a shim configured to adjust the vertical position of the fretting crown.

In some embodiments, turning the height screw in a first direction adjusts the vertical position of the fretting crown upward. According to some embodiments, turning the height screw in a second direction adjusts the vertical position of the fretting crown downward. A longitudinal position of the fretting appendage may be adjustable relative to the body. In some embodiments, the height screw is configured to support the vertical position of the fretting crown during adjustment of the longitudinal position of the fretting appendage.

According to some embodiments, a longitudinal position of the fretting appendage is adjustable relative to the saddle means. The pivot may be configured to support the vertical position of the fretting crown during adjustment of the longitudinal position of the fretting appendage.

In some embodiments, a longitudinal position of the fretting appendage is adjustable relative to the saddle means. According to some embodiments, the stringed musical instrument further includes a support coupled to the body. The support may include a substantially longitudinal slot. In some embodiments, a longitudinal position of the fretting appendage is adjustable by manipulating the fretting appendage along the slot.

According to some embodiments, the stringed musical instrument further includes a support coupled to the body. The fretting appendage may further include a slot. In some embodiments, a longitudinal position of the fretting appendage is adjustable by connecting the slot to the support and manipulating the fretting appendage, via the slot, along the support. According to some embodiments, the stringed musical instrument further includes a fastener configured to couple the fretting appendage to the body.

The stringed musical instrument may include a fastener configurable in a non locking configuration and in a locking configuration. In some embodiments, when the fastener is in the non locking configuration, the longitudinal position of the fretting appendage is adjustable relative to the saddle means, and the vertical position of the fretting crown is adjustable relative to the proto string. According to some embodiments, when the fastener is in the locking configuration, the fastener is configured to fix the longitudinal position of the fretting appendage and the vertical position of the fretting crown.

The stringed musical instrument may include a fastener configured to lock the vertical position of the fretting crown. In some embodiments, the stringed musical instrument includes a fastener configured to lock the longitudinal position of the fretting appendage.

According to some embodiments, the stringed musical instrument further includes a deutero string consecutive to and laterally spaced from the proto string. The deutero string may contact the nut, extend above the fingerboard, and contact the saddle means.

In some embodiments, a lateral string spacing is defined by a spacing, at the saddle means, between the deutero string and the proto string. According to some embodiments, the fretting appendage has a lateral width less than 200% of the lateral string spacing. The fretting crown may include two lateral ends. In some embodiments, a first lateral end of the fretting crown is laterally between the proto string and the deutero string. According to some embodiments, a first lateral side of the fretting appendage is laterally between the proto string and the deutero string.

The fretting crown may be a first fretting crown. In some embodiments, the stringed musical instrument further includes a second fretting appendage having a second fretting crown. According to some embodiments, the second fretting appendage is adjustably positionable i) on the body, ii) with the second fretting crown located longitudinally forward of the saddle means and under the deutero string, and iii) such that the second fretting crown is positionable to define a wrist fretable note a semitone above an open note of the deutero string. A position of the first fretting appendage may be adjustable relative to the second fretting appendage.

Also included in the present disclosure is a stringed musical instrument including a body. In some embodiments, the stringed musical instrument includes a neck having a longitudinally rearward end connected to the body and a longitudinally forward end located away from the body. According to some embodiments, the stringed musical instrument includes a fingerboard connected to the neck. The stringed musical instrument may include a sequence of fingerboard frets on the fingerboard. In some embodiments, the stringed musical instrument includes a nut disposed on the longitudinally forward end of the neck. According to some embodiments, the stringed musical instrument includes a saddle means positioned on the body. The stringed musical instrument may include a block having a fretting crown. According to some embodiments, the block is adjustably positionable on the body. In some embodiments, the stringed musical instrument includes a proto string contacting the nut, extending above the fingerboard and the fretting crown, and contacting the saddle means. According to some embodiments, a vertical position of the fretting crown is adjustable relative to the proto string. The fretting crown may be positionable to define a wrist fretable note a semitone above an open note of the proto string.

In some embodiments, the body is hollow and includes a soundboard. According to some embodiments, the block is disposed on the soundboard. The fretting crown may include a fingerboard matching angle matching a fingerboard angle of the fingerboard relative to the proto string. In some embodiments, the stringed musical instrument further includes a height screw configured to adjust the vertical position of the fretting crown.

According to some embodiments, the stringed musical instrument further includes a height screw. The block may further include a height adjustment hole configured to receive the height screw. In some embodiments, the height screw is configured to adjust the vertical position of the fretting crown. According to some embodiments, the block further includes a height tab located longitudinally forward of the fretting crown. The height adjustment hole may be located in the height tab.

In some embodiments, the stringed musical instrument further includes a support and a height screw. According to some embodiments, the support is coupled to the body. The support may include a height adjustment hole disposed under the block. In some embodiments, the height screw is configured to insert into the height adjustment hole and to adjust the vertical position of the fretting crown by pushing against a downward surface of the block.

According to some embodiments, the block further includes a pivot longitudinally spaced from the fretting crown. The vertical position of the fretting crown may be adjustable by pivoting the block on the pivot. In some embodiments, the pivot is located longitudinally between the fretting crown and the saddle means. According to some embodiments, the pivot is located longitudinally between the fretting crown and the neck.

An axis of rotation of the pivot may be substantially perpendicular to a direction that the proto string extends. In some embodiments, the block pivots on at least two points on the body. According to some embodiments, the stringed musical instrument further includes a height screw configured to pivot the block on the pivot so as to adjust the vertical position of the fretting crown. A longitudinal position of the block may be adjustable relative to the saddle means. In some embodiments, the pivot is configured to support the block during adjustment of the longitudinal position of the block.

According to some embodiments, a longitudinal position of the block is adjustable relative to the saddle means. Turning the height screw in a first direction may adjust the vertical position of the fretting crown upward. Turning the height screw in a second direction may adjust the vertical position of the fretting crown downward. According to some embodiments, the height screw is configured to support the vertical position of the block during adjustment of the longitudinal position of the block.

The stringed musical instrument may further include a support having a guide groove configured to receive the height screw. In some embodiments, a lower end of the height screw is configured to insert into the guide groove. According to some embodiments, a longitudinal position of the block is adjustable by manipulating the height screw along the guide groove.

A downward surface of the block may further include a guide groove configured to receive the height screw. In some embodiments, an upper end of the height screw is configured to insert into the guide groove. According to some embodiments, a longitudinal position of the block is adjustable by manipulating the block, via the guide groove, along the height screw. The height adjustment hole may be centered under the proto string.

In some embodiments, the stringed musical instrument further includes a support coupled to the body and an insert connected to the support. According to some embodiments, the block further includes a slot configured to receive the insert. With the insert inserted in the slot, a longitudinal position of the block may be adjustable, relative to the saddle means, by manipulating the block, via the slot, along the insert.

In some embodiments, the stringed musical instrument further includes a support and a fastener. According to some embodiments, the support includes an opening configured to receive the fastener. The support may be coupled to the body. In some embodiments, the block further includes a slot configured to receive the fastener. According to some embodiments, with the fastener inserted through the slot and into the opening, a longitudinal position of the block is adjustable relative to the saddle means by manipulating the block, via the slot, along the fastener. The fastener may be configurable to lock the longitudinal position of the block and the vertical position of the fretting crown.

In some embodiments, the stringed musical instrument further includes a support coupled to the body. According to some embodiments, the support includes a substantially longitudinal slot. A longitudinal position of the block may be adjustable relative to the saddle means by manipulating the block along the slot.

In some embodiments, the stringed musical instrument further includes a fastener. According to some embodiments, the block includes an opening configured to receive a fastener. With the fastener inserted through the slot of the support into the opening, the longitudinal position of the block may be adjustable by manipulating the block along the slot of the support. In some embodiments, the fastener is configurable to lock the longitudinal position of the block and the vertical position of the fretting crown.

According to some embodiments, the slot is centered under the proto string. The stringed musical instrument may further include a fastener configured to couple the block to the body.

In some embodiments, the stringed musical instrument includes a fastener. According to some embodiments, the fastener is configurable in a non locking configuration and in a locking configuration. When the fastener is in the non locking configuration, the longitudinal position of the block may be adjustable relative to the saddle means, and the vertical position of the fretting crown may be adjustable relative to the proto string. In some embodiments, when the fastener is in the locking configuration, the fastener is configured to fix the longitudinal position of the block and the vertical position of the fretting crown.

According to some embodiments, the stringed musical instrument further includes a fastener configured to couple the block to the support. The stringed musical instrument may further include a deutero string consecutive to and laterally spaced from the proto string. In some embodiments, the deutero string contacts the nut, extends above the fingerboard, and contacts the saddle means. According to some embodiments, a lateral string spacing is defined by a spacing, at the saddle means, between the proto string and the deutero string. The block may have a lateral width less than 200% of the lateral string spacing.

In some embodiments, a first lateral end of the fretting crown is laterally between the proto string and the deutero string. According to some embodiments, a first lateral side of the block is laterally between the proto string and the deutero string.

The fretting crown may be a first fretting crown. In some embodiments, the stringed musical instrument further includes a second block having a second fretting crown. According to some embodiments, the second block is adjustably positionable i) on the body, ii) with the second fretting crown located longitudinally forward of the saddle means and under the deutero string, and iii) such that the second fretting crown is positionable to define a wrist fretable note a semitone above an open note of the deutero string. The slot may be laterally between the proto string and a deutero string.

Also included in the present disclosure is a stringed musical instrument. In some embodiments, the stringed musical instrument includes a body. According to some embodiments, the stringed musical instrument includes a neck having a longitudinally rearward end connected to the body and a longitudinally forward end located away from the body. The stringed musical instrument may include a fingerboard connected to the neck. In some embodiments, the stringed musical instrument includes a sequence of fingerboard frets on the fingerboard. According to some embodiments, the stringed musical instrument includes a nut disposed on the longitudinally forward end of the neck. The stringed musical instrument may include a saddle means positioned on the body. In some embodiments, the stringed musical instrument includes a block adjustably positionable on the body. According to some embodiments, the block includes a fretting crown and a pivot longitudinally spaced from the fretting crown. The stringed musical instrument may include a string contacting the nut, extending above the fingerboard and the fretting crown, and contacting the saddle means. In some embodiments, a vertical position of the fretting crown is adjustable relative to the string by pivoting the block on the pivot. According to some embodiments, the fretting crown is positionable to define a wrist fretable note a semitone above an open note of the string.

The pivot may be located longitudinally between the fretting crown and the saddle means. In some embodiments, the pivot is configured to support the block on the body at least at two points.

According to some embodiments, the pivot is configured to support the block on the body at least at a first point. The first point may be within 80 millimeters (mm) of a longitudinally rearward critical contact point of the string on the saddle means.

In some embodiments, a longitudinal position of the block is adjustable relative to the saddle means. According to some embodiments, the stringed musical instrument further includes a height screw configured to adjust the vertical position of the fretting crown by pivoting the block on the pivot. The stringed musical instrument may further include a fastener configured to lock the vertical position of the fretting crown.

Also included in the present disclosure is a stringed musical instrument. In some embodiments, the stringed musical instrument includes a body. According to some embodiments, the stringed musical instrument includes a neck having a longitudinally rearward end connected to the body and a longitudinally forward end located away from the body. The stringed musical instrument may include a fingerboard connected to the neck. In some embodiments, the stringed musical instrument includes a sequence of fingerboard frets on the fingerboard. According to some embodiments, the stringed musical instrument includes a nut disposed on the longitudinally forward end of the neck. The stringed musical instrument may include a saddle means positioned on the body. In some embodiments, the stringed musical instrument includes a block having a fretting crown. The block may be adjustably positionable on the body. According to some embodiments, the stringed musical instrument includes a string contacting the nut, extending above the fingerboard and the fretting crown, and contacting the saddle means. The stringed musical instrument may include a fastener configurable in a non locking configuration and in a locking configuration. In some embodiments, when the fastener is in the non locking configuration, i) a longitudinal position of the block is adjustable relative to the saddle means, and ii) a vertical position of the fretting crown is adjustable relative to the string, According to some embodiments, when the fastener is in the locking configuration, the fastener fixes the longitudinal position of the block and the vertical position of the fretting crown. The fretting crown may be positionable to define a wrist fretable note a semitone above an open note of the string.

In some embodiments, the stringed musical instrument further includes a support and an insert connected to the support. According to some embodiments, the support is coupled to the body. The block may further include a slot configured to receive the insert. In some embodiments, with the insert inserted in the slot and with the fastener in the non locking configuration, the longitudinal position of the block is adjustable by manipulating the block, via the slot, along the insert.

According to some embodiments, the stringed musical instrument further includes a support coupled to the body. The support may include a substantially longitudinal slot. In some embodiments, when the fastener is in the non locking configuration, the longitudinal position of the block is adjustable by manipulating the block along the slot.

According to some embodiments, the body is hollow and includes a soundboard. The fastener may be configurable to couple the block to the soundboard.

In some embodiments, the stringed musical instrument further includes a shim configured to adjust the vertical position of the fretting crown by being inserted between the body and the block. According to some embodiments, the stringed musical instrument further includes a support coupled to the body. In some embodiments, the support includes an opening configured to receive the fastener. The block may further include an opening configured to receive the fastener.

Also included in the present disclosure is a stringed musical instrument. In some embodiments, the stringed musical instrument includes a body. According to some embodiments, the stringed musical instrument includes a neck having a longitudinally rearward end connected to the body and a longitudinally forward end located away from the body. The stringed musical instrument may include a fingerboard connected to the neck. In some embodiments, the stringed musical instrument includes a sequence of fingerboard frets on the fingerboard. According to some embodiments, the stringed musical instrument includes a nut disposed on the longitudinally forward end of the neck. The stringed musical instrument may include a saddle means positioned on the body. In some embodiments, the stringed musical instrument includes a block having a fretting crown. According to some embodiments, the stringed musical instrument includes a plurality of strings, each i) contacting the nut, ii) extending above the fingerboard, and iii) contacting the saddle means. The plurality of strings may be laterally spaced from one another. In some embodiments, a lateral string spacing is defined by a spacing, at the saddle means, between two consecutive strings of the plurality of strings. According to some embodiments, the block is adjustably positionable on the body, with the fretting crown disposed i) longitudinally forward of the saddle means and ii) under a proto string of the plurality of strings. The block may have a lateral width less than 200% of the lateral string spacing. In some embodiments, the block is positionable such that the fretting crown defines a wrist fretable note a semitone above an open note of the proto string. According to some embodiments, a vertical position of the fretting crown is adjustable relative to the proto string.

The block may be a first block, and the fretting crown may be a first fretting crown. In some embodiments, the stringed musical instrument further includes a second block. According to some embodiments, a deutero string of the plurality of strings is consecutive to the proto string. The second block may include a second fretting crown. In some embodiments, the second block is adjustably positionable i) on the body, ii) with the second fretting crown under the deutero string, and iii) such that the second fretting crown defines a wrist fretable note a semitone above an open note of the deutero string.

According to some embodiments, a deutero string of the plurality of strings is consecutive to the proto string. The block may include a first lateral side and a second lateral side opposite the first lateral side. In some embodiments, the first lateral side is laterally between the proto string and the deutero string.

According to some embodiments, the stringed musical instrument further includes a support coupled to the body and an insert connected to the support. The block may further include a slot configured to receive the insert. In some embodiments, with the insert inserted in the slot, a longitudinal position of the block is adjustable by manipulating the block, via the slot, along the insert.

According to some embodiments, the stringed musical instrument further includes a support coupled to the body. The support may include a substantially longitudinal slot. In some embodiments, a longitudinal position of the block is adjustable by manipulating the block along the slot.

According to some embodiments, the body is hollow and includes a soundboard. The block may be configured to couple to the soundboard.

In some embodiments, the stringed musical instrument further includes a fastener configurable in a non locking configuration and in a locking configuration. According to some embodiments, when the fastener is in the non locking configuration, a longitudinal position of the block is adjustable relative to the saddle means. When the fastener is in the locking configuration, the fastener may fix the longitudinal position of the block.

In some embodiments, a longitudinal position of the block is adjustable relative to the saddle means. According to some embodiments, the stringed musical instrument further includes a shim configured to adjust a vertical position of the fretting crown relative to the proto string.

Also included in the present disclosure is a stringed musical instrument. In some embodiments, the stringed musical instrument includes a body. According to some embodiments, the stringed musical instrument includes a neck having a longitudinally rearward end connected to the body and a longitudinally forward end located away from the body. The stringed musical instrument may include a fingerboard connected to the neck. In some embodiments, the stringed musical instrument includes a sequence of fingerboard frets on the fingerboard. According to some embodiments, the stringed musical instrument includes a nut disposed on the longitudinally forward end of the neck. The stringed musical instrument may include a saddle means positioned on the body. In some embodiments, the stringed musical instrument includes a block having a fretting crown. According to some embodiments, the block is adjustably positionable on the body. The stringed musical instrument may include a string contacting the nut, extending above the fingerboard and the fretting crown, and contacting the saddle means. In some embodiments, the stringed musical instrument includes a height screw configured to adjust a vertical position of the fretting crown. According to some embodiments, turning the height screw in a first direction adjusts the vertical position of the fretting crown upward, moving the fretting crown toward the string. Turning the height screw in a second direction may adjust the vertical position of the fretting crown downward, moving the fretting crown away from the string. In some embodiments, a longitudinal position of the block is adjustable relative to the saddle means. According to some embodiments, the height screw is configured to support the vertical position of the fretting crown during adjustment of the longitudinal position of the block. The fretting crown may be positionable to define a wrist fretable note a semitone above an open note of the string.

In some embodiments, the block includes a height adjustment hole configured to receive the height screw. According to some embodiments, the stringed musical instrument further includes a support coupled to the body. The support may include a height adjustment hole configured to receive the height screw.

In some embodiments, the stringed musical instrument further includes a support and an insert connected to the support. According to some embodiments, the support is coupled to the body. The block may further include a slot configured to receive the insert. In some embodiments, with the insert inserted in the slot, the longitudinal position of the block is adjustable by manipulating the block, via the slot, along the insert.

According to some embodiments, the stringed musical instrument further includes a support coupled to the body. The support may include a substantially longitudinal slot. In some embodiments, the longitudinal position of the block is adjustable by manipulating the block along the slot.

According to some embodiments, the stringed musical instrument further includes a fastener. The fastener may have a non locking configuration and a locking configuration. In some embodiments, when the fastener is in the non locking configuration, the longitudinal position of the block is adjustable relative to the saddle means. According to some embodiments, when the fastener is in the locking configuration, the fastener fixes the longitudinal position of the block.

The stringed musical instrument may further include a fastener. In some embodiments, the fastener has a non locking configuration and a locking configuration. According to some embodiments, when the fastener is in the non locking configuration, the vertical position of the fretting crown is adjustable relative to the string. When the fastener is in the locking configuration, the fastener may fix the vertical position of the fretting crown.

The foregoing, and other features and advantages of the invention, will be apparent from the following, more particular description of the preferred embodiments of the invention, the accompanying drawings, and the claims.

### BRIEF DESCRIPTION OF DRAWINGS

These and other features, aspects, and advantages are described below with reference to the drawings, which are intended to illustrate, but not to limit, the invention.

FIG. 1 illustrates a perspective view of an assembly including a fretting appendage on a body and a picking hand. As illustrated in FIG. 1, a player is performing a wrist fretting action on an instrument similar to an instrument as shown and described in FIG. 47.

FIG. 2 illustrates an orthographic view of a picking hand of a right handed player.

FIG. 3 illustrates an orthographic view of an instrument and a picking hand. As illustrated in FIG. 3, a player is wrist fretting on an instrument similar to an instrument as shown and described in FIG. 8.

FIG. 4 illustrates a partial orthographic side view of a body, a fretting appendage, and a string.

FIG. 5 illustrates a partial orthographic side view of a body, a fretting appendage, a string, and a wrist.

FIG. 6 illustrates a perspective view of an assembly on a body and a hand.

FIG. 7 illustrates an orthographic view of an instrument, a picking hand, and a fretting hand.

FIG. 8 illustrates an orthographic view of an instrument and an assembly. As illustrated in FIGS. 8-19, an instrument in an acoustic six string guitar form includes a fretting appendage.

FIG. 9 illustrates a trimetric cutaway view of a body, from the back.

FIG. 10 illustrates a trimetric view of an assembly on a body.

FIG. 11 illustrates a partial exploded view of an assembly on a body.

FIG. 12 illustrates a partial exploded view of an assembly on a body.

FIG. 13 illustrates a partial cross-sectional view of a longitudinally forward end of a neck, along 13-13 in FIG. 8.

FIG. 14 illustrates a partial cross-sectional view of a body and an assembly, along 14-14 in FIG. 8.

FIG. 15 illustrates a partial orthographic side view of an assembly on a body; a broken line depicts a position of a bottom of a string if it were fretted against an eighteenth fingerboard fret.

FIG. 16 illustrates a partial orthographic side view of a fretting end of a fretting appendage under a string; a broken line depicts a position of a bottom of a string if it were fretted against an eighteenth fingerboard fret.

FIG. 17 illustrates a partial orthographic side view of an assembly on a body; a solid line depicts a first position of a fretting appendage, and a broken line depicts a second position of the fretting appendage.

FIG. 18 illustrates a partial cross-sectional view, along 14-14 in FIG. 8, of a body and an assembly, without a longitudinally rearward fastener.

FIG. 19 illustrates a partial cross-sectional view, along 14-14 in FIG. 8, of a body and an assembly, without a longitudinally forward fastener.

FIG. 20 illustrates a trimetric view of an assembly on a body including two fretting appendages.

FIG. 21 illustrates a trimetric view of an assembly on a body including three fretting appendages.

FIG. 22 illustrates a trimetric view of an assembly on a body including four fretting appendages.

FIG. 23 illustrates a trimetric view of an assembly on a body including five fretting appendages.

FIG. 24 illustrates an orthographic view of an assembly on a body including six fretting appendages.

FIG. 25 illustrates a partial trimetric cutaway view of a body, from the back.

FIG. 26 illustrates a partially exploded view of an assembly on a body.

FIG. 27 illustrates a partial view, from a longitudinally rearward viewpoint, of fretting appendages of an assembly and a fingerboard fret on a fingerboard.

FIG. 28 illustrates an orthographic view of an instrument and an assembly. As illustrated in FIGS. 28-35, an instrument in an electric six string guitar form includes two fretting appendages and a vibrato mechanism saddle support.

FIG. 29 illustrates an orthographic view of a back of a body.

FIG. 30 illustrates a trimetric view of an assembly on a body.

FIG. 31 illustrates a partial trimetric view of an assembly on a body.

FIG. 32 illustrates a partial view, from a longitudinally rearward viewpoint, of fretting appendages of an assembly and a fingerboard fret on a fingerboard.

FIG. 33 illustrates a partial exploded view of an assembly on a body.

FIG. 34 illustrates a partial cross-sectional view of a longitudinally forward end of a neck, along 34-34 in FIG. 28.

FIG. 35 illustrates a partial cross-sectional view of a body and an assembly, along 35-35 in FIG. 28.

FIG. 36 illustrates an orthographic view of an instrument and an assembly. As illustrated in FIGS. 36-45, an instrument in an electric six string guitar form includes a common support of a fretting appendage and a saddle means.

FIG. 37 illustrates an orthographic view of a back of a body.

FIG. 38 illustrates a trimetric view of an assembly on a body.

FIG. 39 illustrates a partially exploded view of an assembly on a body.

FIG. 40 illustrates a partial cross-sectional view of a longitudinally forward end of a neck, along 40-40 in FIG. 36.

FIG. 41 illustrates a partial cross-sectional view of a body and an assembly, along 41-41 in FIG. 36.

FIG. 42 illustrates a partial orthographic view of a back of a body, showing an aperture of a body cavity.

FIG. 43 illustrates a partial view, from a longitudinally rearward viewpoint, of fretting appendages of an assembly and a fingerboard fret on a fingerboard.

FIG. 44 illustrates a partial cross-sectional view of a body and an assembly, along 41-41 in FIG. 36, without a longitudinally forward fastener.

FIG. 45 illustrates a partial cross-sectional view of a body and an assembly, along 41-41 in FIG. 36, without a longitudinally rearward fastener.

FIG. 46 illustrates a partial cross-sectional view of a body and an assembly, similar to an assembly as illustrated and described in FIG. 41, but with a fastener and a fastening opening in an alternative arrangement.

FIG. 47 illustrates a partial cross-sectional view of a body and an assembly, similar to an assembly as illustrated and described in FIG. 41, but with a height screw and a height adjustment hole in an alternative arrangement.

FIG. 48 illustrates an isometric view of a fretting appendage. FIGS. 48-49 illustrate a fretting appendage with an alternative form which may be substituted for a fretting appendage of an instrument similar to an instrument as shown and described in FIGS. 36-45.

FIG. 49 illustrates an isometric view of a fretting appendage.

FIG. 50 illustrates an orthographic view of an instrument and an assembly. As illustrated in FIGS. 50-54, an instrument in an electric six string guitar form includes a fretting appendage with a two string fretting crown.

FIG. 51 illustrates an orthographic view of a back of a body.

FIG. 52 illustrates an orthographic view of an assembly on a body.

FIG. 53 illustrates a partially exploded view of an assembly on a body.

FIG. 54 illustrates an orthographic view of a fretting appendage, from a longitudinally rearward viewpoint.

FIG. 55 illustrates an orthographic view of an assembly on a body. As illustrated in FIGS. 55-57, an instrument similar to an instrument as shown and described in FIGS. 50-54 includes a fretting appendage with a laterally proximal fretting crown and a laterally distal fretting crown.

FIG. 56 illustrates a partially exploded view of an assembly on a body.

FIG. 57 illustrates an orthographic view of a fretting appendage, from a longitudinally rearward viewpoint.

FIG. 58 illustrates a partial trimetric view of an instrument and an assembly. As illustrated in FIGS. 58-59, an instrument includes a longitudinally elongated fretting appendage set up to define a wrist fretable note a major third above an open note of a string.

FIG. 59 illustrates a partial cross-sectional view of an assembly on a body, along 59-59 in FIG. 58.

FIG. 60 illustrates an orthographic view of an assembly on a body. In FIG. 60, an instrument, which is similar to an instrument as shown and described in FIGS. 50-54, includes a fretting appendage with a five string fretting crown.

FIG. 61 illustrates a trimetric view of an assembly on a body. As illustrated in FIG. 61-62, an instrument in an electric six string guitar form includes a support including two barriers.

FIG. 62 illustrates a partially exploded view of an assembly on a body.

FIG. 63 illustrates a trimetric view of an assembly on a body. As illustrated in FIG. 63-64, an instrument in an electric six string guitar form includes a support with a barrier that inserts into a channel in a fretting appendage.

FIG. 64 illustrates a partially exploded view of an assembly on a body, according to some embodiments.

FIG. 65 illustrates an orthographic top view of an assembly including a slanted pickup.

### DETAILED DESCRIPTION OF THE INVENTION

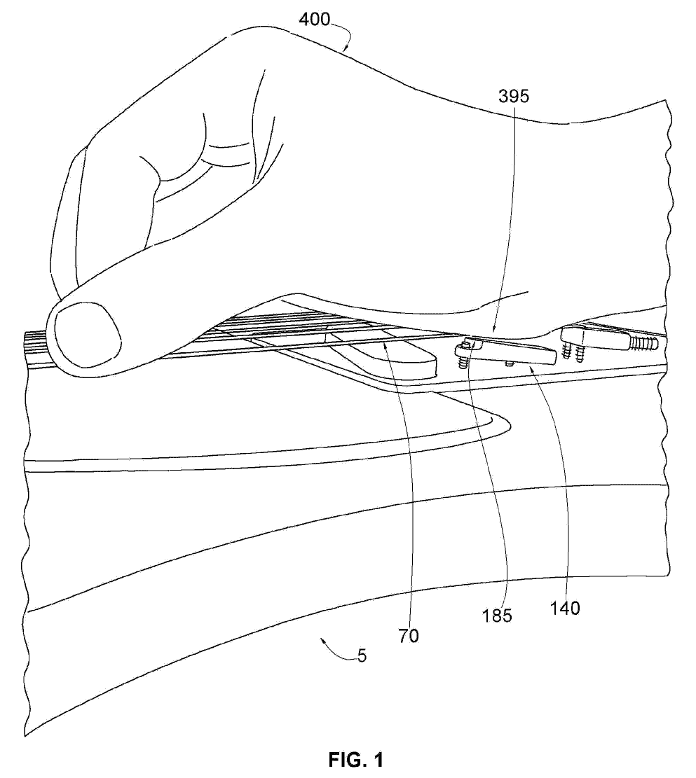

As illustrated in FIG. 1, an instrument 5 including a fretting crown 185 on a fretting appendage 140 under a string 70 may be played by wrist fretting. Wrist fretting is a previously unknown method of stopping a string, in which the pisiform bone wrist area 395 of the picking hand 400 may be used to depress the string. The pisiform bone wrist area may depress the string between a saddle means and a fretting crown until the string contacts the fretting crown. The thumb of the picking hand may be used to pluck the string.

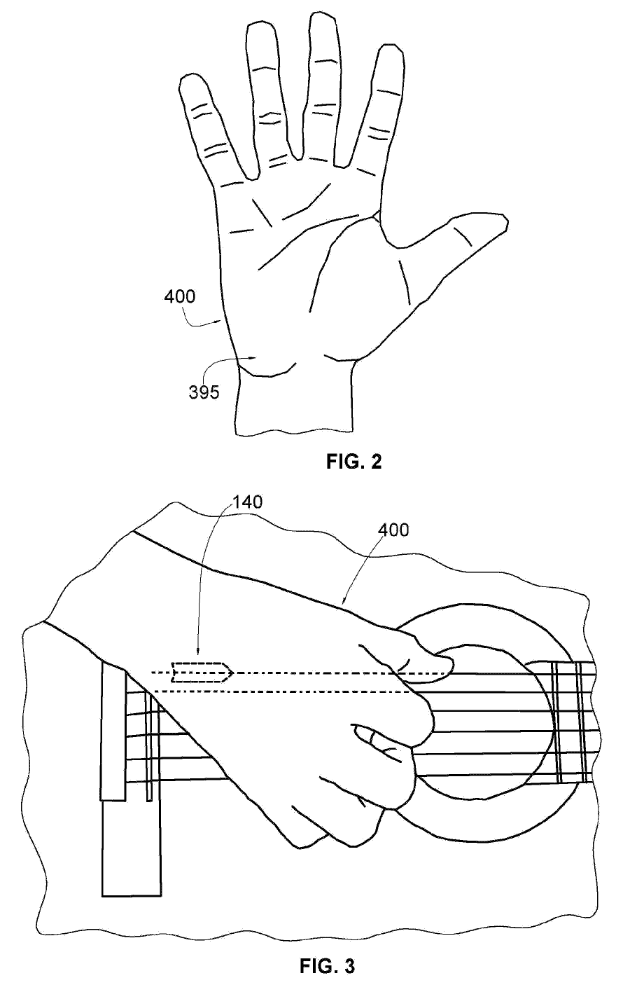

As illustrated in FIG. 2, the pisiform bone wrist area 395 of the picking hand 400, including the pisiform bone in the wrist and the flesh, bones, and skin around it, may be used to wrist fret. Both “hand” and “wrist” may be used to indicate the location of the pisiform bone of the human body. The wrist may be understood to be part of the hand.

As illustrated in FIG. 3, a player may wrist fret. The hand may be positioned to enable the pisiform bone wrist area to depress a laterally outermost proximal string slightly longitudinally rearward of a fretting crown of a fretting appendage 140. The picking hand 400 may cover the fretting appendage, which may be positioned under the laterally outermost proximal string. The fretting appendage, which is hidden by the hand, is indicated by a broken line. The thumb may pluck a wrist fretted note on the laterally outermost proximal string, while other fingers may pluck other strings. In a real-world situation, from this perspective, a viewer may not be able to see whether or not a wrist fretting action is taking place. As illustrated, the fretting appendage may be used with the laterally outermost proximal string; in additional or alternative embodiments, a fretting appendage may be positioned under and used with any string.

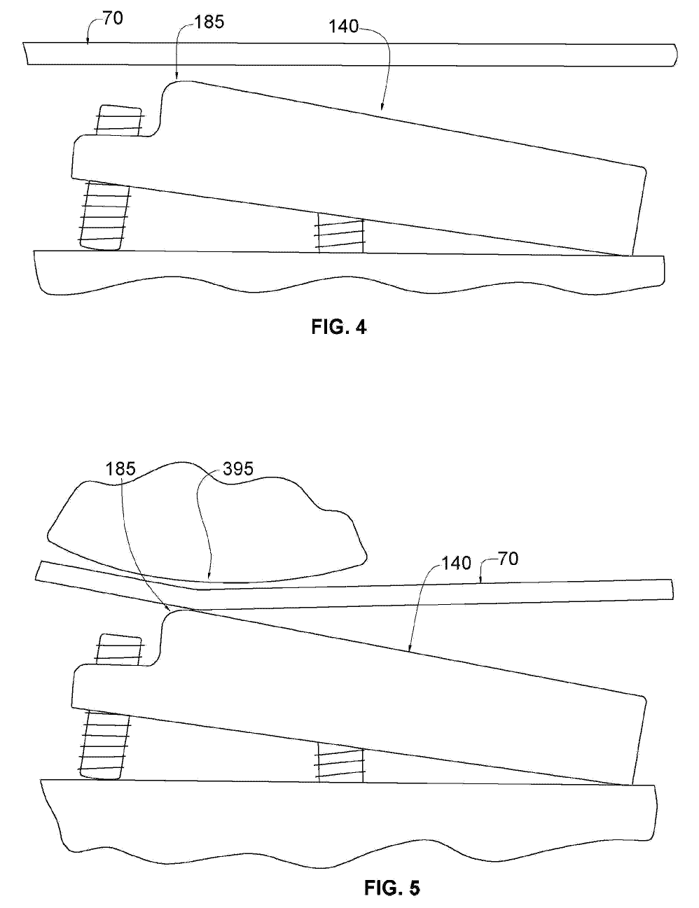

As illustrated in FIG. 4, a fretting appendage 140 is located under a string 70. The distance between a fretting crown 185 of the fretting appendage and the string may allow fretted fingerboard notes and open notes of the string to be sounded by plucking or strumming. A fretting action on the fingerboard may bring the string nearer to the fretting crown without bringing the string into contact with the fretting crown.

As illustrated in FIG. 5, the pisiform bone wrist area 395 of the picking hand may bring a string 70 into contact with a fretting crown 185 of a fretting appendage 140. The pisiform bone wrist area may depress the string until the string contacts the fretting crown, shortening the sounding length of the string. This wrist fretting action may bring the string nearer to the fingerboard frets without bringing the string into contact with the fingerboard frets.

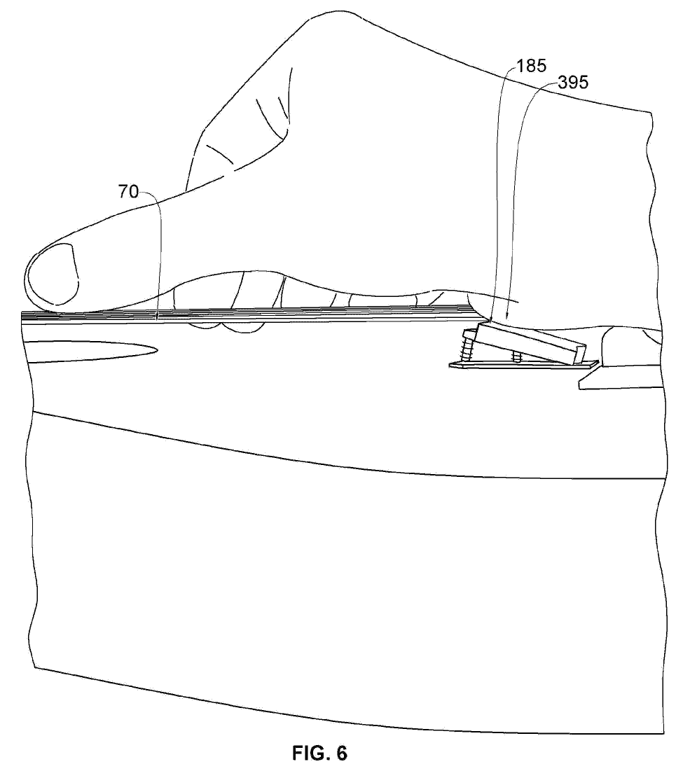

As illustrated in FIG. 6, a player may shorten the sounding length of a string 70 by wrist fretting. The pisiform bone wrist area 395 may depress the string slightly longitudinally rearward of a fretting crown 185 until the string contacts the fretting crown. A shortened sounding length of the string between the fretting crown and a nut has a pitch above an open note of the string. The player may pluck the string between the fretting crown and the nut with the picking hand thumb to produce a wrist fretted note, while the remaining fingers of the picking hand pluck laterally distal strings.

As illustrated in FIG. 6, a fretting crown 185, which defines a wrist fretable note, may be used to establish a sounding length of a string 70, and that sounding length of the string may be used to play the defined note.

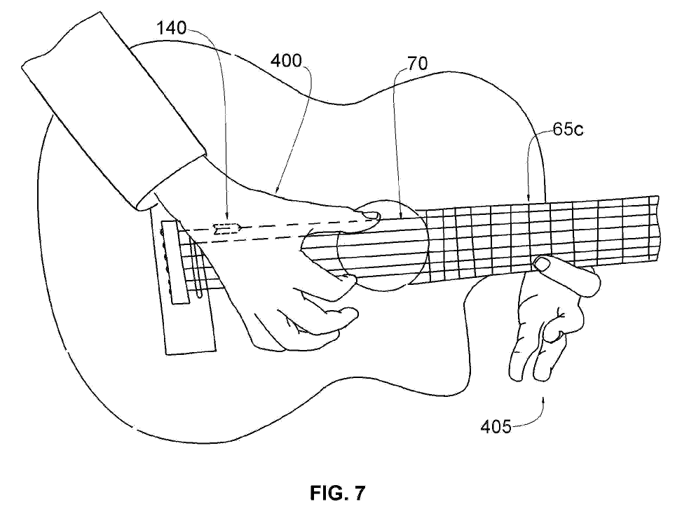

As illustrated in FIG. 7, a player may wrist fret with the pisiform bone wrist area of the picking hand 400, using a fretting appendage 140 under a string 70, which is a laterally outermost proximal string. The fretting appendage, which is hidden by the hand in FIG. 7, is indicated by a broken line. The player may use the index finger of the fretting hand 405 to fret a laterally outermost distal string at a thirteenth fingerboard fret 65c. If the instrument were in standard guitar tuning, the picking hand thumb might be plucking F2 on the laterally outermost proximal string, and the picking hand index finger might be plucking F5 on the laterally outermost distal string.

As illustrated in FIG. 7, a player may play fretted fingerboard notes with the fretting hand 405. To play a fretted fingerboard note, the player may depress a string against a fingerboard fret 65 with a finger of the fretting hand, stopping the string with the fingerboard fret, and shortening the sounding length of the string. A shortened sounding length of the string, between the fingerboard fret and a saddle means, may be plucked with the picking hand 400.

As illustrated in FIG. 7, a fingerboard fret 65, which defines a fretted fingerboard note, may be usable, by depressing a string with a finger of the fretting hand 405, to establish a sounding length of the string (which may be a laterally outermost distal string, as illustrated), and that sounding length of the string may be used to play the defined note.

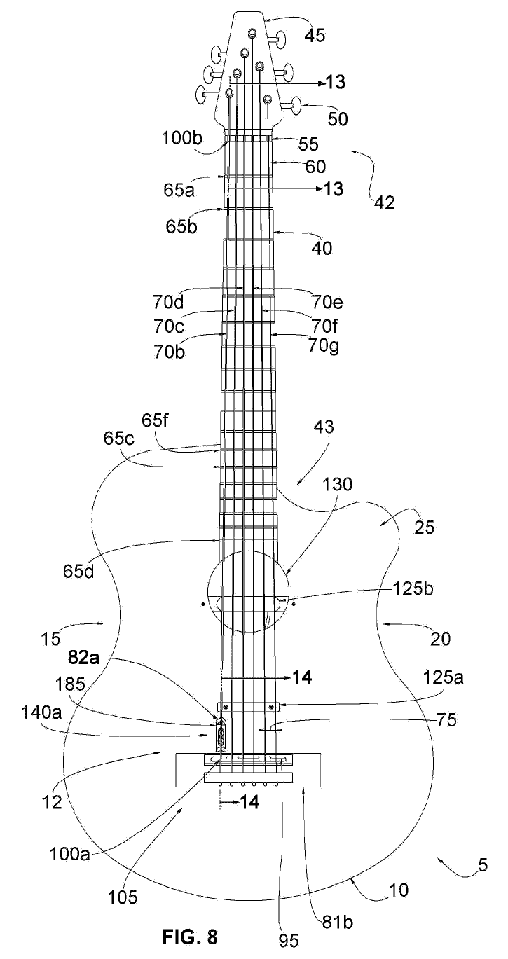

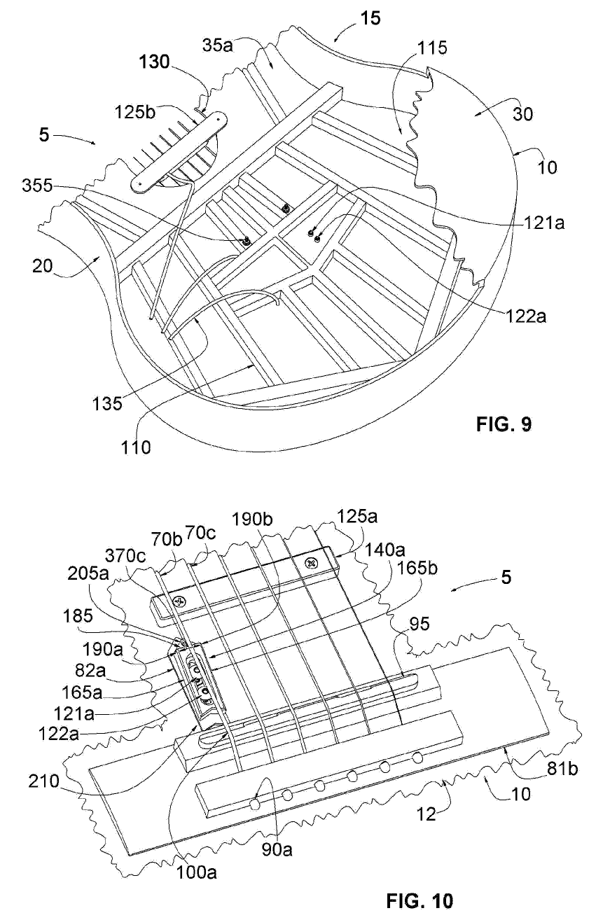

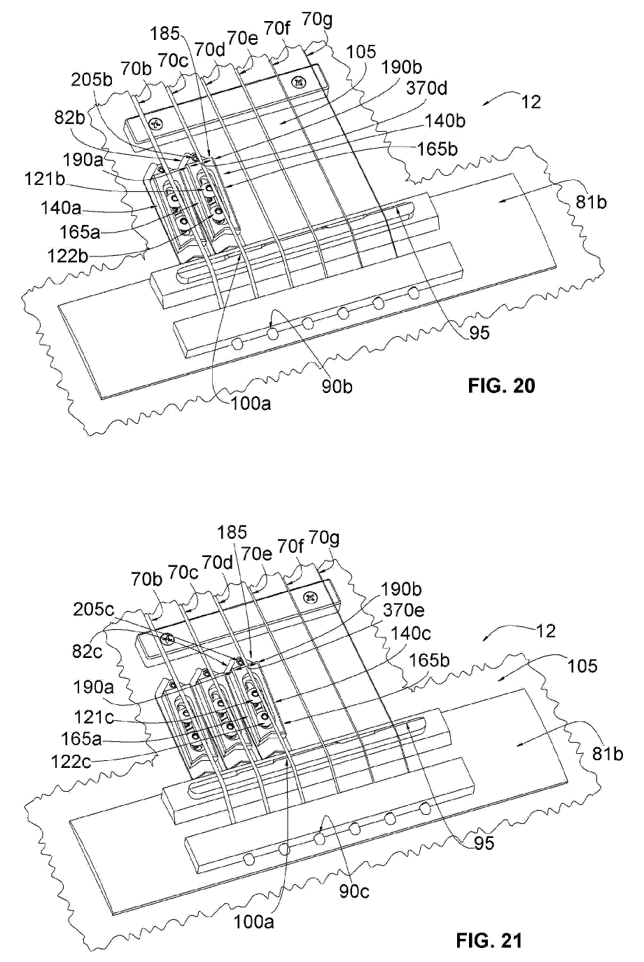

In combination, FIGS. 8 and 9 illustrate the following: An instrument 5 may include a body 10. The body may include a laterally proximal body side 15 and a laterally distal body side 20. The body may include a top 25, a back 30, and an acoustic body cavity 35a. A longitudinally rearward end 43 of a neck 40 may be connected to the body. The neck may extend longitudinally away from the body. A longitudinally forward end 42 of the neck may be located away from (i.e., remote from) the body. A headstock 45, tuning machines 50 tensioning a laterally spaced plurality of strings, and a nut 55 may be located at the longitudinally forward end of the neck. The nut may be disposed on the longitudinally forward end of the neck. A fingerboard 60 may be connected to the neck. A sequence of fingerboard frets on the fingerboard may include a first fingerboard fret 65a and a second fingerboard fret 65b. The sequence of fingerboard frets may be coupled to the fingerboard. The first fingerboard fret may run perpendicularly to a centerline of the neck, extending laterally across the fingerboard. The second fingerboard fret may be consecutive to and longitudinally spaced from the first fingerboard fret. The strings may attach at the longitudinally forward end of the neck, contact the nut, extend substantially longitudinally above the fingerboard and the fingerboard frets, contact a saddle means on the body, and attach at the body. Consecutive strings at the saddle means may be spaced, center to center, at a lateral string spacing 75. The strings may be closer together at the nut than at the saddle means. There may be a small vertical distance between the strings and the fingerboard frets. FIGS. 20-25, 28-30, 36-38, 50-52, 55, 58, 60, 61, and 63 illustrate similar features in additional or alternative embodiments.

A saddle means may be positioned on the body. The saddle means may include a single saddle for multiple strings, or multiple saddles for multiple strings. A saddle means may include acoustic or electric type saddles, and may include hardtail or vibrato type saddles.

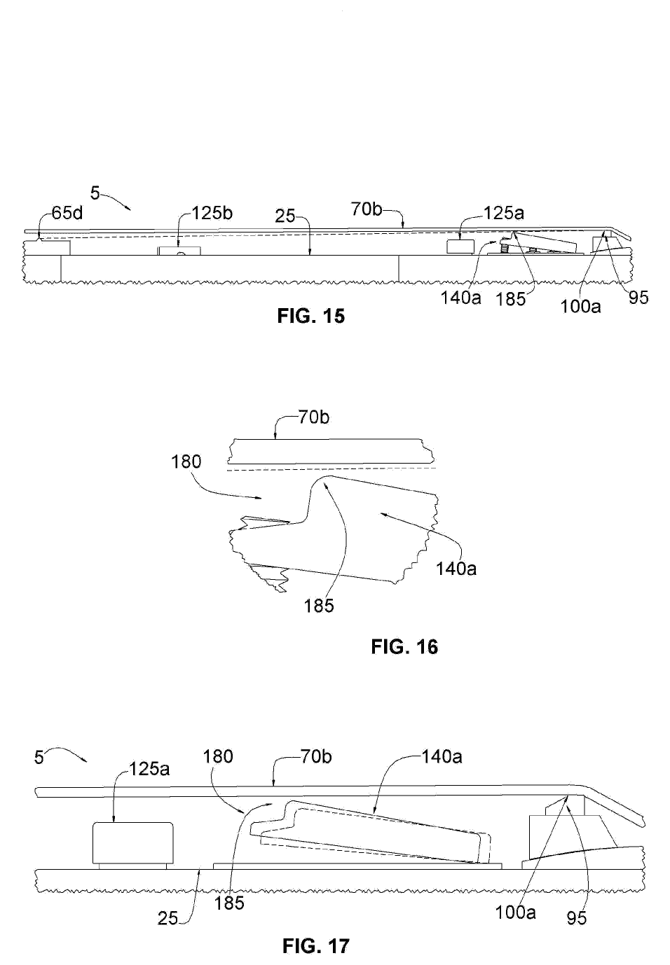

In combination, FIGS. 813, and 15 illustrate the following: A first fingerboard fret 65a, a second fingerboard fret 65b, a third fingerboard fret, a fourth fingerboard fret, a fifth fingerboard fret, a sixth fingerboard fret, a seventh fingerboard fret, an eighth fingerboard fret, a ninth fingerboard fret, a tenth fingerboard fret, an eleventh fingerboard fret, a twelfth fingerboard fret 65f, a thirteenth fingerboard fret 65c, a fourteenth fingerboard fret, a fifteenth fingerboard fret, a sixteenth fingerboard fret, a seventeenth fingerboard fret, and an eighteenth fingerboard fret 65d of a sequence of fingerboard frets may define fretted fingerboard notes a semitone, a whole step, a minor third, a major third, a perfect fourth, a tritone, a perfect fifth, a minor sixth, a major sixth, a minor seventh, a major seventh, an octave, an octave and a semitone, an octave and a whole step, an octave and a minor third, an octave and a major third, an octave and a perfect fourth, and an octave and a tritone above an open note of a string 70. Of the sequence of fingerboard frets, the first fingerboard fret may be longitudinally foremost. Of the sequence of fingerboard frets, the eighteenth fingerboard fret may be longitudinally rearmost.

In additional or alternative embodiments, the number of fingerboard frets may vary.

In combination, FIGS. 8-12 and 14 illustrate the following: An instrument 5 may have an acoustic six string guitar form. An acoustic saddle support 81b including a saddle slot 85 and six stringing openings 90 may be coupled to a body 10. A saddle means may include a saddle 95, which may be inserted into the saddle slot. The saddle may be shaped to position a longitudinally rearward critical contact point 100a of each string 70 at an individualized and intonated lateral position, longitudinal position, and vertical position. A top 25 of the body may include a soundboard 105 or other features. Braces 110 on an underside 115 of the soundboard may be shaped and positioned to allow a fretting appendage support 82 and a fastener to insert through and couple to the soundboard. A first pickup 125a may be mounted on the body between the saddle and a sound hole 130 with pickup screws 355. A second pickup 125b may be mounted in the sound hole. The acoustic saddle support may be grounded by a ground wire 135. FIGS. 20-26 illustrate similar features in additional or alternative embodiments.

In FIGS. 8 and 10 a first fretting appendage support 82a supports a first fretting appendage 140a. As illustrated in FIGS. 20-24, multiple fretting appendage supports may support multiple fretting appendages.

In combination, FIGS. 8-12 and 14 illustrate the following: A fretting appendage support 82 may be thin, strong, and lightweight; it may be partly formed from thin sheet steel or another material. The fretting appendage support may include a guide groove 145, a longitudinally forward threaded insert 150a inserted into a longitudinally forward insert opening 155a, and a longitudinally rearward threaded insert 150b inserted into a longitudinally rearward insert opening 155b. The threaded inserts may be coupled (by welding or another method) to the fretting appendage support. The longitudinally forward threaded insert, which may include a longitudinally forward fastening opening 160a, may insert into a longitudinally forward insertion opening 158 in the soundboard 105. The longitudinally rearward threaded insert, which may include a longitudinally rearward fastening opening 160b, may insert into a longitudinally rearward insertion opening 159 in the soundboard. The longitudinally forward insertion opening, the longitudinally rearward insertion opening, the fretting appendage support, the guide groove, the longitudinally forward fastening opening, and the longitudinally rearward fastening opening may be aligned with and centered under a string 70. The guide groove may be longitudinally forward of the longitudinally forward fastening opening. The fretting appendage support may be adhesively coupled to the soundboard, longitudinally between an acoustic saddle support 81b and a fingerboard 60.

In combination, FIGS. 8-12 and 14 illustrate the following: A fretting appendage 140 may be coupled to the fretting appendage support 82. The fretting appendage may include a proximal lateral side 165a, a distal lateral side 165b, a longitudinally forward surface 170, an upper surface 171 with rounded lateral edges, and a downward surface 172. A fretting end 180 of the fretting appendage may include a fretting crown 185. The fretting crown may be a rounded edge where the upper surface and the longitudinally forward surface meet, and may include a proximal lateral end 190a and a distal lateral end 190b, which may be rounded, and a fretting crown segment 370. A height tab 195 at the fretting end may include a height adjustment hole 200. A height screw 205 may insert into the height adjustment hole. A lower end of the height screw may be captured by the guide groove 145, which may be narrow enough to prevent contact with the soundboard. A pivot 210 in a lower location at a supporting end 215 of the fretting appendage may include two lateral contact projections 220. The pivot may contact an upward facing guide surface of the fretting appendage support at two points along a line perpendicular to the line of the string 70. A through slot 230 and a recess 235 may be centered between the lateral sides of the fretting appendage with the recess in an upper location. A longitudinally forward fastener 121 and a longitudinally rearward fastener 122 may insert through the through slot into the longitudinally forward fastening opening 160a and the longitudinally rearward fastening opening 160b. Heads of the two fasteners may seat in the recess. In longitudinal order, from rearmost to foremost may be: a stringing opening 90, a saddle 95 of a saddle means, the pivot, the through slot, the fretting crown, the height adjustment hole, a first pickup 125a, a second pickup 125b, a sequence of fingerboard frets, and a nut 55. The fretting appendage may be on the fretting appendage support, which may be longitudinally rearward of the pickups. The fretting appendage support, the height screw, the longitudinally forward fastener, and the longitudinally rearward fastener may align the fretting appendage with the string, centering the fretting crown under the string. The fretting appendage may be centered under the string. Fasteners and threaded inserts may insert into an acoustic body cavity 35a. The fretting crown may be positionable such that it defines a wrist fretable note a semitone above an open note of the string. FIGS. 20-26 illustrate similar features in additional or alternative embodiments.

In combination, FIGS. 8-14 illustrate the following: A first fretting appendage support 82a may be inserted into a first longitudinally forward insertion opening 158a and a first longitudinally rearward insertion opening 159a in a soundboard 105. The first fretting appendage support may be aligned with and centered under a proto string 70b. The first longitudinally forward insertion opening and the first longitudinally rearward insertion opening may be centered under the proto string. The first fretting appendage support, a first height screw 205a, a first longitudinally forward fastener 121a, and a first longitudinally rearward fastener 122a may align a first fretting appendage 140a with the proto string, and may center a fretting crown 185 of the first fretting appendage under the proto string. The first height screw may insert into a first height adjustment hole 200a. The proto string may emerge from a first stringing opening 90a, and may be directed by a saddle 95 above the first fretting appendage and a fingerboard 60, to a nut 55. The proto string may be a laterally outermost proximal string.

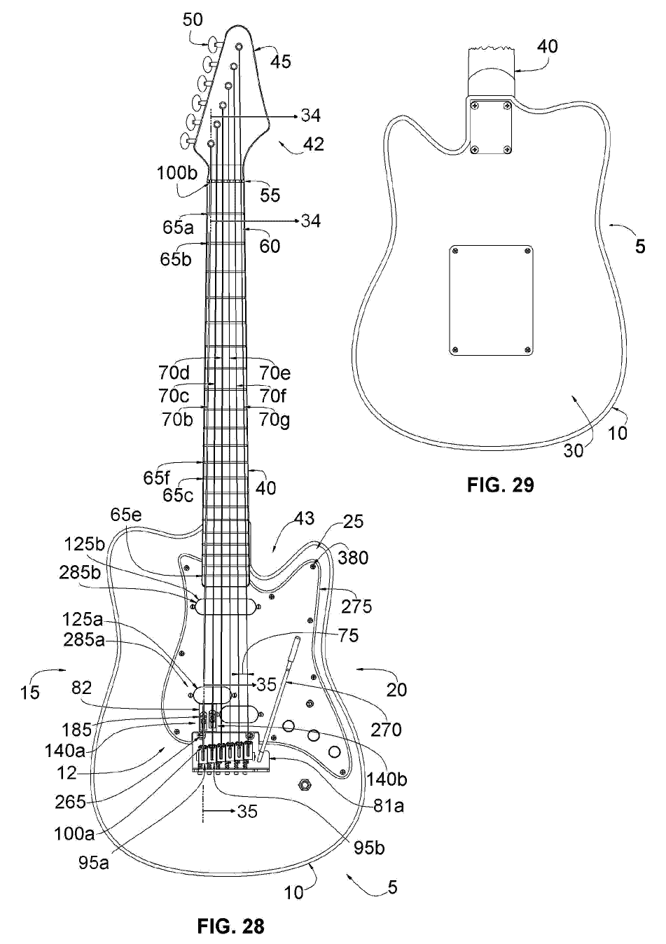

In combination, FIGS. 8, 13, and 14 illustrate the following: The sounding length of an open string may be established by a longitudinally forward critical contact point 100b on a nut 55 and by a longitudinally rearward critical contact point 100a on a saddle means. Each string 70 is coupled (by the nut) to a longitudinally forward end 42 of a neck 40 at that string’s longitudinally forward critical contact point on the nut, and coupled to a body 10 (by the saddle means) at that string’s longitudinally rearward critical contact point on the saddle means. FIGS. 28, 34, 35, 36, 40, and 41 illustrate similar features in additional or alternative embodiments.

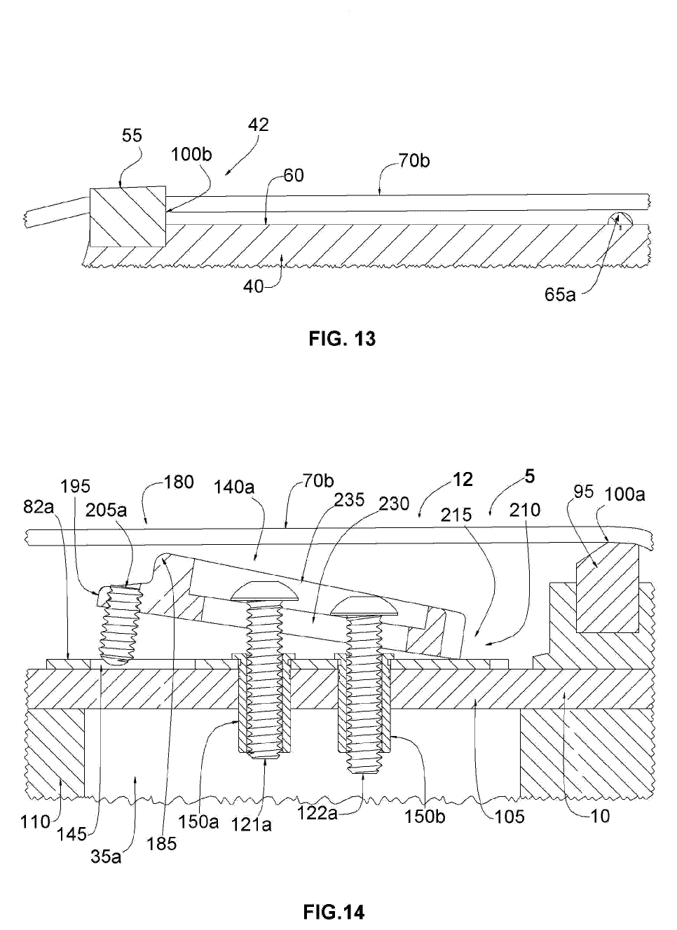

In combination, FIGS. 8 and 13 illustrate the following: A nut 55 may establish a longitudinally forward critical contact point 100b of a string 70. A nut may be typical of nuts used with angled (tilted) headstocks, and the nut and the longitudinally forward critical contact points of the strings on the nut may be in conventional lateral positions relative to the centerline of the neck 40. FIGS. 28, 34, 36, and 40 illustrate similar features in additional or alternative embodiments.

In additional or alternative embodiments, a nut may include one or more components, and may have a different form. For example, a nut may include a feature of a Fender style nut, a compensated nut, a headless headpiece, a locking nut, a roller nut, a combination of a string guide and a “zero fret”, or a nut of another variety. In additional or alternative embodiments, a position of a nut or a position of a longitudinally forward critical contact point of a string on the nut may be positioned away from a nominal position suggested by a neck scale length, for example, by shaping a compensated nut.

As illustrated in FIG. 8, a sequence of fingerboard frets may have a chromatic spacing. A first fingerboard fret 65a may be positioned to define fretted fingerboard notes a semitone above open notes of open strings, and may be longitudinally nearer to a nut 55 than a second fingerboard fret 65b. For a string 70, the sequence of fingerboard frets may define a series of successive semitones above a fundamental pitch of that string. The fingerboard frets may be longitudinally spaced based on a neck scale length. A neck scale length (conventionally called a “scale length”) may be understood to be a nominal sounding length of an open string from a saddle 95 to a nut. The fingerboard frets may be chromatically positioned relative to the nut. FIGS. 28, 36, and 50 illustrate additional or alternative embodiments with similar features.

A nominal sounding length of a fretted fingerboard note may be calculated, based on a neck scale length, using the twelfth root of two. A nominal oddment length may be calculated by subtracting a nominal sounding length from the neck scale length. (On conventional guitars, fingerboard frets may be formed or positioned with a tolerance of less than .127 millimeters (mm); the following nominal lengths are calculated as an example.) A nominal semitone sounding length may be 94.3874% of a neck scale length. A nominal whole step sounding length may be 89.0899% of a neck scale length. A nominal minor third sounding length may be 84.0896% of a neck scale length. A nominal major third sounding length may be 79.3701% of a neck scale length. A nominal semitone oddment length may be 5.6126% of a neck scale length. A nominal whole step oddment length may be 10.9101% of a neck scale length. A nominal minor third oddment length may be 15.9104% of a neck scale length. A nominal major third oddment length may be 20.6299% of a neck scale length. A nominal octave oddment length may be 50.0000% of a neck scale length.

As illustrated in FIG. 8, a fingerboard fret 65 intended to produce a fretted fingerboard note of a specific interval above open notes of open strings may be positioned at a nominal oddment length, respective to that interval, from a nut 55. More specifically, a fingerboard fret may be positioned at the nominal oddment length from the expected positions of the longitudinally forward critical contact points 100b of the strings on the nut. A first fingerboard fret 65a may be positioned at a nominal semitone oddment length from the nut. A twelfth fingerboard fret 65f may be positioned at a nominal octave oddment length from a nut. A neck scale length may be twice the distance from the twelfth fingerboard fret to the nut. FIGS. 28, 36, and 50 illustrate similar features in additional or alternative embodiments.

In additional or alternative embodiments, a fingerboard fret may be positioned at a distance from a nut which is smaller or larger than suggested by a nominal oddment length.

In combination, FIGS. 8 and 10 illustrate the following: An instrument may include an assembly 12 coupled to a body 10. The assembly may include features involved in saddle support function, saddle means function, wrist fretting function, locking function, positional adjustment function, pickup function, and other functions. Features included by the assembly may be positioned on and coupled to the body. A part of an assembly may insert into a body cavity. FIGS. 20-24, 28, 30, 36, 38, 50, 52, 55, 58, 60, 61, and 63 illustrate similar features in additional or alternative embodiments.

In combination, FIGS. 8 and 10 illustrate the following: A saddle means may acoustically couple vibrations of a string 70 to a soundboard 105 of a top 25 of a body 10. The saddle means may include a saddle 95 shaped to position longitudinally rearward critical contact points 100a of strings, each at an individualized vertical position and at an individualized and intonated longitudinal distance from a nut 55. A saddle may be in the form of a shaped, elongated block, which may be plastic, bone, or another hard material. A shaped saddle may be reshaped, or removed and replaced with a differently shaped saddle to adjust a position of a longitudinally rearward critical contact point of a string. FIGS. 20-24 and 26 illustrate similar features in additional or alternative embodiments.

In additional or alternative embodiments, a saddle means may be angled to position longitudinally rearward critical contact points of one or more strings.

In combination, FIGS. 8, 10, 11, and 14 illustrate the following: An acoustic guitar saddle means may include a single saddle 95. An acoustic saddle support 81b may be positioned on and coupled to a soundboard. The acoustic saddle support may be a shaped block including a saddle slot 85. The acoustic saddle support may include wood or another appropriate material. The saddle slot may be substantially lateral. The saddle may be positioned on and coupled to the acoustic saddle support. The saddle may be positioned on and coupled to the body by the acoustic saddle support. The acoustic saddle support may include stringing openings 90, and may act as a string retainer. FIGS. 20-24 and 26 illustrate similar features in additional or alternative embodiments.

In combination, FIGS. 8, 9, 11, and 14 illustrate the following: An acoustic instrument 5 may include a hollow body 10. The body may include a top 25, including a soundboard 105. A fretting appendage 140 may be acoustically coupled to the soundboard, under a string 70, by a fretting appendage support 82 and a fastener. The fretting appendage may be vertically or longitudinally adjustable independently of a saddle means. When plucking a wrist fretted string, the fretting appendage may transfer vibrations of the string to the soundboard. The soundboard may act as an acoustic surface, coupling vibrations of the string to the air. The light weight and small size of a fretting appendage, and the thin material and small size of a fretting appendage support, may enable the fretting appendage to make a clear wrist fretted note, without damping the vibration of the soundboard. By coupling the fretting appendage to the soundboard (with the fretting appendage support and the fastener) near the acoustic saddle support 81b, the fretting appendage may be positioned in a location where vibrations are transferred to the soundboard, producing sound. The soundboard may be a thin piece of wood or another appropriate material. An underside 115 of the soundboard may be stiffened by a brace 110, which is shaped and positioned to allow a fretting appendage support or a fastener to insert through an insertion opening in the soundboard.

“Acoustically coupled” may be understood to mean attached so as to conduct sound waves to the soundboard 105, producing musical sound. In some embodiments, a fretting appendage 140 which is acoustically coupled to a soundboard may, when a string 70 is wrist fretted against a fretting crown 185 of the fretting appendage and plucked between the fretting crown and a nut 55, produce a sound which measures at least 60 decibels (dB) at a distance within 300 mm of the soundboard.

A string 70, which is configured for wrist fretting, may be understood to be a wrist fretting string. An instrument 5 may include a wrist fretting string and a single direction fretting string. A single direction fretting string may be laterally distal to a distal lateral end 190b of each fretting crown 185 included in an assembly 12. A single direction fretting string may be used to play open notes or fretted fingerboard notes while accompaniment is played on a wrist fretting string. For some players, an instrument including a combination of one or more wrist fretting strings and one or more single direction fretting strings (which may be distal to the wrist fretting strings) may be easy to learn, comfortable to play, and useful for producing wrist fretted low notes in the lowest octave of the instrument.

In combination, FIGS. 8 and 10 illustrate the following: A plurality of consecutive strings may be as follows: A proto string 70b, which may be a laterally outermost proximal string, may be a wrist fretting string. A deutero string 70c, a trito string 70d, a tetarto string 70e, a pempto string 70f, and a hecto string 70g may be single direction fretting strings.

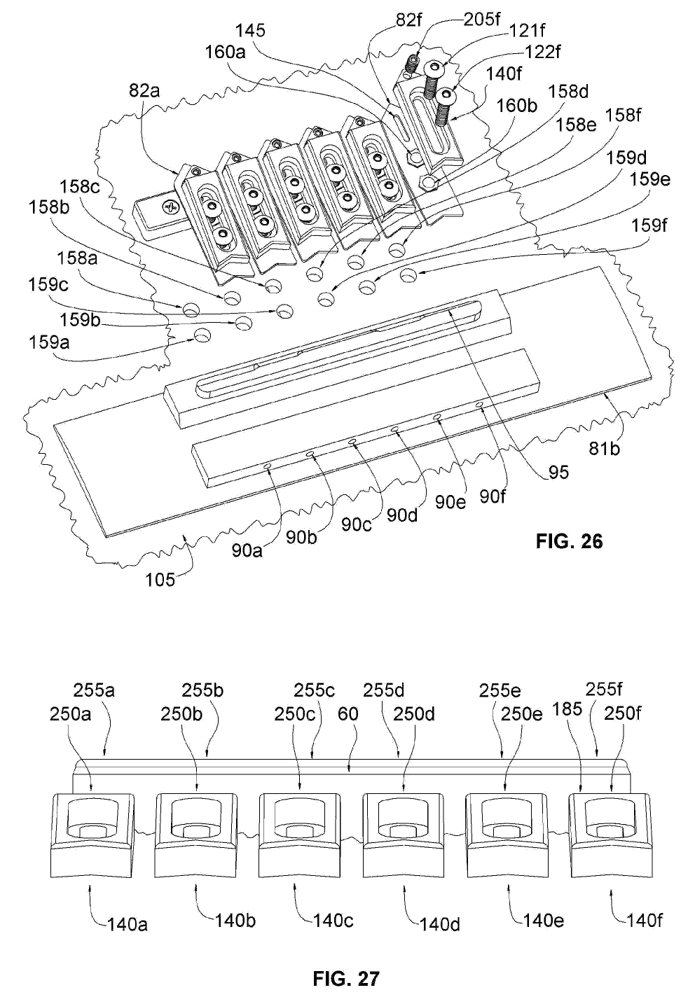

In combination, FIGS. 8, 11, 12, and 14 illustrate the following: A fretting end 180 of a fretting appendage 140 may include a height tab 195. The height tab may be longitudinally forward of a fretting crown 185 and longitudinally rearward of a fingerboard 60. The height tab may include a height adjustment hole 200. With the fretting appendage in a low vertical position, a height screw 205 may insert vertically into the height adjustment hole. As the height screw contacts the support and adjusts the fretting end upward, it may tilt as the fretting appendage pivots. The height screw may contact and be captured by a guide groove 145 of the support. As the fretting appendage is longitudinally repositioned, the height screw may also be longitudinally repositioned. The height screw may slide longitudinally along the guide groove during vertical and longitudinal repositioning. The height screw may support the fretting appendage (in a range of vertical positions, including a raised position) during sliding longitudinal repositioning. FIGS. 26, 33, 35, 47, 59, 62, and 64 illustrate similar features in additional or alternative embodiments.

In additional or alternative embodiments, a height screw inserted in a height adjustment hole in a fretting appendage may contact a planar guide surface of a support.

As illustrated in FIG. 8, an instrument 5 may include a neck 40 with a classical style fingerboard 60. A classical style fingerboard may be flat. A flat fingerboard may include a fingerboard angle of zero degrees. For a flat fingerboard, a fretting appendage 140 with a fretting crown 185 with a fingerboard matching angle of zero degrees may be appropriate. Fingerboard matching angles are described in further detail below. FIG. 27 illustrates similar features in an additional or alternative embodiment.

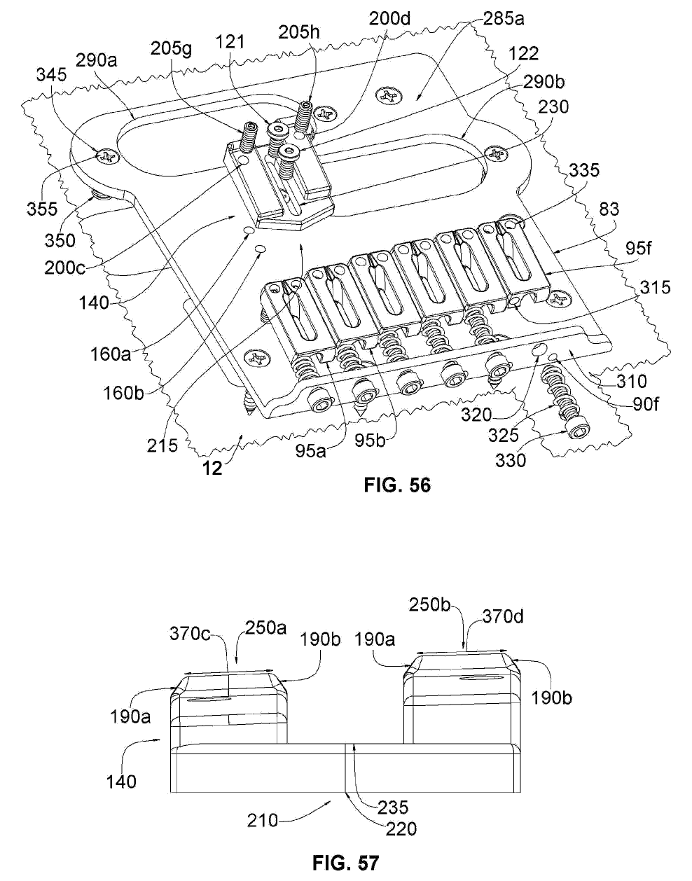

In combination, FIGS. 9-11 and 14 illustrate the following: An assembly 12 may include a longitudinally forward fastener 121 and a longitudinally rearward fastener 122. Either fastener may be used by itself to lock a vertical position, longitudinal position, and lateral position of a fretting appendage 140. The longitudinally forward fastener may be used to limit lateral movement of the fretting appendage at a longitudinally forward fastening opening 160a, including in a non locking configuration. The longitudinally rearward fastener may be used to limit lateral movement of the fretting appendage at a longitudinally rearward fastening opening 160b, including in a non locking configuration. FIGS. 20-26, 39, 41, 53, 56, and 59 illustrate similar features in additional or alternative embodiments.

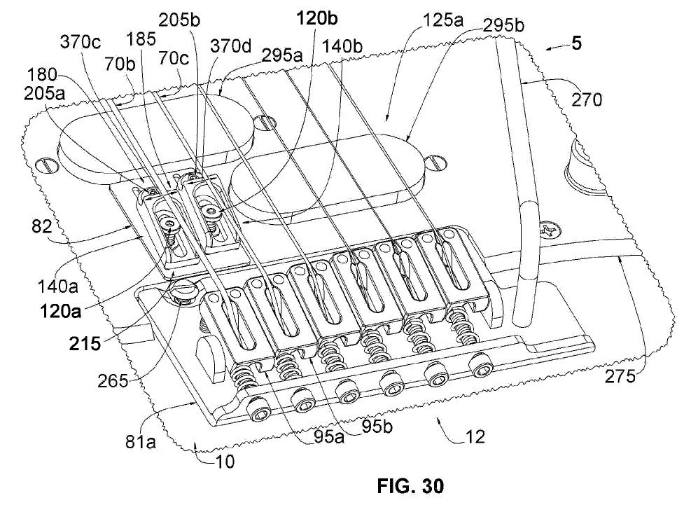

In combination, FIGS. 10-12 illustrate the following: A fretting crown 185 includes a string contactable area, which may be used to stop a string 70. A fretting crown may include a proximal lateral end 190a, a distal lateral end 190b, and a fretting crown segment 370. A lateral end of a fretting crown may be rounded, beveled, or both. A fretting crown may be a rounded edge where an upper surface 171 of a fretting appendage 140 and a longitudinally forward surface 170 of the fretting appendage meet. A fretting crown may run substantially laterally, and may be perpendicular to the line of the string. A fretting crown may be machined into a fretting appendage. In some embodiments, the proximal lateral ends of the fretting crown do not extend beyond the lateral sides of the fretting appendage. FIGS. 30, 31, 33, 38, 39, and 48-49 illustrate additional or alternative embodiments with similar features

As illustrated in FIG. 10, a distal lateral side 165b of a first fretting appendage 140a and a distal lateral end 190b of a fretting crown 185 of the first fretting appendage may be laterally between the proto string 70b and the deutero string 70c. FIGS. 20-24, 28, 36, 61, and 63 illustrate similar features in additional or alternative embodiments.

As illustrated in FIG. 10, a pivot 210 of a fretting appendage 140 may contact a support at two or more points. The pivot may resist rotation of a fretting appendage around an axis parallel with a string 70, allowing vertical positions of two lateral ends 190 of a fretting crown 185 to be adjusted substantially equally. A pivot which contacts a support at two or more points may maintain a fingerboard matching angle of a fretting crown within one degree clockwise or one degree counter-clockwise (around an axis parallel with the string) during an adjustment of a vertical position of the fretting crown of 3 mm or less. A pivot and a height screw 205 may support a fretting appendage at three or more points (which may form a tripod), including during sliding longitudinal adjustment and vertical adjustment, including with the fretting end and fretting crown in a raised position.

A pivot 210 may support the vertical position of a fretting appendage during adjustment of the longitudinal position of the fretting appendage, including the fretting end 180 and fretting crown 185. The pivot may be longitudinally spaced from the fretting end and fretting crown.

In combination, FIGS. 10, 11, and 14 illustrate the following: A fretting appendage support 82 may be positioned on and coupled to a body 10. A fretting appendage 140 may be positioned on and coupled to the body by the fretting appendage support, to which the fretting appendage may couple. The fretting appendage support may include a (substantially planar) upward facing guide surface contacted by a pivot 210 of the fretting appendage, and to which the pivot may be locked by a fastener. A fretting appendage support may contact or otherwise engage a height screw 205 respective to a fretting appendage. The guide surface of a fretting appendage support under a fretting appendage may be in a plane parallel to a plane approximated by the strings 70. A fretting appendage support, including the guide surface contacted by the fretting appendage, may extend under a fretting appendage and under a respective string. A fretting appendage support may be on a body at least partly laterally between a laterally distal string and a laterally proximal string, one of which may be the string intended for use with the fretting appendage. The fretting appendage support may extend laterally proximally and laterally distally under the wrist fretting string, on the surface of the body. The fretting appendage support may be at a vertically lower level than the laterally proximal string and the laterally distal string. The laterally proximal string and the laterally distal string may extend above the fretting appendage support. FIGS. 20-24, 30, 31, and 33 illustrate additional or alternative embodiments with similar features.

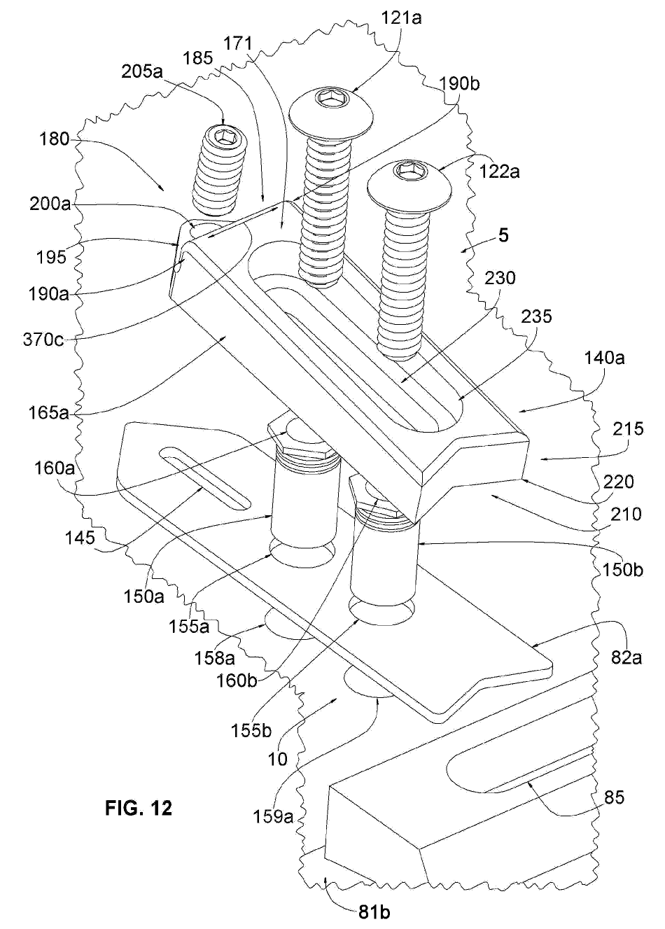

In combination, FIGS. 10 and 12 illustrate the following: A fretting crown 185 may extend under one or more strings 70. A string contactable area of a fretting crown usable for wrist fretting with a specific string (without bending the string) may be understood to be a fretting crown segment 370.

A fretting crown may include one, two, three, four, five, six, or more fretting crown segments. A fretting crown may extend laterally under one, two, three, four, five, or more, strings

In additional or alternative embodiments, a fretting appendage with two, three, or more fretting crown segments may be used with an instrument similar to an instrument as shown and described in FIG. 10. The fretting appendage may be laterally positioned to place each fretting crown segment under a respective string. With appropriate adaptation, any fretting appendage in this disclosure may be configured with one fretting crown segment or with multiple fretting crown segments, and may be positioned for use with one string or for use with multiple strings.

In FIGS. 10 and 12 a one string fretting crown 185 includes a first fretting crown segment 370c. The one string fretting crown may extend laterally under a single string 70, and may be of a width for use with one string.

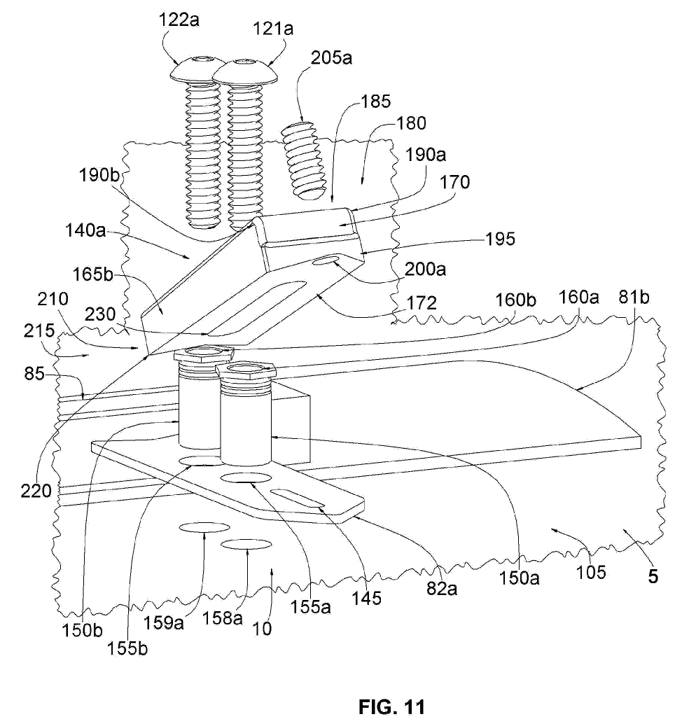

In combination, FIGS. 11, 12, and 14 illustrate the following: A fretting appendage support 82 may include a longitudinal slot in the form of a guide groove 145. The guide groove may be centered under a string 70 and positioned to capture a lower end of a height screw 205, restricting lateral movement. A height screw may partly insert or fully insert into a guide groove. The height screw may slide along the guide groove in a support during adjustment of a longitudinal position of a fretting appendage 140 (including a fretting crown 185). The height screw may support the fretting appendage during sliding longitudinal repositioning. A fastener may lock the height screw against the support. FIGS. 26, 31, 33, 35, 47, 62, and 64 illustrate similar features in additional or alternative embodiments.

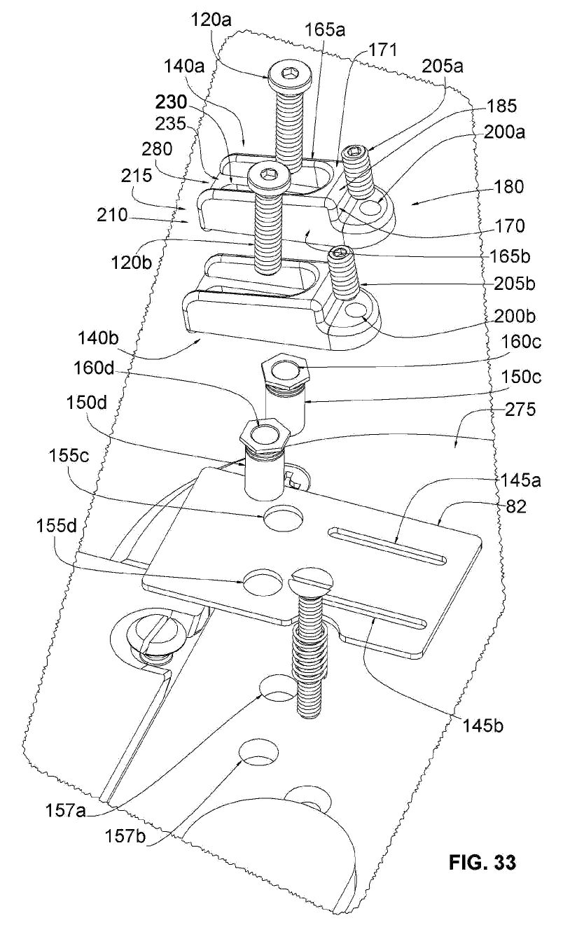

In combination, FIGS. 12 and 14 illustrate the following: A fretting appendage 140 may include a fretting end 180, which may include a fretting crown 185. The fretting end may be opposite a supporting end 215 of the fretting appendage. The supporting end may include a pivot 210. The fretting appendage may be vertically thicker at the fretting crown than at the pivot. The fretting end may include other features, such as a height tab 195. A lateral edge or a corner of an upper surface 171 of the fretting appendage may be beveled, rounded, or both. The pivot may be longitudinally spaced from the fretting end 180 of the fretting appendage. The pivot may be between the fretting end and a saddle means. A vertical position of the fretting end (including the fretting crown) may be adjustable relative to a string 70, a support, and a body 10, by pivoting the fretting appendage on the pivot. The fretting end may be pivoted up or down to adjust the fretting crown closer to or farther from the string. The fretting appendage may be supported on the support on the body by the pivot, which may be positioned on the body on the support. A pivot may be understood to be a feature enabling a rotation movement. A pivot may slide along the support during longitudinal adjustment of a fretting appendage. FIGS. 33, 35, 38, 41, 46-49, 59, 61, and 63 illustrate similar features in additional or alternative embodiments.

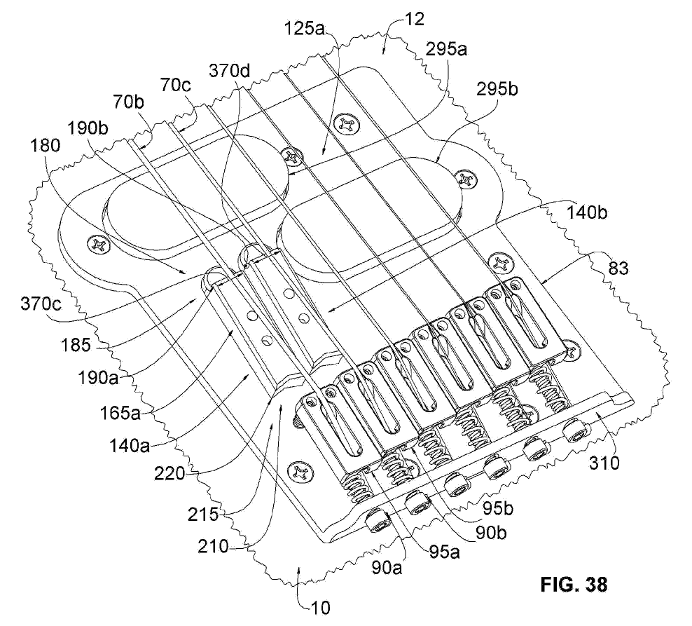

As illustrated in FIG. 12, a pivot 210 may include two lateral contact projections 220. The contact projections may contact a support at two laterally spaced points. FIGS. 32 and 38 illustrate similar features in additional or alternative embodiments.

Illustrations in FIGS. 13-17 illustrate a way of setting up an instrument 5 in an intonated manner, according to some embodiments. A first pickup 125a and a second pickup 125b may be coupled to a top 25. Because the instrument is adjustable, other setups are possible.

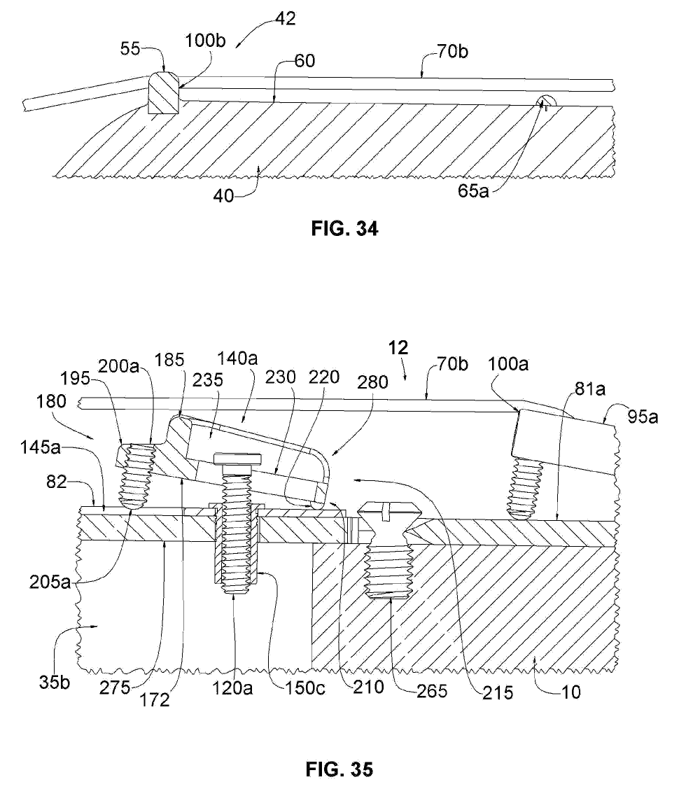

In combination, FIGS. 13-17 illustrate the following: A proto string 70b may extend at a wrist fretable vertical distance above a fretting crown 185 of a fretting end 180 of a first fretting appendage 140a. The fretting crown may be positioned to define a wrist fretable note a semitone above an open note of the proto string. The fretting crown may be positioned such that each fingerboard fret, including an eighteenth fingerboard fret 65d (which may be the longitudinally rearmost fingerboard fret), may be used with the proto string to play a fretted fingerboard note. To intonate the fretted fingerboard notes, a distance between a longitudinally rearward critical contact point 100a of the proto string on a saddle 95 and a longitudinally forward critical contact point 100b of the proto string on a nut 55 may be greater than a neck scale length. To make each fingerboard fret on the fingerboard playable, a vertical distance between the fretting crown and the proto string may be adjusted to be greater than a vertical distance between a first fingerboard fret 65a and the proto string. A distance from the fretting crown to the longitudinally rearward critical contact point may be less than a nominal semitone oddment length, and less than the distance from the first fingerboard fret to the longitudinally forward critical contact point, which may be a nominal semitone oddment length. In other words, a distance between the fretting crown and the saddle (on the line of the string) may be shorter than a distance between the first fingerboard fret and the nut (on the line of the string). FIGS. 34, 35, 40, and 41 illustrate similar setups in additional or alternative embodiments.

In combination, FIGS. 15 and 16 illustrate the following: An instrument 5 may be set up in a similar manner as in FIGS. 13 and 14. A fretting crown 185 may be positioned such that an eighteenth fingerboard fret 65d may be used with the string 70 to play a fretted fingerboard note. A broken line may represent the position of a bottom of the string when the string is fretted against the eighteenth fingerboard fret. The fretting crown may be vertically positioned to be as close to the string as possible while still allowing a fretted fingerboard note at the eighteenth fingerboard fret to be played. If the fretting crown were at the same vertical distance from the string as the first fingerboard fret, the fretting crown would be above the broken line, and the eighteenth fingerboard fret would not be playable. A distance from the fretting crown to the nut (measured from the forward critical contact point) may be greater than a distance from the first fingerboard fret to the saddle 95 (measured from the rearward critical contact point); the extra sounding length of the wrist fretable note may compensate for the relatively greater string height at the fretting crown than at the first fingerboard fret, and may intonate the wrist fretable note.

As illustrated in FIG. 17, an instrument 5 may be set up as in FIGS. 13-16. The solid line represents a fretting appendage 140 in the same position as the fretting appendage in FIGS. 14-16. The broken line represents the fretting appendage in a second position. For clarity, a height screw is not shown. As indicated by the solid line, the fretting end 180 of the fretting appendage may be in the highest vertical position in which the eighteenth fingerboard fret remains playable. As indicated by the broken line, the fretting end of the fretting appendage may be in the lowest vertical position in which the fretting crown 185 defines a wrist fretted note a semitone above the open note of the string 70; a position lower than this second position might make it unusable. The position of the fretting appendage as indicated by the solid line may be further longitudinally forward than the second position as indicated by the broken line; by moving the fretting appendage longitudinally rearward, the sounding length of the wrist fretted note may be lengthened, counteracting the increase in the pitch of the wrist fretted note due to the increase in the vertical distance from the fretting crown to the string. The two fretting crown positions in FIG. 17 may each define the same wrist fretable note a semitone above an open note of the respective string 70. In each position, the wrist fretable note is intonated. A longitudinal distance from the solid line position to the broken line position may be about 1% of a longitudinal distance from a longitudinally rearward end of the fingerboard to the saddle means.

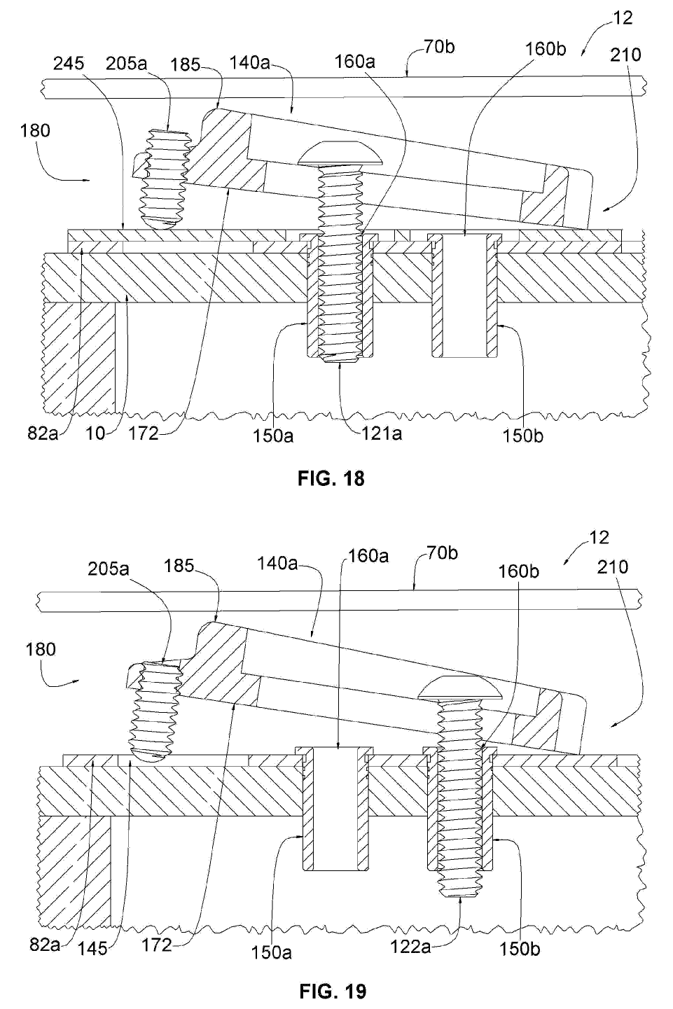

As illustrated in FIG. 18, an optional and removable shim 245 is positioned on a guide surface of a fretting appendage support 82 under a fretting appendage 140. The shim may be positioned under and in contact with a pivot 210 of the fretting appendage and under a height screw 205 inserted into the fretting appendage. The shim may be positioned between the fretting appendage and the support, and thus between the fretting appendage and a body 10. The shim may include an upward facing guide surface which acts as a guide surface of a support. The shim may adjust a vertical position of the fretting appendage (including a fretting crown 185) by inserting between the fretting appendage and the fretting appendage support. The shim may be of the same lateral width as the fretting appendage support. A shim may include an opening allowing a fastener to insert.

A shim may be used as an alternative to a height screw 205, or in conjunction with a height screw. A shim may be contacted by a pivot 210 of a fretting appendage, by a downward surface 172 of a fretting appendage, or by the height screw.

In additional or alternative embodiments, multiple shims may be stacked for vertical adjustment. In further additional or alternative embodiments, a shim in the form of a wedge may be used for vertical adjustment; a sliding action of a shim may be used for vertical adjustment. In still further additional or alternative embodiments, a shim may be positioned between a height screw and a fretting appendage.

In combination, FIGS. 18 and 19 illustrate the following: An assembly 12 on a body 10 includes a first fretting appendage support 82a including a longitudinally forward threaded insert 150a (with a longitudinally forward fastening opening 160a) and a longitudinally rearward threaded insert 150b (with a longitudinally rearward fastening opening 160b). A first fretting appendage 140a may be attached to the first fretting appendage support with a single fastener. Either a first longitudinally forward fastener 121aor a first longitudinally rearward fastener 122a may be independently capable of locking the position of the fretting appendage, coupling it to the support and to the body. A fretting end 180 of the first fretting appendage includes a height adjustment hole into which a first height screw 205a is inserted. The first height screw may be captured by a guide groove 145 in the first fretting appendage support or may contact a shim 245. The first height screw may adjust the vertical position of the fretting end by pivoting the first fretting appendage on a pivot 210. A downward surface 172 of the first fretting appendage may face downward. A proto string 70b may be above a fretting crown 185 of the fretting end.

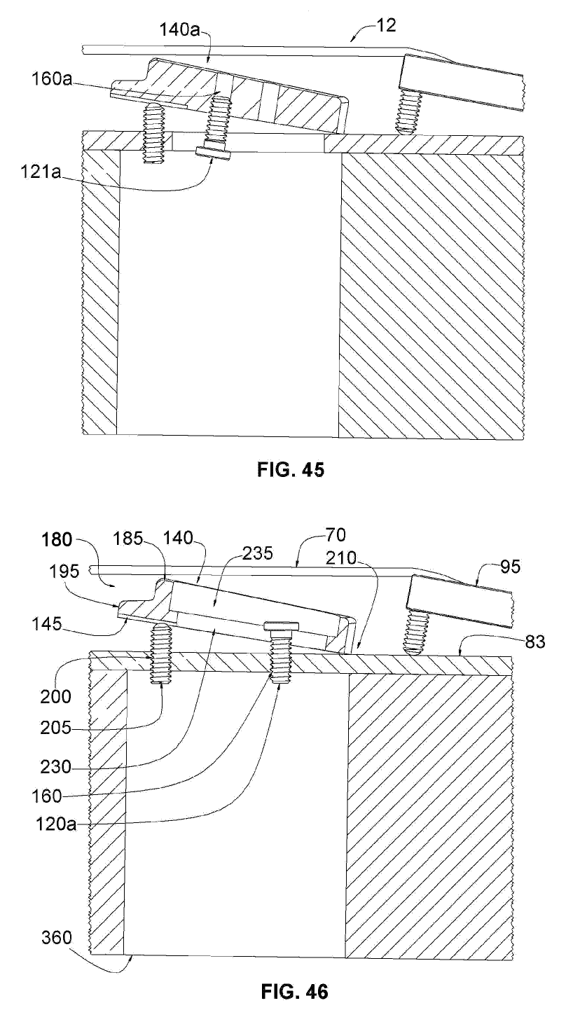

As illustrated in FIG. 18, a longitudinally forward fastener 121 is inserted into a longitudinally forward fastening opening 160a. An assembly 12 may function without a longitudinally rearward fastener. FIG. 45 illustrates an additional or alternative embodiment with a similar setup.

As illustrated in FIG. 19, a longitudinally rearward fastener 122 is inserted into a longitudinally rearward fastening opening 160b. An assembly 12 may function without a longitudinally forward fastener. FIG. 44 illustrates an additional or alternative embodiment with a similar setup.

In FIGS. 20-24 multiple fretting appendage supports 82 are positioned under multiple strings 70. Each fretting appendage support may support an independently positionable fretting appendage.

In combination, FIGS. 20-24 and 26 illustrate the following: There may be a small lateral distance between a fretting appendage support 82 and a consecutive fretting appendage support. There may be a small lateral distance between a fretting appendage 140 and a consecutive fretting appendage. A deutero string 70c may be consecutive to a proto string 70b. A first fretting appendage 140a, under the proto string, may be consecutive to a second fretting appendage 140b under the deutero string. The proto string may be a laterally outermost proximal string.

In combination, FIGS. 20-24 illustrate the following: An assembly 12 may include a saddle 95 in an acoustic saddle support 81b. The saddle may position a longitudinally rearward critical contact point 100a of a string 70 in an individualized lateral, longitudinal, and vertical position.

In FIG. 20, a proximal lateral side 165a of a second fretting appendage 140b and a proximal lateral end 190a of a fretting crown 185 of the second fretting appendage may be laterally between the proto string 70b and the deutero string 70c. A distal lateral side 165b of the second fretting appendage and a distal lateral end 190b of the fretting crown of the second fretting appendage may be laterally between the deutero string and the trito string 70d. FIGS. 21-24, 28, 36, 61, and 63 illustrate similar features in additional or alternative embodiments.

In combination, FIGS. 20, 25, and 26 illustrate the following: A deutero string 70c may be consecutive to a proto string 70b. A second fretting appendage support 82b may insert into a second longitudinally forward insertion opening 158b and a second longitudinally rearward insertion opening 159b in a soundboard 105, which may be aligned with and centered under the deutero string. The second fretting appendage support may be aligned with and centered under the deutero string. The second fretting appendage support, a second height screw 205b, a second longitudinally forward fastener 121b, and a second longitudinally rearward fastener 122b may align a second fretting appendage 140b with the deutero string, and may center a fretting crown 185 of the second fretting appendage under the deutero string. The deutero string may emerge from a second stringing opening 90b, and may be directed by a saddle 95 above the second fretting appendage and a fingerboard, to a nut. The proto string may be a laterally outermost proximal string. Each fastener may be configured to lock the longitudinal and vertical position of the respective fretting appendage, which may be a block.

As illustrated in FIG. 20, a first fretting appendage 140a may include a fretting crown including a first fretting crown segment under a proto string 70b. A second fretting appendage 140b may include a fretting crown 185 including a second fretting crown segment 370d under a deutero string 70c. Each fretting crown may be a one string fretting crown. The first fretting appendage may be a laterally proximal block with a first fretting crown, and the second fretting appendage may be a laterally distal block with a second fretting crown. The fretting crown of each block may define a wrist fretable note a semitone above the note of its respective string. Each block may be adjustably positionable on the body. A longitudinal position of each block may be adjustable relative to the saddle means and relative to the other block. A vertical position of the fretting end (and fretting crown) of each block may be adjustable relative to its respective string and to the other block.

As illustrated in FIG. 20 a plurality of consecutive strings may be as follows: A proto string 70b, which may be a laterally outermost proximal string, and a deutero string 70c may be wrist fretting strings. A trito string 70d, a tetarto string 70e, a pempto string 70f, and a hecto string 70g may be single direction fretting strings. FIGS. 28, 36, 50 and 55 illustrate similar features in additional or alternative embodiments.

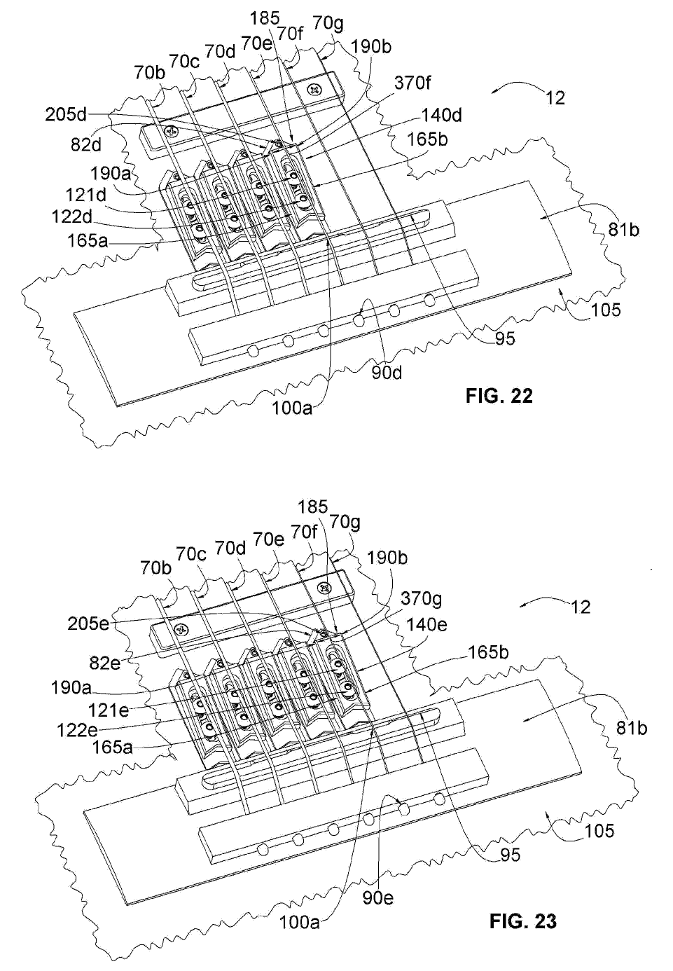

As illustrated in FIG. 21, a proximal lateral side 165a of a third fretting appendage 140c and a proximal lateral end 190a of a fretting crown 185 of the third fretting appendage may be laterally between the deutero string 70c and the trito string 70d. A distal lateral side 165b of the third fretting appendage and a distal lateral end 190b of the fretting crown of the third fretting appendage may be laterally between the trito string and the tetarto string 70e. FIGS. 22-24 illustrate similar features in additional or alternative embodiments.

In combination, FIGS. 21, 25, and 26 illustrate the following: A trito string 70d may be consecutive to a deutero string 70c, which may be consecutive to a proto string 70b. A third fretting appendage support 82c may insert into a third longitudinally forward insertion opening 158c and a third longitudinally rearward insertion opening 159c in a soundboard 105, which may be aligned with and centered under the trito string. The third fretting appendage support may be aligned with and centered under the trito string. The third fretting appendage support, a third height screw 205c, a third longitudinally forward fastener 121c, and a third longitudinally rearward fastener 122c may align a third fretting appendage 140c with the trito string, and may center a fretting crown 185 of the third fretting appendage under the trito string. The trito string may emerge from a third stringing opening 90c, and may be directed by a saddle 95 above the third fretting appendage and a fingerboard, to a nut. The proto string may be a laterally outermost proximal string.

As illustrated in FIG. 21, a third fretting appendage 140c may include a fretting crown 185 including a third fretting crown segment 370e under a trito string 70d. The fretting crown may be a one string fretting crown.

As illustrated in FIG. 21, a plurality of consecutive strings may be as follows: A proto string 70b, which may be a laterally outermost proximal string, a deutero string 70c, and a trito string 70d may be wrist fretting strings. A tetarto string 70e, a pempto string 70f, and a hecto string 70g may be single direction fretting strings.

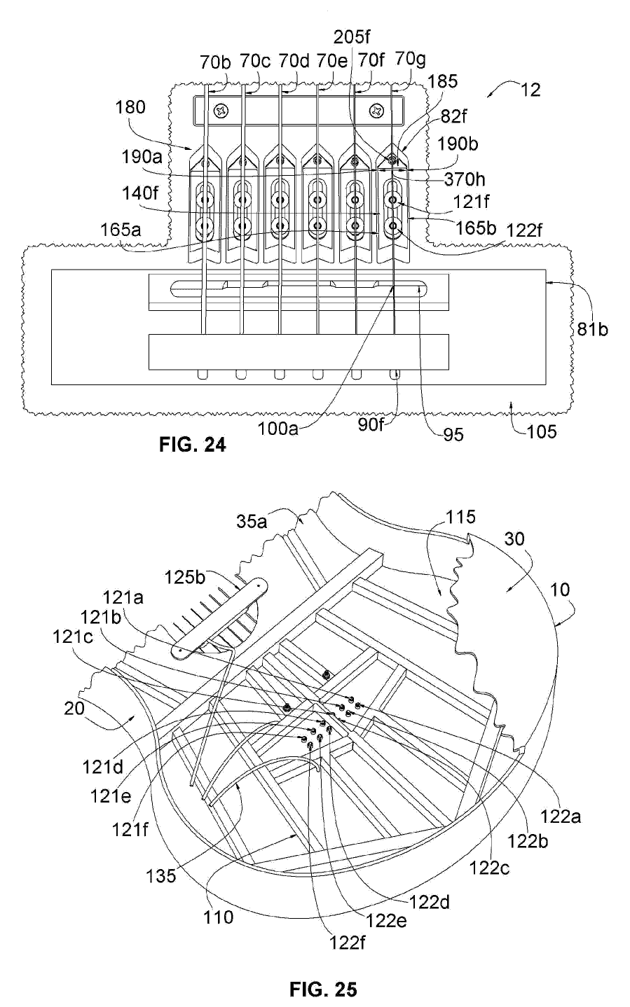

In FIG. 22, a proximal lateral side 165a of a fourth fretting appendage 140d and a proximal lateral end 190a of a fretting crown 185 of the fourth fretting appendage may be laterally between the trito string 70d and the tetarto string 70e. A distal lateral side 165b of the fourth fretting appendage and a distal lateral end 190b of the fretting crown of the fourth fretting appendage may be laterally between the tetarto string and the pempto string 70f. FIGS. 23 and 24 illustrate similar features in additional or alternative embodiments.

In combination, FIGS. 22, 25, and 26 illustrate the following: A tetarto string 70e may be consecutive to a trito string 70d, which may be consecutive to a deutero string 70c, which may be consecutive to a proto string 70b. A fourth fretting appendage support 82d may insert into a fourth longitudinally forward insertion opening 158d and a fourth longitudinally rearward insertion opening 159d in a soundboard 105, which may be aligned with and centered under the tetarto string. The fourth fretting appendage support may be aligned with and centered under the tetarto string. The fourth fretting appendage support, a fourth height screw 205d, a fourth longitudinally forward fastener 121d, and a fourth longitudinally rearward fastener 122d may align a fourth fretting appendage 140d with the tetarto string, and may center a fretting crown 185 of the fourth fretting appendage under the tetarto string. The tetarto string may emerge from a fourth stringing opening 90d, and may be directed by a saddle 95 above the fourth fretting appendage and a fingerboard, to a nut. The proto string may be a laterally outermost proximal string.

As illustrated in FIG. 22, a fourth fretting appendage 140d may include a fretting crown 185 including a fourth fretting crown segment 370f under the tetarto string 70e. The fretting crown may be a one string fretting crown.

In FIG. 22, a plurality of consecutive strings may be as follows: A proto string 70b, which may be a laterally outermost proximal string, a deutero string 70c, a trito string 70d, and a tetarto string 70e may be wrist fretting strings. A pempto string 70f and a hecto string 70g may be single direction fretting strings.

In FIG. 23, a proximal lateral side 165a of a fifth fretting appendage 140e and a proximal lateral end 190a of a fretting crown 185 of the fifth fretting appendage may be laterally between the tetarto string 70e and the pempto string 70f. A distal lateral side 165b of the fifth fretting appendage and a distal lateral end 190b of the fretting crown of the fifth fretting appendage may be laterally between the pempto string and the hecto string 70g. FIG. 24 illustrates similar features in an additional or alternative embodiment.

In combination, FIGS. 23, 25, and 26 illustrate the following: A pempto string 70f may be consecutive to a tetarto string 70e, which may be consecutive to a trito string 70d, which may be consecutive to a deutero string 70c, which may be consecutive to a proto string 70b. A fifth fretting appendage support 82e may insert into a fifth longitudinally forward insertion opening 158e and a fifth longitudinally rearward insertion opening 159e in a soundboard 105, which may be aligned with and centered under the pempto string. The fifth fretting appendage support may be aligned with and centered under the pempto string. The fifth fretting appendage support, a fifth height screw 205e, a fifth longitudinally forward fastener 121e, and a fifth longitudinally rearward fastener 122e may align a fifth fretting appendage 140e with the pempto string, and may center a fretting crown 185 of the fifth fretting appendage under the pempto string. The pempto string may emerge from a fifth stringing opening 90e, and may be directed by a saddle 95 above the fifth fretting appendage and a fingerboard, to a nut. The proto string may be a laterally outermost proximal string.

As illustrated in FIG. 23, a fifth fretting appendage 140e may include a fretting crown 185 including a fifth fretting crown segment 370g under a pempto string 70f. The fretting crown may be a one string fretting crown.

As illustrated in FIG. 23, a plurality of consecutive strings may be as follows: A proto string 70b, which may be a laterally outermost proximal string, a deutero string 70c, a trito string 70d, a tetarto string 70e, and a pempto string 70f may be wrist fretting strings. A hecto string 70g may be a single direction fretting string.

In FIG. 24, a proximal lateral side 165a of a sixth fretting appendage 140f and a proximal lateral end 190a of a fretting crown 185 of the sixth fretting appendage may be laterally between the pempto string 70f and the hecto string 70g. A distal lateral side 165band a distal lateral end 190b of the sixth fretting appendage laterally distal to and at a lower vertical level than the hecto string.

In combination, FIGS. 24-26 illustrate the following: A hecto string 70g may be consecutive to a pempto string 70f, which may be consecutive to a tetarto string 70e, which may be consecutive to a trito string 70d, which may be consecutive to a deutero string 70c, which may be consecutive to a proto string 70b. A sixth fretting appendage support 82f may insert into a sixth longitudinally forward insertion opening 158f and a sixth longitudinally rearward insertion opening 159f in a soundboard 105, which may be aligned with and centered under the hecto string. The sixth fretting appendage support may be aligned with and centered under the hecto string. The sixth fretting appendage support, a sixth height screw 205f, a sixth longitudinally forward fastener 121f, and a sixth longitudinally rearward fastener 122f may align a sixth fretting appendage 140f with the hecto string, and may center a fretting crown 185 of the sixth fretting appendage under the hecto string. The hecto string may emerge from a sixth stringing opening 90f, and may be directed by a saddle 95 above the sixth fretting appendage and a fingerboard, to a nut. The proto string may be a laterally outermost proximal string.

As illustrated in FIG. 24, a sixth fretting appendage 140f may include a fretting crown 185 including a sixth fretting crown segment 370h under the hecto string 70g. The fretting crown may be a one string fretting crown.

As illustrated in FIG. 24, a plurality of consecutive strings may be as follows: A proto string 70b, which may be a laterally outermost proximal string, a deutero string 70c, a trito string 70d, a tetarto string 70e, a pempto string 70f, and a hecto string 70g may be wrist fretting strings.

In combination, FIGS. 24 and 26 illustrate the following: One or more supports may include a fastening opening for each of multiple fretting appendages 140. A fastening opening respective to a fretting appendage may be centered under that fretting appendage’s respective string 70. When a support includes two fastening openings for a single fretting appendage, such as a longitudinally forward fastening opening 160a and a longitudinally rearward fastening opening 160b, the two fastening openings may be aligned with the respective string, longitudinally spaced, and centered under that string. Because the lines of the strings may converge slightly toward the nut, lines of longitudinal adjustment of fretting appendages delineated by pairs of fastening openings may converge slightly toward the nut. A longitudinally forward fastener 121 and a longitudinally rearward fastener 122 may insert into a longitudinally forward fastening opening and a longitudinally rearward fastening opening.

As illustrated in FIG. 24, an assembly 12 may include a fretting appendage 140 for any string 70 of a plurality of strings. A longitudinal position of each fretting appendage and a vertical position of a fretting end 180 of each fretting appendage may be adjustable without altering a longitudinal position or a vertical position of another fretting appendage or of a saddle 95. Lateral widths of the fretting appendages may allow fretting appendages to be positioned under consecutive strings without the fretting appendages contacting one another. A fretting crown 185 of each fretting appendage may define a wrist fretable note a semitone above an open note of its respective string. Each fretting appendage (including its respective fretting crown) may be repositionable along a line of longitudinal adjustment substantially parallel with (and along the line of) its respective string.

The following paragraph discloses fingerboard matching angles of fretting crowns as may be used in conjunction with any of the other disclosure throughout the present specification.

In combination, FIGS. 24 and 27 illustrate the following: A fingerboard 60 may include a fingerboard angle 255 (respective to a string 70), and a fretting crown 185 (respective to that string) may include a fingerboard matching angle 250. A fingerboard matching angle may allow a string 70 above the fretting crown to vibrate freely when a player plucks an open note or a fretted fingerboard note. The fingerboard matching angle may allow the fretting hand to bend the string without “fretting out” on the fretting crown. FIGS. 32, 43, 54, and 57 illustrate similar features in additional or alternative embodiments.

As illustrated in FIG. 25, a body 10 may include a laterally distal body side 20. The body may include a back 30. A first longitudinally forward fastener 121aand a first longitudinally rearward fastener 122a may couple a first fretting appendage to the body. A brace 110 attached to an underside 115 of a soundboard may strengthen the soundboard and may be shaped and positioned to allow insertion of parts of an assembly. A ground wire 135 in an acoustic body cavity 35a may ground strings. A second pickup 125b may be mounted in the sound hole.

As illustrated in FIG. 26, a first stringing opening 90a may allow attachment of a proto string to an acoustic saddle support 81b. A first fretting appendage support 82a may insert into a first longitudinally forward insertion opening 158a and a first longitudinally rearward insertion opening 159a. A guide groove 145 in a sixth fretting appendage support 82f may capture the lower end of a sixth height screw 205f, which adjusts the vertical position of a sixth fretting appendage 140f.

As illustrated in FIG. 27, a fingerboard matching angle 250 of a fretting crown 185 of a fretting appendage 140 may match a fingerboard angle 255 of a fingerboard 60. The fingerboard may be flat. With the flat fingerboard, the fingerboard angle and the fingerboard matching angle of the fretting crown may be about zero degrees.

As illustrated in FIG. 27, a fretting crown of a first fretting appendage 140a may include a first fingerboard matching angle 250a, which may match a first fingerboard angle 255a of a fingerboard 60. A fretting crown of a second fretting appendage 140b may include a second fingerboard matching angle 250b, which may match a second fingerboard angle 255bof the fingerboard. A fretting crown of a third fretting appendage 140c may include a third fingerboard matching angle 250c, which may match a third fingerboard angle 255cof the fingerboard. A fretting crown of a fourth fretting appendage 140d may include a fourth fingerboard matching angle 250d, which may match a fourth fingerboard angle 255d of the fingerboard. A fretting crown of a fifth fretting appendage 140emay include a fifth fingerboard matching angle 250e, which may match a fifth fingerboard angle 255e of the fingerboard. A fretting crown 185 of a sixth fretting appendage 140f may include a sixth fingerboard matching angle 250f, which may match a sixth fingerboard angle 255f of the fingerboard. In alternative or additional embodiments, other instruments may include a similar fingerboard and a fretting appendage with a similar fingerboard matching angle.

In combination, FIGS. 28 and 29 illustrate the following: An instrument 5 may include a body 10. A neck 40 may include a longitudinally rearward end 43 connected to the body and a longitudinally forward end 42 away from (remote from) the body. Tuning machines 50 on a headstock 45 of the neck may tension strings including a proto string 70b, a deutero string 70c, a trito string 70d, a tetarto string 70e, a pempto string 70f, and a hecto string 70g. A string may contact a nut 55 at a longitudinally forward critical contact point 100b, extend above a sequence of fingerboard frets, including a first fingerboard fret 65a, a second fingerboard fret 65b, a twelfth fingerboard fret 65f, a thirteenth fingerboard fret 65c, and a twenty-first fingerboard fret 65e, and contact a saddle means at a longitudinally rearward critical contact point 100a. The body may include a top 25, a back 30, a laterally distal body side 20, and a laterally proximal body side 15. At the back, a plate may cover a body cavity. Consecutive strings at the saddle means may be spaced, center to center, at a lateral string spacing 75.

In combination, FIGS. 28, 30, and 31 illustrate the following: An instrument 5 may have an electric six string guitar form. A vibrato mechanism saddle support 81amay be coupled to a body 10. A saddle means may include six saddles 95, which may be coupled to the vibrato mechanism saddle support. Each saddle may be independently vertically positionable and longitudinally positionable. The saddles may be locked in place by a saddle lock 260. The vibrato mechanism saddle support may include a string retainer, may be positioned by two vibrato screws 265, and may allow coupling of a whammy bar 270 to enable vibrato.

In combination, FIGS. 28, 30, 31, and 35 illustrate the following: A vibrato mechanism saddle support 81a of an assembly 12 may include a vibrato mechanism. The vibrato mechanism saddle support may have vibrato function, and the assembly may include a whammy bar 270 connecting to the vibrato mechanism saddle support. Two vibrato screws 265 may position the vibrato mechanism saddle support and act as a vibrato fulcrum. A vibrato mechanism saddle support may include a saddle lock 260, which locks a saddle means in place. A vibrato mechanism saddle support may include a vibrato block, a claw, a claw screw, and/or a spring. A vibrato mechanism saddle support may additionally or alternatively include other vibrato features, such as those of double locking vibrato mechanisms.

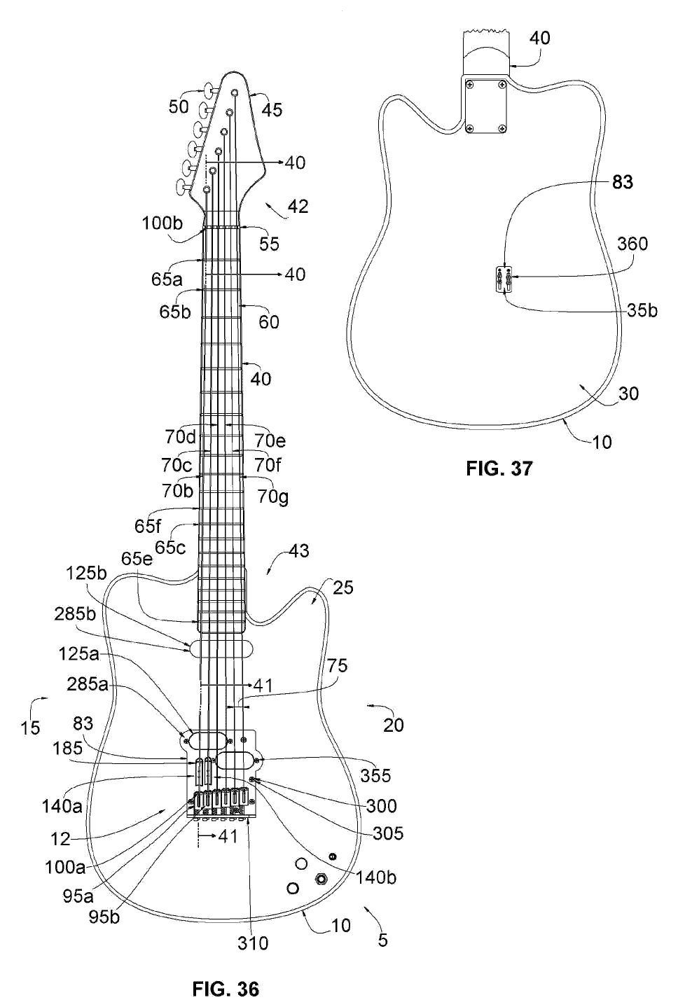

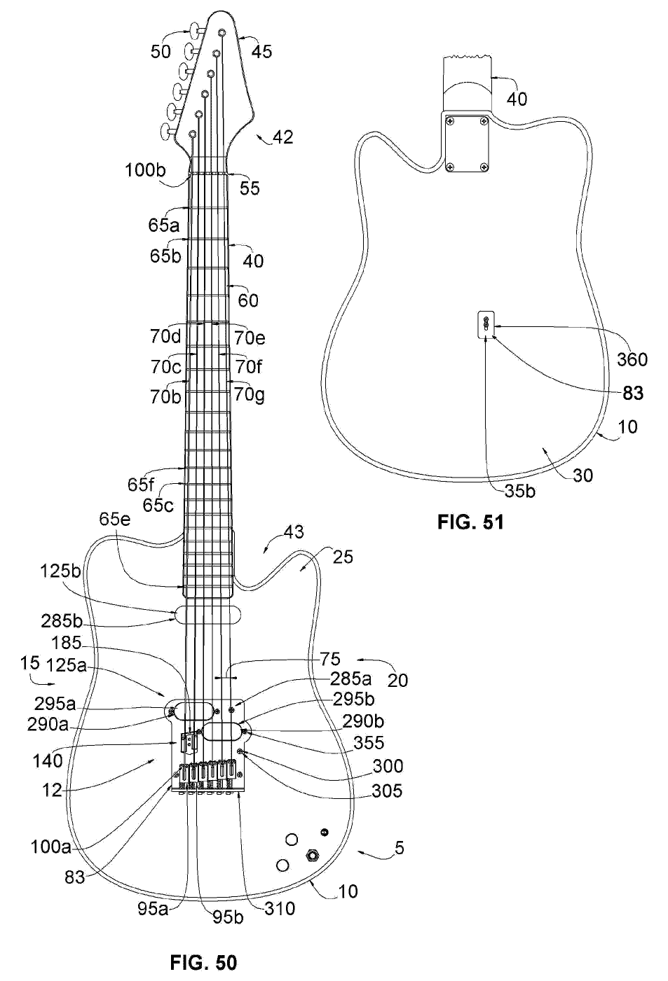

As illustrated in FIG. 28, a nineteenth fingerboard fret, a twentieth fingerboard fret, and a twenty-first fingerboard fret 65e of a sequence of fingerboard frets may define fretted fingerboard notes an octave and a perfect fifth, an octave and a minor sixth, and an octave and a major sixth above an open note of a string 70. The twenty-first fingerboard fret may be longitudinally rearmost of the fingerboard frets. FIGS. 36 and 50 illustrate additional or alternative embodiments with similar features.

In any embodiment with fingerboard frets, the number of fingerboard frets may be varied.

In combination, FIGS. 28, 30, 33, and 35 illustrate the following: A fretting appendage support 82 may be thin, strong, and lightweight; it may include thin sheet steel or another material. The fretting appendage support may include a first guide groove 145a, a second guide groove 145b, a first threaded insert 150c inserted into a first insert opening 155c, and a second threaded insert 150d inserted into a second insert opening 155d. The threaded inserts may be coupled (by welding, or alternatively, another means of attachment, such as an adhesive) to the fretting appendage support. The first threaded insert may include a first fastening opening 160c. The second threaded insert may include a second fastening opening 160d. The first threaded insert may insert into a first insertion opening 157ain a pickguard 275. The first guide groove and the first fastening opening may be aligned with and centered under a proto string 70b. The second threaded insert may insert into a second insertion opening 157b in the pickguard. The second guide groove and the second fastening opening may be aligned with and centered under a deutero string 70c. Each guide groove may be longitudinally forward of its respective fastening opening. The fretting appendage support may be adhesively coupled to the pickguard. The fretting appendage support may be on the pickguard, and may be longitudinally forward of a vibrato mechanism saddle support 81a.

In combination, FIGS. 28, 30, 31, 33, and 35 illustrate the following: Two fretting appendages 140 may be coupled to a fretting appendage support 82. For each fretting appendage, the fretting appendage may include a proximal lateral side 165a, a distal lateral side 165b, a longitudinally forward surface 170, an upper surface 171 with rounded lateral edges, and a downward surface 172. A fretting end 180 of the fretting appendage may include a fretting crown 185. The fretting crown may be a rounded edge where the upper surface and the longitudinally forward surface meet, and may include a proximal lateral end 190aand a distal lateral end 190b, which may be rounded, and a fretting crown segment 370. A height tab 195 at the fretting end may include a height adjustment hole 200. A height screw 205 may insert into the height adjustment hole. A lower end of the height screw may be captured by a guide groove 145, which may be narrow enough to minimize contact with a pickguard 275. A pivot 210 in a lower location at a supporting end 215 of the fretting appendage may include two hemispherical lateral contact projections 220 (A contact projection of a pivot may have this shape or another shape in any embodiment). The two contact projections may contact an upward facing guide surface of the fretting appendage support (or of a shim on the fretting appendage support) at two points along a line perpendicular to the line of a string 70. A through slot 230 and a recess 235 may be centered between the lateral sides of the fretting appendage, with the recess in an upper location. A fastener may insert through the through slot into a fastening opening 160 in the fretting appendage support. A head of the fastener may seat in the recess. A gap 280 at a rearward longitudinal end of the recess, for the head of the fastener, may lengthen a longitudinal positioning range of the fretting appendage. The fretting appendage may be centered under the string. In longitudinal order, from rearmost to foremost the instrument may include: a saddle 95, the pivot, the through slot, the fretting crown, the height adjustment hole, a proximal lateral opening 290a of a first pickup opening 285a in the pickguard, a second pickup opening 285b in the pickguard, a sequence of fingerboard frets, and a nut 55.

In combination, FIGS. 28, 30, 31, 33, and 35 illustrate the following: A first guide groove 145a, a first fastening opening 160c, a first height screw 205a, and a first fastener 120a may align a first fretting appendage 140awith a proto string 70b, and center a fretting crown 185 of the first fretting appendage under the proto string. A first saddle 95a may direct the proto string above the first fretting appendage and a fingerboard 60, to a nut 55. A second guide groove 145b, a second fastening opening 160d, a second height screw 205b, and a second fastener 120b may align a second fretting appendage 140bwith a deutero string 70c, and may center a fretting crown of the second fretting appendage under the deutero string. A second saddle 95bmay direct the deutero string above the second fretting appendage and the fingerboard to the nut. Each fretting crown may be positionable such that it defines a wrist fretable note a semitone above an open note of its respective string.

In combination, FIGS. 28 and 32 illustrate the following: An instrument 5 may include a neck 40 with a curved fingerboard 60. Each fretting appendage may include a fingerboard matching angle 250. A fingerboard angle 255 may manifest as a tangent to a curve of a surface of the fingerboard under a string 70; a fingerboard angle may be measured near the longitudinally rearmost fingerboard fret of a sequence of fingerboard frets. FIGS. 36, 43, 50, 54, and 57 illustrate similar features in additional or alternative embodiments.

In combination, FIGS. 28, 30, 31, 33 and 35 illustrate the following: Pickguard screws 380 may couple a pickguard 275 to a body 10 through pickguard screw holes of the pickguard. A pickguard may cover an electric body cavity 35bof a body. A fretting appendage support 82 may be coupled to the pickguard. A fretting appendage 140 may be coupled to the fretting appendage support. The fretting appendage support may be positioned on and coupled to the body by the pickguard. A pickguard may include a pickup opening 285. The pickguard and a fretting appendage support may align a fretting appendage, a pickup opening, and a pickup 125 with a string 70.

A fretting appendage support may function as a part of a pickguard. A guide groove, through slot, or fastening opening, or other features of a fretting appendage support may be part of a pickguard, and a threaded insert may be installed in a pickguard. In additional or alternative embodiments, a pickguard may be used with or coupled to a common support of a fretting appendage and a saddle means, or coupled to a saddle support. A pickguard may be attached to a body with pickguard screws, an adhesive, or in another way.

As illustrated in FIG. 28, a pickup 125 is mounted under a string 70, longitudinally forward of a fretting appendage 140 and longitudinally rearward of a sequence of fingerboard frets. When the string is wrist fretted and plucked, a rearward longitudinal end of a sounding length of the string may be nearer to the pickup than when the open string is plucked. This may produce a brightening of the sound that some players may enjoy; this effect may get stronger as the pickup is mounted nearer to the fretting appendage. In additional and alternative embodiments, the relationship between pickup position, fretting crown position, and pickup tone may be similar.

As illustrated in FIG. 28, a string 70 extends above a fretting crown 185 of a fretting appendage 140, with the fretting crown in a semitone position. A first pickup 125amay be coupled to a body 10, under the string, and near the fretting crown. This pickup position may enable the tone brightening associated with the use of the fretting appendage. A second pickup 125bmay be mounted nearer to the fingerboard 60 of the neck 40. When using the second pickup, the tone brightening effect may be less noticeable; this may produce a mellower tone that some players may enjoy. An additional pickup may be added, a pickup may be attached in an alternative location, or a pickup may be omitted. In alternative or additional embodiments, pickups are in other positions typical of electric guitars and bass guitars.

In combination, FIGS. 28, 30, and 31 illustrate the following: An assembly may include a pickguard 275. The pickguard may be coupled to a top 25 of a body. A first pickup opening 285ain the pickguard may include a proximal lateral opening 290a and a distal lateral opening 290b. A first pickup 125amay include a proximal lateral coil 295a inserted into the proximal lateral opening, and may include a distal lateral coil 295binserted into the distal lateral opening. A second pickup 125bmay insert into a second pickup opening 285b. The pickups may be vertically adjustable.

In combination, FIGS. 28, 30, and 31 illustrate the following: A proximal lateral opening 290a and a distal lateral opening 290b of a first pickup opening 285a may accommodate a first fretting appendage 140a under a laterally outermost proximal string and a second fretting appendage 140b under a consecutive string (in semitone relationships with these strings) while allowing the first pickup 125a to be mounted near a saddle means. The proximal lateral opening and proximal lateral coil 295a (under proximal strings including a laterally outermost proximal string) of the first pickup may be farther longitudinally forward (nearer to the nut and farther from the saddle means) than the distal lateral opening and the distal lateral coil 295b of the first pickup. The distal lateral opening and distal lateral coil (under distal strings including a laterally outermost distal string) may be laterally distal to the first fretting appendage and the second fretting appendage; they may be farther laterally distal than the proximal lateral opening and proximal lateral coil. Strings may be grounded with a ground wire. FIGS. 36, 50, 55, 61, and 63 illustrate a similar pickup arrangement in additional or alternative embodiments.

In combination, FIGS. 28, 30, 31, 33, and 35 illustrate the following: A support may include a guide groove 145 for each of multiple fretting appendages 140. Each fretting appendage may be longitudinally positionable relative to a respective string 70 by sliding a height screw 205 inserted into a height adjustment hole 200 in that fretting appendage along its respective guide groove. Each guide groove may be centered under and aligned with its respective string. Because the strings may be slightly closer together at a nut 55 than at a saddle means, guide grooves may converge slightly in the direction of the nut. In additional or alternative embodiments, FIGS. 20-24 illustrates multiple supports with a similar guide groove arrangement.

As illustrated in FIG. 30, a first fretting appendage 140a includes a one string fretting crown 185 including a first fretting crown segment 370c positioned under a laterally proximal string. A second fretting appendage 140bmay include a one string fretting crown including a second fretting crown segment 370d positioned under a laterally distal string. The assembly 12 may include two fretting crown segments. The laterally proximal string may be consecutive to the laterally distal string. FIGS. 20 and 38 illustrate similar features in additional or alternative embodiments.

In combination, FIGS. 30, 33, and 35 illustrate the following: A first height screw 205a may insert into a first height adjustment hole 200ain a first fretting appendage 140a, and a second height screw 205b may insert into a second height adjustment hole 200bin a second fretting appendage 140b. The vertical position and longitudinal position of each fretting appendage may be independently adjusted and locked

As illustrated in FIG. 30, two consecutive strings of a plurality of strings include a laterally proximal string and a laterally distal string. A first fretting appendage 140aincluding a fretting end 180 including a fretting crown 185 may be positioned under the laterally proximal string. A second fretting appendage 140bincluding a fretting end including a fretting crown may be positioned under the laterally distal string. A saddle means may direct the laterally proximal string at a wrist fretable vertical distance above the fretting crown of the first fretting appendage. The saddle means may direct the laterally distal string at a wrist fretable vertical distance above the fretting crown of the second fretting appendage.

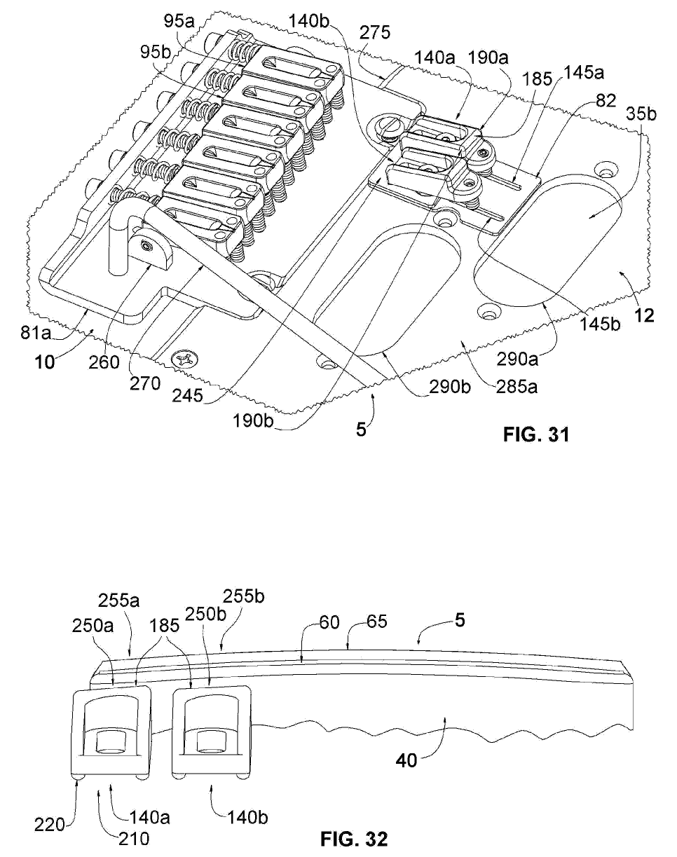

As illustrated in FIG. 31, an optional and removable shim 245 is positioned on a fretting appendage support 82, under supporting ends of two fretting appendages 140. The shim may adjust the vertical position of a fretting crown 185 of a fretting appendage. The shim may be of the same lateral width as the fretting appendage support. An upward facing guide surface of the shim may act as a guide surface of the fretting appendage support.

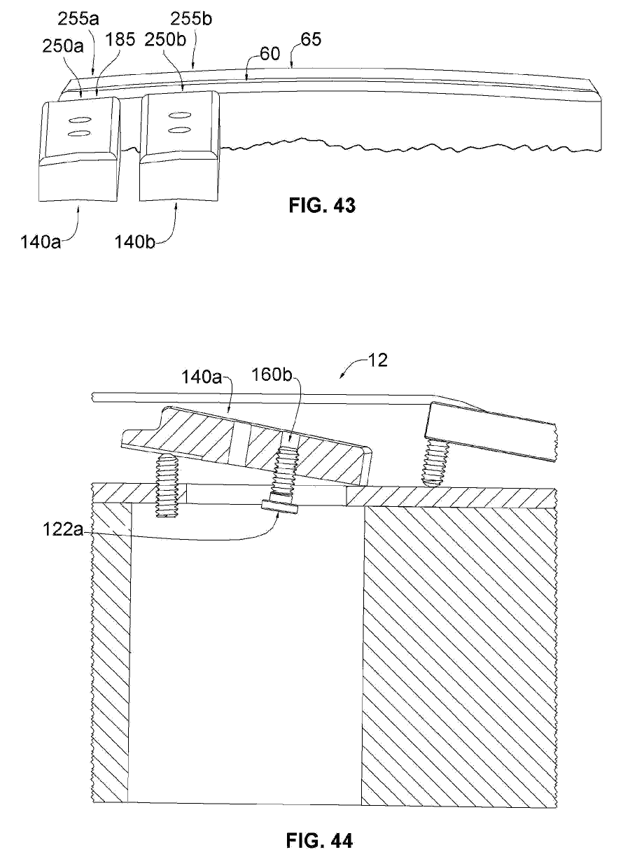

As illustrated in FIG. 32, a fingerboard 60 is curved. Fingerboard frets 65 on the fingerboard may be curved. A fretting crown 185 of a first fretting appendage 140a may include a first fingerboard matching angle 250a, which may match a first fingerboard angle 255aof the fingerboard. A fretting crown of a second fretting appendage 140bmay include a second fingerboard matching angle 250b, which may match a second fingerboard angle 255bof the fingerboard. FIG. 43 illustrates similar features in an additional or alternative embodiment.

In combination, FIGS. 33 and 35 illustrate the following: A fretting appendage 140 may include a longitudinal slot in the form of a through slot 230 centered between lateral sides 165 of the fretting appendage. A fastener may insert downward through the through slot into a fastening opening 160 in a support. A head of the fastener may seat in a recess 235 in an upper surface 171 of the fretting appendage. The fastening opening may be centered under a string 70. The fastener may fit snugly in the through slot. The through slot may be an elongated hole in the fretting appendage. The through slot may include a laterally proximal guide surface and a laterally distal guide surface, which may contact the fastener. The fastener and the through slot may be centered under the string by the fastening opening. The fastener may remain stationary while the fretting appendage is repositioned longitudinally. During longitudinal repositioning of the fretting appendage, the guide surfaces of the through slot may slide along the fastener. The fastener may remain in the through slot during repositioning. The recess may be laterally wider than the through slot. FIGS. 10-12, 14, 18-24, 26, 46, 56, and 58 illustrate similar features in additional or alternative embodiments.

As illustrated in FIG. 32, a pivot 210 includes two hemispherical lateral contact projections 220. The pivot may contact a support at two laterally spaced points along a line perpendicular to a respective string. In additional or alternative embodiments, another pivot shape, such as a linear edge, may be used.

A pivot 210 may rotate on an axis of rotation which is substantially perpendicular to a direction that a respective string extends. Two contact projections 220 or a linear edge of the pivot may contact a support at two or more points along this axis of rotation. The pivot may support the fretting appendage on the body at two or more points on this axis of rotation. In some embodiments, a pivot supports the block on the body within 80 mm or a longitudinally rearward critical contact point of a respective string on a saddle means.

In combination, FIGS. 33 and 35 illustrate the following: A recess 235 in a fretting appendage 140 may include a gap 280 at a supporting end 215 of the fretting appendage to provide space for a fastener head.

In combination, FIG. 34 and 35 illustrate the following: A proto string 70b may contact a nut 55 at a longitudinally forward end 42 of a neck 40 at a longitudinally forward critical contact point 100b. The proto string may extend above a sequence of fingerboard frets on a fingerboard 60, including a first fingerboard fret 65a. The proto string may extend at a wrist fretable vertical distance above a fretting crown 185 of a first fretting appendage 140a and contact a first saddle 95a at a longitudinally rearward critical contact point 100a. The longitudinal and vertical positions of the fretting appendage may be adjustable. To allow fingerboard frets with higher ordinal numbers to be played, the distance from the fretting crown to the proto string may be adjusted to be greater than the distance from the first fingerboard fret to the proto string; to intonate the wrist fretable note, the distance from the fretting crown to the longitudinally rearward critical contact point may be adjusted to be less than the distance from the first fingerboard fret to the longitudinally forward critical contact point.

FIG. 35 illustrates a fastener in a locking configuration; however, when the fastener is in a non locking configuration, a longitudinal position of a fretting appendage 140 and a vertical position of a fretting end 180 (including a fretting crown 185) of the fretting appendage may be adjusted. Wrist fretting may be performed with the fretting appendage locked firmly in place on a body 10 with the fastener. Locking the longitudinal position of the fretting appendage and the vertical position of the fretting end of the fretting appendage with the fastener may lock a longitudinal position and a vertical position of the fretting crown. With the fastener in the locking configuration, the immobilized fretting crown may be used to stop a string, shortening the sounding length of the string opposite the direction of use of a sequence of fingerboard frets. FIGS. 18, 19, and 44-47 illustrate similar features in additional or alternative embodiments.

In combination, FIGS. 36 and 37 illustrate the following: A body 10 may include a top 25 and a back 30. The body may include an electric body cavity 35b. An assembly 12 may attach to the body. The assembly may include a common support 83 of a saddle means and a fretting appendage 140. The common support may attach to the top of the body. A neck 40 may include a longitudinally forward end 42 located away from (remote from) the body and a longitudinally rearward end 43 coupled to the body. On a headstock 45 of the neck, tuning machines 50 may tension a plurality of laterally spaced strings including a proto string 70b, a deutero string 70c, a trito string 70d, tetarto string 70e, a pempto string 70f, and a hecto string 70g. Each string may contact a nut 55 on the neck at a longitudinally forward critical contact point 100b and contact the saddle means at a longitudinally rearward critical contact point 100a. Consecutive string may be spaced at the saddle means at a lateral string spacing 75. The body includes a laterally distal body side 20 and a laterally proximal body side 15. A sequence of fingerboard frets on a fingerboard 60 on the neck may include a first fingerboard fret 65a, a second fingerboard fret 65b, twelfth fingerboard fret 65f, thirteenth fingerboard fret 65c, and a twenty-first fingerboard fret 65e.

In combination, FIGS. 36, 38, 39, and 41 illustrate the following: A common support 83 may include a rear wall 310 with stringing openings 90, which may act as a string retainer. The stringing openings may direct strings 70 to a saddle means. The common support may orient the strings at the rear wall and at the saddle means, and may orient and position a fretting appendage 140 relative to the strings. A rear wall may include top loading stringing openings. A common support may include a pickup opening 285. A string may be directed by a saddle means coupled to the common support above a fretting appendage, a pickup opening, and a pickup 125 in the pickup opening. A common support may extend under a fretting appendage and under a respective string. A common support may include a planar upward facing guide surface contacted by a pivot 210 of the fretting appendage, to which the pivot may be locked by a fastener. A common support may include bent or welded sheet metal, or another material. A fretting appendage may be repositionably coupled on the upward facing guide surface of the common support on a body 10 at least partly laterally between two laterally outermost strings of a plurality of strings. FIGS. 50, 55, 58, 60, 61, 63, and 65 illustrate similar features in additional or alternative embodiments.

In combination, FIGS. 36, 38, and 39 illustrate the following: An instrument 5 may have an electric six string guitar form. A common support 83 (of a fretting appendage 140 and a saddle means) may be coupled to and positioned on a body 10 with support screws 300 through support screw holes 305. The common support may include the support screw holes. A rear wall 310 which may include six laterally spaced saddle intonation screw openings 320 and six laterally spaced stringing openings 90. The saddle means may include six saddles including a first saddle 95a, a second saddle 95b, and a fifth saddle 95e. Each saddle may be independently vertically positionable and longitudinally positionable. For each saddle, a saddle intonation screw 330 may insert through a saddle intonation screw opening into a saddle intonation hole 315 in the saddle. The saddle may be stabilized by a saddle spring 325. A head of the saddle intonation screw may seat behind the rear wall. The saddle may include two action holes 335 into which two action screws 340 may be inserted. A saddle means and a fretting appendage may be positioned on and coupled to the body by the common support. The common support may include saddle support function and fretting appendage support function; a common support of a fretting appendage and a saddle may act as a saddle support and as a fretting appendage support. FIGS. 50, 52, 53, 55, 56, 58, and 60-65 illustrate additional and alternative embodiments with similar features.

In additional or alternative embodiments, an assembly may include a separate string retainer for use with a common support, or a common support may include string through body stringing openings.

In combination, FIGS. 36-39, 41, and 42 illustrate the following: Two fretting appendages 140 and a saddle means may be coupled to a common support 83. Each fretting appendage may be arranged as follows: The fretting appendage may include a proximal lateral side 165a, a distal lateral side 165b, a longitudinally forward surface 170, an upper surface 171 with rounded lateral edges, and a downward surface 172. A fretting end 180 of the fretting appendage may include a fretting crown 185. The fretting crown may be a rounded edge where the upper surface and the longitudinally forward surface meet, and may include a proximal lateral end 190a and a distal lateral end 190b, which may be rounded, and a fretting crown segment 370. A height tab 195 may be at the fretting end. A height screw 205 may insert into a height adjustment hole 200 in the common support. An upper end of the height screw may be captured by a guide groove 145 in the downward surface of the fretting appendage. The guide groove may extend into the height tab. A pivot 210 in a lower location at a supporting end 215 of the fretting appendage may include two lateral contact projections 220. The pivot may contact an upward facing guide surface of the common support (or of a shim on the common support) at two points along a line perpendicular to the line of a string 70. A longitudinally forward fastening opening 160a, a longitudinally rearward fastening opening 160b, and the guide groove may be centered between the lateral sides of the fretting appendage. A longitudinally forward fastener 121 may insert through a through slot 230 in the common support into the longitudinally forward fastening opening. A longitudinally rearward fastener 122 may insert through the through slot into the longitudinally rearward fastening opening. Each fastener may include a head, which may seat under the common support. The fretting appendage may be centered under the string. In longitudinal order, from rearmost to foremost may be: a rear wall 310, a saddle 95 of the saddle means, the pivot, the longitudinally rearward fastening opening, the longitudinally forward fastening opening, the fretting crown, the height tab, a proximal lateral opening 290a of a first pickup opening 285a, a second pickup 125b, a fingerboard 60, and a nut 55.

In combination, FIGS. 36, 38, 39, 41, and 42 illustrate the following: A first height adjustment hole 200a, a first through slot 230a, a first height screw 205a, a first longitudinally forward fastener 121a, and a first longitudinally rearward fastener 122a may align a first fretting appendage 140awith a proto string 70b, centering a fretting crown 185 of the first fretting appendage under the proto string. The proto string may seat behind a rear wall 310, emerge from a first stringing opening 90a, and may be directed by a first saddle 95aabove the first fretting appendage, a proximal lateral coil 295a of a first pickup 125a, and a fingerboard 60, to a nut 55. A second height adjustment hole 200b, a second through slot 230b, a second height screw 205b, a second longitudinally forward fastener 121b, and a second longitudinally rearward fastener 122b may align a second fretting appendage 140bwith a deutero string 70c, centering a fretting crown of the second fretting appendage under the deutero string. The deutero string ball end may seat behind the rear wall, and the deutero string may emerge from a second stringing opening 90b, and may be directed by a second saddle 95b above the second fretting appendage, the proximal lateral coil, and the fingerboard, to the nut. Each fretting crown may be positionable such that it defines a wrist fretable note a semitone above an open note of its respective string.

In combination, FIGS. 36, 38, and 39 illustrate the following: A first pickup opening 285a in a common support 83 (of a fretting appendage 140 and a saddle means) may include a proximal lateral opening 290a and a distal lateral opening 290b. A first pickup 125amay include a proximal lateral coil 295ainserted into the proximal lateral opening, and may include a distal lateral coil 295binserted into the distal lateral opening. The distal lateral opening of the first pickup may be laterally distal to the two fretting appendages and farther longitudinally rearward than the proximal lateral opening. Pickup screw holes 345 (in the common support), pickup springs 350, and pickup screws 355 may couple the first pickup to the common support. A second pickup 125bmay insert into a second pickup opening 285bin a body 10. The pickups may be vertically adjustable. The common support may be grounded by a ground wire 135. FIGS. 50, 52, 53, 55, 56, and 61-64 illustrate additional and alternative embodiments with similar features.

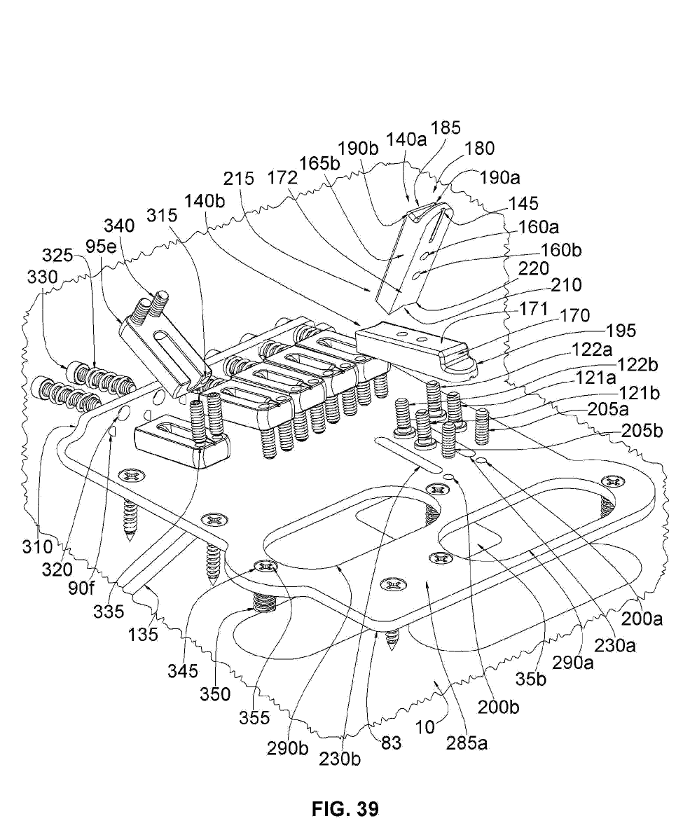

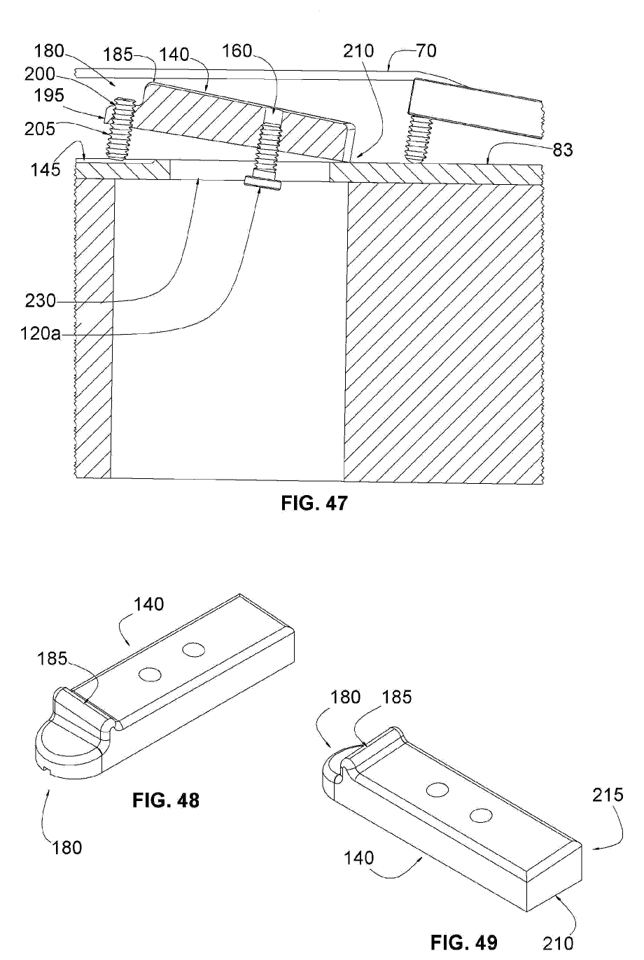

In combination, FIGS. 39, 41, and 42 illustrate the following: A support may include a longitudinal slot in the form of a through slot 230 aligned with the line of a string 70, and centered under the string. A fastener may insert upward through the through slot, and into a fastening opening 160 in a fretting appendage 140. The fastener may include a head, which may seat under the support. The fastening opening may begin in a downward surface 172 of the fretting appendage, and continue through an upper surface 171 of the fretting appendage. The fastener may fit snugly in the through slot. The through slot may include a laterally proximal guide surface and a laterally distal guide surface, which may contact the fastener. The through slot may be an elongated hole in the support. When a fretting end 180 (including a fretting crown 185) of the fretting appendage is in a low vertical position, the fastener may be vertical; as a height screw 205 raises the fretting end, the fastener may tilt with the fretting appendage. The fastener may move longitudinally with the fretting appendage as the fretting appendage's longitudinal position is adjusted. The fastener may slide in the through slot during longitudinal adjustment. In additional or alternative embodiments, a fastening opening may be a blind hole. In FIGS. 47 and 62 similar features are illustrated in additional or alternative embodiments.

In combination, FIGS. 36, 39, and 42 illustrate the following: A support may include a through slot 230 for each of multiple fretting appendages 140. Each fretting appendage may be longitudinally positionable relative to its respective string 70 by manipulating it along its respective through slot. Each through slot may be centered under and aligned with its respective string. Because the strings may be slightly closer together at a nut 55 than at a saddle means, through slots may converge slightly in the direction of the nut.

In combination, FIGS. 36, 38, 39, and 41 illustrate the following: A saddle means may include six saddles 95, which may contact strings 70. A saddle may be independently vertically positionable and longitudinally positionable relative to a support, a fretting appendage 140, a nut 55, and a body 10. Action screws 340 may insert into action holes 335 in a saddle, to adjust its vertical position. An action hole may be a screw hole. An action screw may act as a height screw for a saddle. A saddle intonation screw 330 may insert through a saddle intonation screw opening 320 in a rear wall into a saddle intonation hole 315 in a saddle. A head of a saddle intonation screw may seat behind a rear wall. A saddle intonation screw opening may limit movement of a saddle intonation screw at a rear wall. A saddle spring 325 may maintain a position of a saddle. A saddle intonation screw respective to a saddle may be used to adjust that saddle’s longitudinal position. A first saddle 95a may direct a proto string 70bat a wrist fretable vertical distance above a fretting end 180 of a first fretting appendage 140a. A second saddle 95b may direct a deutero string 70cat a wrist fretable vertical distance above a fretting end of a second fretting appendage 140b. A third, a fourth, a fifth, and a sixth saddle may direct a trito, a tetarto, a pempto, and a hecto string above a fingerboard 60 to a nut. FIGS. 28, 30-31, illustrate similar features in additional or alternative embodiments.

In combination, FIGS. 36-39, 41, and 42 illustrate the following: A common support 83 (of a fretting appendage 140 and a saddle means) may include a first height adjustment hole 200a, a first through slot 230a, a second height adjustment hole 200b, and a second through slot 230b. The first height adjustment hole and the first through slot may be aligned with and centered under a proto string 70b. The second height adjustment hole and the second through slot may be aligned with and centered under a deutero string 70c. Each height adjustment hole may be longitudinally forward of its respective through slot. An aperture 360 of an electric body cavity 35b at a back 30 may allow access to height screw drives and fastener heads.

As illustrated in FIG. 38, an assembly 12 may include a first fretting appendage 140a respective to a proto string 70b and a second fretting appendage 140b respective to a deutero string 70c. The first fretting appendage may include a one string fretting crown including lateral ends and a first fretting crown segment 370c. The second fretting appendage may include a one string fretting crown including lateral ends and a second fretting crown segment 370d. Each fretting crown segment may be positionable at a wrist fretable vertical distance under its respective string. Each fretting crown segment may be independently vertically and longitudinally positionable, and may be positionable to define an intonated wrist fretable note a semitone above the note of its respective string.

In FIG. 39, a support has a sixth stringing opening 90f. The sixth string opening may enable a hecto string to insert through a rear wall 310. A ground wire 135 may ground the support and the strings.

In combination, FIGS. 39 and 41 illustrate the following: A fretting appendage 140 may include a longitudinal slot in the form of a guide groove 145 in a downward surface 172 of the fretting appendage. The guide groove may be centered between lateral sides 165 of the fretting appendage and positioned to capture an upper end of a height screw 205, restricting lateral movement. The height screw may partly insert into the guide groove. A guide groove of a fretting appendage may slide along a height screw during adjustment of a longitudinal position of the fretting appendage (including a fretting crown 185), or during adjustment of a vertical position of a fretting end 180 (including the fretting crown) of the fretting appendage. The height screw may support the fretting appendage (in a range of vertical positions including a raised position) during longitudinal position adjustment. A fastener may lock the height screw against the fretting appendage. Each of multiple fretting appendages may have a similar guide groove. FIGS. 44, 45, 46 illustrate similar features in additional or alternative embodiments.

In combination, FIGS. 39, 41, and 42 illustrate the following: A support may include a height adjustment hole 200 under a fretting appendage 140. A height screw 205 may insert into the height adjustment hole, extend vertically between the support and the fretting appendage, and contact a guide groove 145 in a downward surface 172 of the fretting appendage. The guide groove of the fretting appendage may slide longitudinally along the height screw during longitudinal position adjustment of the fretting appendage and during vertical adjustment of the fretting crown. FIGS. 44, 45, 46 illustrate similar features in an additional or alternative embodiment.

In additional or alternative embodiments, a guide groove for a height screw may be omitted from a fretting appendage or from a support. In further additional or alternative embodiments, a height screw inserted in a height adjustment hole in a support contacts a smooth downward surface of a fretting appendage.

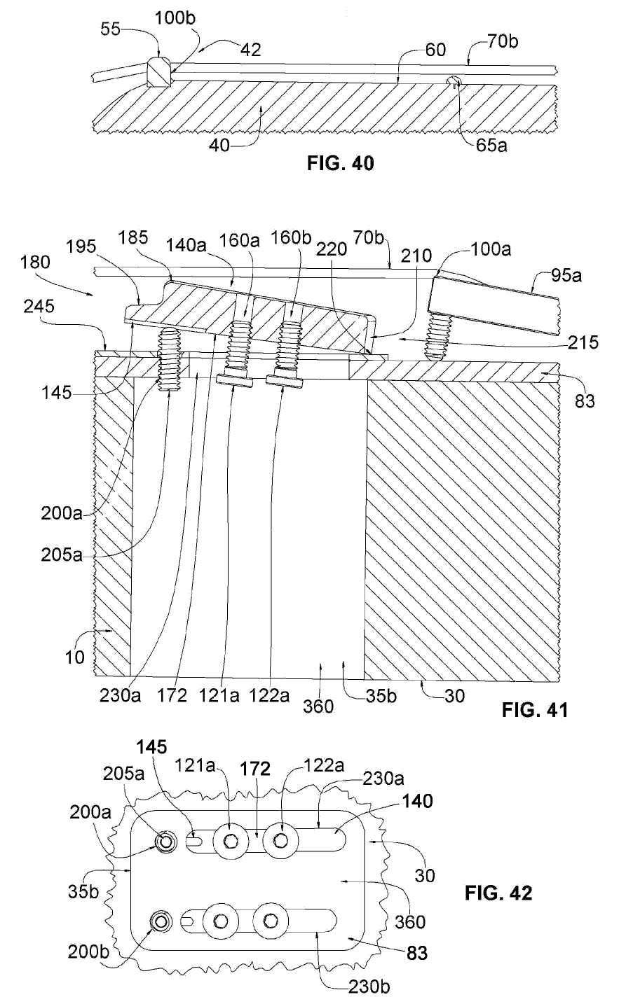

In combination, FIGS. 40 and 41 illustrate the following: A proto string 70b may contact a nut 55 at a longitudinally forward critical contact point 100b at a longitudinally forward end 42 of a neck 40. The proto string may extend above a first fingerboard fret 65aon a fingerboard 60 on the neck. The proto string may extend at a wrist fretable vertical distance above a fretting crown 185 of a fretting end 180 of a first fretting appendage 140a. The proto string may contact a first saddle 95aat a longitudinally rearward critical contact point 100a. A vertical position of the first fretting appendage may be adjusted such that the proto string is farther from the fretting crown than from the first fingerboard fret, to allow the fingerboard frets to be playable. The first saddle may be adjusted to intonate the fingerboard fretted notes of the proto string. A longitudinal position of the first fretting appendage may be adjusted such that the wrist fretable note of the fretting crown is intonated. The first fingerboard fret may be farther from the forward critical contact point of the proto string than the fretting crown is from the rearward critical contact point of the proto string. A second saddle and a second fretting appendage associated with a deutero string may be independently adjusted to achieve a similar setup for the deutero string.

As illustrated in FIG. 41, an optional and removable shim 245 may be positioned on a common support 83 (of a fretting appendage 140 and a saddle means), under a pivot 210 of the fretting appendage; the shim may be of the same lateral width as the fretting appendage. A guide surface of the shim may act as a guide surface of the common support. The shim may include openings for a height screw or a fastener.

As illustrated in FIG. 43, a fingerboard 60 may be curved. Fingerboard frets 65 on the fingerboard may be curved. A fretting crown 185 of a first fretting appendage 140a may include a first fingerboard matching angle 250a, which may match a first fingerboard angle 255aof the fingerboard. A fretting crown of a second fretting appendage 140bmay include a second fingerboard matching angle 250b, which may match a second fingerboard angle 255bof the fingerboard.

As illustrated in FIG. 44, a first longitudinally rearward fastener 122a is inserted into a longitudinally rearward fastening opening 160b. An assembly 12 may function without a longitudinally forward fastener for the first fretting appendage 140a. The first longitudinally rearward fastener is independently capable of locking the position of the first fretting appendage, without the use of another fastener. FIG. 19 illustrates similar features in an additional or alternative embodiment.

As illustrated in FIG. 45, a first longitudinally forward fastener 121a is inserted into a longitudinally forward fastening opening 160a. An assembly 12 may function without a longitudinally rearward fastener for the first fretting appendage 140a. The first longitudinally forward fastener is independently capable of locking the position of the first fretting appendage, without the use of another fastener. FIG. 18. illustrates similar features in an additional or alternative embodiment.

In FIG. 46, a common support 83 (of a fretting appendage 140 and a saddle means) includes a height adjustment hole 200 longitudinally forward of a fastening opening 160. The fretting appendage may include a fretting end 180 including a height tab 195 longitudinally forward of a fretting crown 185 of the fretting end, and may include a guide groove 145 in a downward surface. The guide groove may extend into the height tab. The fretting appendage may include a through slot 230 and a recess 235 centered between lateral sides of the fretting appendage and behind the fretting crown, with the recess in an upper location. A height screw 205 may be inserted into the height adjustment hole and captured by the guide groove. A pivot 210 may enable adjustment of a vertical position of the fretting end using the height screw. A first fastener 120amay insert through the through slot into the fastening opening. A head of the fastener may seat in the recess. The height adjustment hole and the fastening opening may be aligned with and centered under a string 70. The string may contact a saddle 95. The height screw may be adjusted through an aperture 360. The common support, the height screw, and the first fastener may align the fretting appendage with the string and center the fretting crown under the string.

As illustrated in FIG. 47, a common support 83 (of a fretting appendage 140 and a saddle means) includes a guide groove 145 and a through slot 230 longitudinally rearward of the guide groove. The fretting appendage may include a fretting end 180 including a fretting crown 185 and a height tab 195. The height tab may be longitudinally forward of the fretting crown. The fretting appendage may include a height adjustment hole 200 in the height tab and a fastening opening 160 longitudinally rearward of the fretting crown. The fastening opening may be centered between lateral sides of the fretting appendage. The height adjustment hole may be located along a centerline of the fretting appendage. A height screw 205 may insert into the height adjustment hole and be captured by the guide groove. A pivot 210 may enable adjustment of a vertical position of the fretting end using the height screw. A first fastener 120amay insert through the through slot into the fastening opening. A head of the first fastener may seat under the common support. The guide groove and the through slot may be aligned with and centered under a string 70. The common support, the height screw, and the fastener may align the fretting appendage with the string and center the fretting crown under the string.

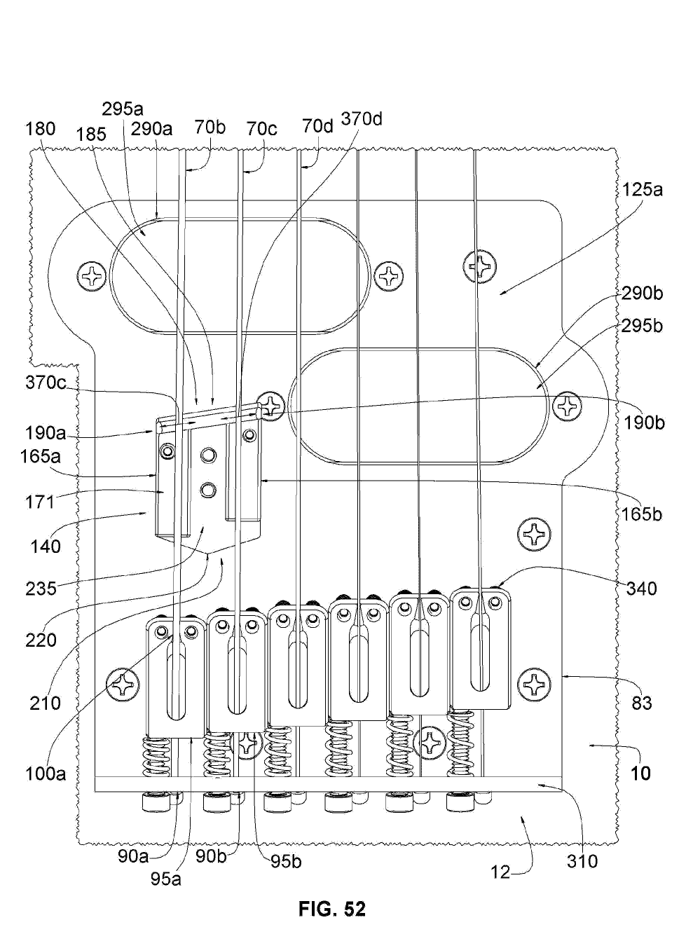

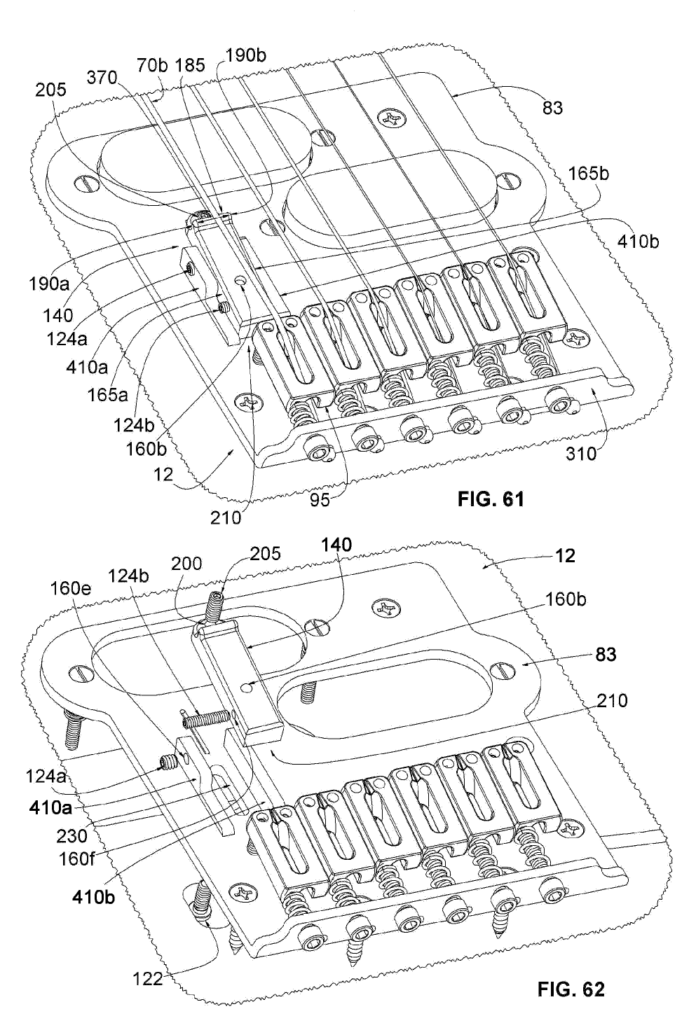

In combination, FIGS. 48 and 49 illustrate the following: A fretting appendage 140 may include a fretting end 180 including a fretting crown 185 in the form of a raised ridge, which may be integrated into the fretting appendage or an attached piece of fretwire. The fretting crown may include a fingerboard matching angle. A pivot 210 at a supporting end 215 of the fretting appendage in the form of a linear edge may be formed to contact a support on a body at two or more laterally spaced points along a line perpendicular to a string. The fretting appendage may be used on an instrument, such as an instrument as shown and described in FIGS. 36-45. FIGS. 52-57 illustrate similar fretting crowns in additional or alternative embodiments. FIGS. 61-64 illustrate similar pivots in additional or alternative embodiments.

In combination, FIGS. 50-57 illustrate the following: A common support 83 (of a fretting appendage 140 and a saddle means) may be coupled to a body 10. The fretting appendage may include a proximal lateral side 165a, a distal lateral side 165b, and an upper surface 171. A fretting end 180 of the fretting appendage may include a laterally proximal first fretting crown segment 370c and a laterally distal second fretting crown segment 370d. The fretting appendage may be coupled to the common support such that the first fretting crown segment may be under a proto string 70b, and the second fretting crown segment may be under a deutero string 70c. Each fretting crown segment may be longitudinally between a fingerboard 60 and a saddle 95 (of the saddle means), which contacts a string respective to that fretting crown segment. The fretting crown segments may be under their respective strings. A recess 235 in the upper surface may be centered between the lateral sides of the fretting appendage. A pivot 210 may include a central contact projection 220, which may contact an upward facing guide surface of the common support. The pivot may be in a longitudinally rearward and lower location at a supporting end 215 of the fretting appendage. The fretting end may pivot up and down, and the fretting appendage may rotate on the pivot during a vertical position adjustment using height screws. Two height screws 205 and the pivot may tripodally support (in a range of vertical positions) the fretting appendage on the common support, including during a sliding longitudinal positional adjustment. Ends, corners, and edges of the fretting appendage, which may contact the hand, may be beveled or rounded.

In additional or alternative embodiments, a fretting appendage with three or more fretting crown segments may be used with an instrument similar to an instrument as shown and described in FIGS. 50 and 51. The lateral position of the fretting appendage and various features may be chosen to position the fretting crown segments under respective strings.

In combination, FIGS. 50, 52, 53, 55, and 56 illustrate the following: An assembly 12 may include a common support 83 of a saddle means and a fretting appendage 140. The common support may include a rear wall 310 with a saddle intonation screw opening 320 next to a sixth stringing opening 90f. A saddle intonation screw 330 may insert through the saddle intonation screw opening into a saddle intonation hole 315 in a sixth saddle 95f. A saddle spring 325 on the saddle intonation screw may assist in holding the sixth saddle in place. Two action holes 335 in the sixth saddle may allow insertion of two action screws 340 to adjust the vertical position of the sixth saddle. A longitudinal position and a vertical position of each saddle of the assembly may be adjusted such that a longitudinally rearward critical contact point 100a of its respective string 70 is at a distance i) less than, ii) equal to, or iii) greater than a neck scale length from a longitudinally forward critical contact point 100b of that string. A first pickup 125a, including a proximal lateral coil 295a and a distal lateral coil 295b, may be inserted into a proximal lateral opening 290aand a distal lateral opening 290b of a first pickup opening 285a in the common support. The pickup coils may be vertically adjusted with pickup screws 355 inserted into the first pickup and into pickup screw holes 345 in the common support. The first pickup may be held in place with pickup springs 350. A second pickup 125bmay be inserted in a second pickup opening 285bin a body 10; the first pickup may be nearer to fretting appendages, and the second pickup may be nearer to a neck 40.

In combination, FIGS. 50 and 51 illustrate the following: An instrument 5 may include a body 10 including a laterally proximal body side 15, a laterally distal body side 20, and a back 30. A longitudinally rearward end 43 of a neck 40 may couple to the body and a longitudinally forward end 42 of the neck may be away (remote) from the body. Tuning machines 50 on a headstock 45 at the longitudinally forward end of the neck may tension a plurality of strings including a proto string 70b, a deutero string 70c, a trito string 70d, a tetarto string 70e, a pempto string 70f, and a hecto string 70g. Consecutive strings at a saddle means on the body may be spaced, center to center, at a lateral string spacing 75. (For clarity, lateral string spacing in FIG. 50 is shown slightly longitudinally forward of its exact location). A common support 83 of a saddle means and a fretting appendage 140 coupled to and positioned on a top 25 of the body may couple and position those components on the body. The common support may include support screw holes 305 through which support screws 300 couple it to the body. A fingerboard on the neck may include a first fingerboard fret 65a, a second fingerboard fret 65b, a twelfth fingerboard fret 65f, a thirteenth fingerboard fret 65c, and a twenty-first fingerboard fret 65e. An electric body cavity 35b may be accessed to adjust the assembly through an aperture 360 at the back.

In combination, FIGS. 50, 52, 53, 55, 56 illustrate the following: A fretting appendage 140 may be positionable independently of one or more saddles 95 of a saddle means. A longitudinally forward fastener 121 may lock a vertical position, a longitudinal position, and a lateral position of the fretting appendage. A longitudinally rearward fastener 122 may lock the vertical position, the longitudinal position, and the lateral position of the fretting appendage. Either fastener may be used by itself to lock the position of the fretting appendage with or without the other. When both fasteners are used, they may align the fretting appendage along a line laterally centered between two strings, and may center each of two fretting crown segments 370 under its respective string. A ball end of a proto string 70b may seat behind the rear wall 310, may emerge from a first stringing opening 90a, and may be directed by a first saddle 95aabove a laterally proximal first fretting crown segment 370c and a fingerboard 60, to a nut 55. A deutero string 70cmay seat behind the rear wall, may emerge from a second stringing opening 90b, and may be directed by a second saddle 95b above a laterally distal second fretting crown segment 370d and the fingerboard, to the nut. The fretting appendage may be slidably longitudinally positionable along a line laterally centered between the two strings, using a through slot 230, a longitudinally forward fastening opening 160a, a longitudinally rearward fastening opening 160b, and their respective fasteners.

The fretting appendage may alternatively be used with a single fastener; when used with a single fastener, the fretting appendage may be rotated around a vertical axis to adjust the position (for intonation) of its fretting crown segments.

In combination, FIGS. 50-54 illustrate the following: A common support 83 (of a fretting appendage 140 and a saddle means) may include a through slot 230 laterally centered between a laterally proximal string, which may be a proto string 70b, and a laterally distal string, which may be a deutero string 70c. A longitudinally forward fastener 121 may insert through the through slot into a longitudinally forward fastening opening 160a in the fretting appendage. A longitudinally rearward fastener 122 may insert through the through slot into a longitudinally rearward fastening opening 160b in the fretting appendage. Heads of the fasteners may seat under the common support, and may be adjusted through an aperture 360 of an electric body cavity 35b. The two fastening openings may be centered between the lateral sides 165 of the fretting appendage. The through slot may center the fasteners and the fretting appendage laterally between the two strings, centering a laterally proximal first fretting crown segment 370c under the proto string and a laterally distal second fretting crown segment 370d under the deutero string. The fretting appendage may include a two string fretting crown 185, which may be arched, which may include fingerboard matching angles 250, and which may include longitudinally compensated fretting crown segment positioning. A distal lateral side 165bof the fretting appendage and a distal lateral end 190b of the fretting crown may be laterally between the deutero string and a trito string 70d. The fretting appendage may be longitudinally repositioned by sliding it along the through slot, and the fasteners may slide in the through slot against lateral guide surfaces of the through slot. The height screws and the fasteners may tilt at an angle with the fretting appendage as the height of a fretting crown segment is adjusted by turning a height screw.

In combination, FIGS. 54 and 57 illustrate the following: A fretting crown 185 of fretting appendage 140 may include a fingerboard matching angle 250. A first fingerboard matching angle 250aof a laterally proximal first fretting crown segment 370c and a laterally distal second fingerboard matching angle 250b of a second fretting crown segment 370d may be shaped on the fretting appendage by arching the fretting crown segments relative to one another, or angling them, or both.

On an instrument shown in FIGS. 50-57, to align a fingerboard matching angle 250 with a fingerboard 60, the following steps may be followed: A saddle means may be used to set a vertical distance of a laterally distal string above the fingerboard and a vertical distance of a laterally proximal string above the fingerboard to be equal. Then, a laterally distal height screw 205hand a laterally proximal height screw 205g may be used to adjust a vertical distance between the second fretting crown segment and the laterally distal string and a vertical distance between the first fretting crown segment and the laterally proximal string to be equal.

Each of multiple fretting crown segments 370 may include a fingerboard matching angle 250 matching a fingerboard angle associated with its respective string. A fretting crown segment respective to a laterally outermost string may include a larger fingerboard matching angle than a fretting crown segment respective to a string nearer to the centerline of a neck 40.

A fretting crown 185 may be angled around a vertical axis at an angle at which “fanned frets” may function.

In combination, FIGS. 52 and 54 illustrate the following: An assembly 12 may include a common support 83 of a saddle means and a fretting appendage 140. The fretting appendage may include a fretting crown 185 in the form of a two string fretting crown (a fretting crown of a width for use with two consecutive strings). The two string fretting crown may extend laterally under two consecutive strings 70, and may include a first fretting crown segment 370c and a second fretting crown segment 370d. The fretting crown may have a proximal lateral end 190a and a distal lateral end 190b. The proximal lateral end may be vertically lower than a proto string 70b and laterally within about one lateral string spacing of the proto string. The distal lateral end may be laterally between a deutero string 70c and a trito string 70d.

In some embodiments, a lateral end of a fretting crown is nearer or farther than a lateral string spacing from a respective string

In combination, FIGS. 52, 53, 55, and 56 illustrate the following: A fretting appendage 140 may include a height adjustment hole 200; a height screw 205 may insert into the height adjustment hole and adjust a vertical position of the fretting end 180 of the fretting appendage by engaging a common support 83. A height screw may insert vertically into a height adjustment hole and tilt during adjustment.

In combination, FIGS. 52, 53, 55, and 56 illustrate the following: A laterally proximal height screw 205g in a laterally proximal height adjustment hole 200c and a laterally distal height screw 205h in a laterally distal height adjustment hole 200d may allow vertical positions of two fretting crown segments 370 to be adjusted relative to two respective strings 70. The laterally distal height adjustment hole may be laterally distal to a deutero string, and the laterally proximal height adjustment hole may be laterally proximal to a proto string. The height adjustment holes may be farther longitudinally rearward than the fretting crown segments and farther longitudinally forward than a pivot 210.

In an alternative or additional embodiments, an instrument similar to an instrument as shown and described in FIGS. 50-57 may include a laterally proximal height adjustment hole and a laterally distal height adjustment hole in a support. A laterally distal height screw and a laterally proximal height screw may insert and contact a fretting appendage from beneath, adjusting the vertical position of a fretting end.

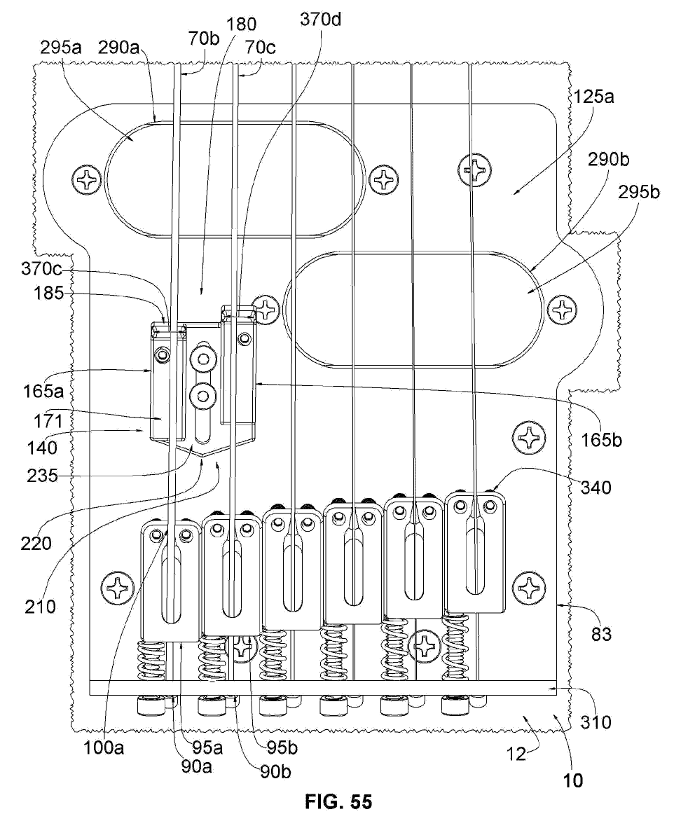

In combination, FIGS. 52 and 55 illustrate the following: Two fretting crown segments 370, relative to one another, may have compensated longitudinal positions on a fretting appendage 140, matching an expected longitudinal offset of a longitudinally rearward critical contact point 100a of a laterally proximal string from a longitudinally rearward critical contact point of a laterally distal string. (Alternatively, such as when no offset is expected, the fretting crown segments may be longitudinally about even, or the offset may be reversed.) The fretting appendage may be longitudinally positionable such that each fretting crown segment defines a wrist fretable note a semitone above an open note of its respective string. The fretting crown segments may be farther longitudinally forward than a pivot 210. The fretting appendage may be positioned such that each fretting crown segment is at a distance i) farther than, ii) equal to, or iii) nearer than, a nominal oddment length from the rearward critical contact point of its respective string. Longitudinally compensated positions may enable each fretting crown segment to be located at an intonated distance from a nut. As illustrated, a laterally proximal first fretting crown segment 370c may be farther longitudinally rearward than the laterally distal second fretting crown segment 370d.

In combination, FIGS. 55-57 illustrate the following: A longitudinally forward fastening opening 160a and a longitudinally rearward fastening opening 160b in a common support 83 (of a fretting appendage 140 and a saddle means) may be laterally centered between a laterally proximal string, which may be a proto string 70b, and a laterally distal string, which may be a deutero string 70c. The fretting appendage may include a laterally proximal fretting crown 185 including a laterally proximal first fretting crown segment 370c, and a laterally distal fretting crown including a laterally distal second fretting crown segment 370d. A through slot 230 may be centered between lateral sides 165 of the fretting appendage. A longitudinally forward fastener 121 may insert through the through slot into the longitudinally forward fastening opening. A longitudinally rearward fastener 122 may insert through the through slot into the longitudinally rearward fastening opening. Heads of the fasteners may seat in a recess 235 above the through slot. The two fastening openings may center the fasteners and the fretting appendage laterally between the two strings, centering each fretting crown under its respective string. The two fretting crowns may be separated by a small lateral space. A proximal lateral end 190aof the laterally proximal fretting crown may be at a lower vertical level than and laterally within about a lateral string spacing of a proto string. A distal lateral end 190bof the laterally proximal fretting crown may be laterally between the proto string and the deutero string. The proximal lateral end of the laterally distal fretting crown may be laterally between the proto string and the deutero string. A distal lateral side 165bof the fretting appendage and the distal lateral end of the laterally distal fretting crown may be laterally between the deutero string and a trito string. The fretting appendage may be longitudinally repositioned by sliding the through slot along the fasteners.

In combination, FIGS. 55 and 57 illustrate the following: A fretting appendage 140 may include a first fretting crown segment 370con a laterally proximal one string fretting crown 185 under a laterally proximal string and a second fretting crown segment 370d on a laterally distal one string fretting crown under a laterally distal string. The laterally proximal string may be consecutive to the laterally distal string.

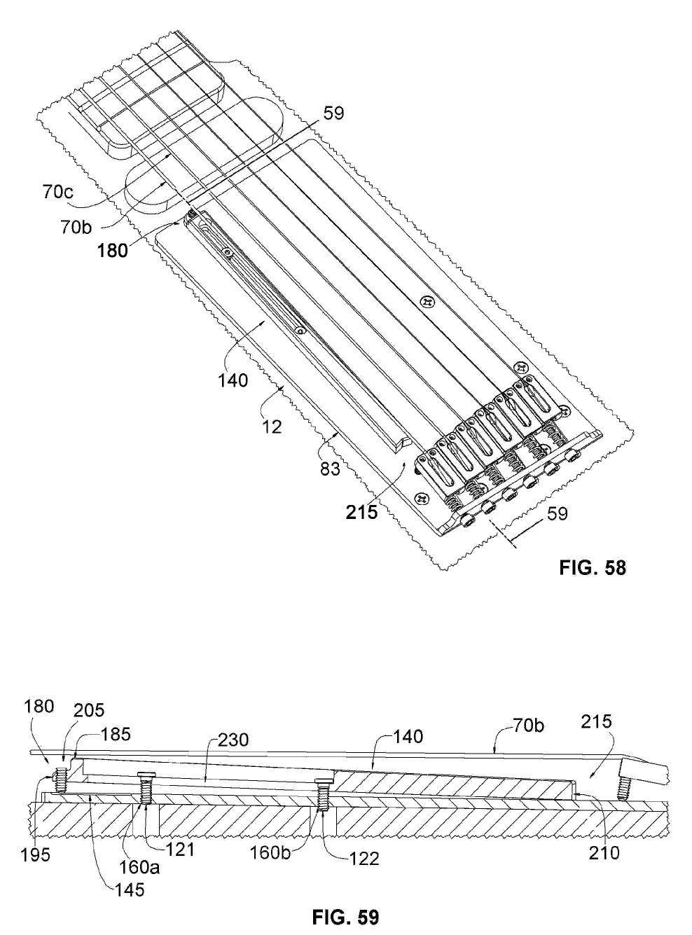

In combination, FIGS. 58 and 59 illustrate the following: A deutero string 70c may be consecutive to a proto string 70b, which may be a laterally outermost proximal string. An assembly 12 may include a common support 83 of a fretting appendage and a saddle means. The fretting appendage 140 may be coupled to the support. The fretting appendage may include a fretting end 180 including a height tab 195 and a fretting crown 185. The fretting crown may be under the proto string. The fretting crown may include a fingerboard matching angle. A height screw 205 may insert into a height adjustment hole in the height tab and contact a guide groove 145 of the support. A longitudinally forward fastener 121 may insert through a through slot 230 in the fretting appendage into a longitudinally forward fastening opening 160a in the support. A longitudinally rearward fastener 122 may insert through the through slot in the fretting appendage into a longitudinally rearward fastening opening 160b in the support. A pivot 210 at a supporting end 215 of the fretting appendage may contact the support. The pivot may be longitudinally rearward of the height adjustment hole, the fretting crown, and the through slot. The fretting appendage (including the fretting crown) may be longitudinally positionable, and the fretting end (including the fretting crown) may be vertically positionable. The fretting crown may be positionable such that it defines a wrist fretable note a major third above an open note of the proto string. A distal lateral side of the fretting appendage and a distal lateral end of the fretting crown may be laterally between the proto string and the deutero string.

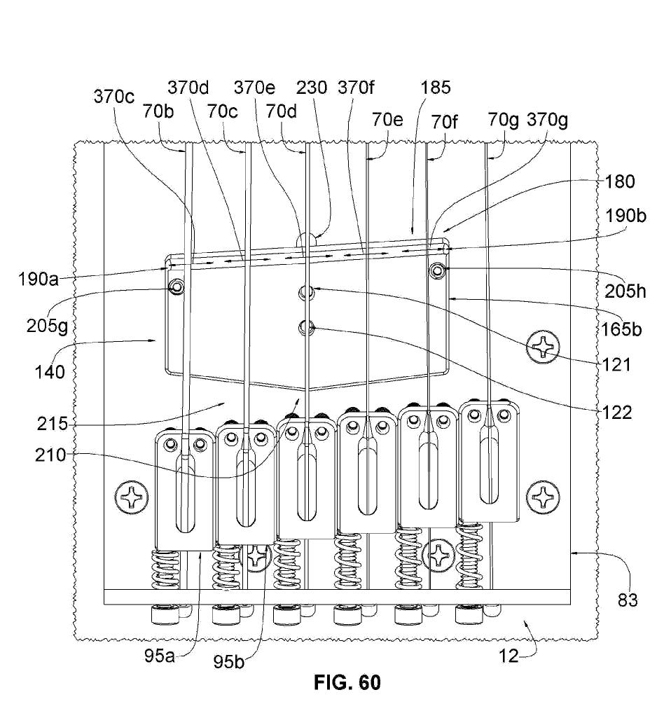

As illustrated in FIG. 60, an assembly 12 may include a fretting appendage 140 and a saddle means may be coupled to a common support 83. The fretting appendage may include a fretting end 180, including a five string fretting crown 185. The five string fretting crown may include a first fretting crown segment 370c under a proto string 70b, a second fretting crown segment 370d under a deutero string 70c, a third fretting crown segment 370e under a trito string 70d, a fourth fretting crown segment 370f under a tetarto string 70e, and a fifth fretting crown segment 370g under a pempto string 70f. A laterally proximal height screw 205gand a laterally distal height screw 205h may insert into a laterally proximal height adjustment hole and a laterally distal height adjustment hole in the fretting appendage and may contact the support. The proto string may contact a first saddle 95a. The deutero string may contact a second saddle 95b. A longitudinally forward fastener 121 and a longitudinally rearward fastener 122 may insert through a through slot 230 in the support into two fastening openings in the fretting appendage. A pivot 210 at a supporting end 215 of the fretting appendage may contact the support. The fretting appendage (including the fretting crown segments) may be longitudinally positionable, and the fretting end (including the fretting crown segments) may be vertically positionable. The five string fretting crown may be positionable such that each fretting crown segment defines a wrist fretable note a semitone above an open note of its respective string. A distal lateral side 165b of the fretting appendage and a distal lateral end 190b of the five string fretting crown may be laterally between the pempto string and a hecto string 70g. A laterally proximal end 190aof the five string fretting crown is laterally proximal to the proto string. Each fretting crown segment may include a fingerboard matching angle, and may include intonation compensating longitudinal positioning on the fretting appendage. The laterally proximal height screw and the laterally distal height screw may allow vertical repositioning of the fretting end.

As illustrated in FIG. 60, a five string fretting crown 185 may include a first fretting crown segment 370c under a proto string 70b, a second fretting crown segment 370d under a deutero string 70c, a third fretting crown segment 370e under a trito string 70d, a fourth fretting crown segment 370f under a tetarto string 70e, and a fifth fretting crown segment 370g under a pempto string 70f. The five string fretting crown may extend laterally under five consecutive strings, and may be of a width for use with five strings.

As illustrated in FIGS. 61 and 62, a support may include a laterally proximal barrier 410aand a laterally distal barrier 410b, which may form a longitudinal slot in the form of a channel. The channel may be aligned with and centered under a proto string 70b. The channel may include a laterally proximal guide surface and a laterally distal guide surface, which may be surfaces of the barriers, and which may contact a proximal lateral side 165aand a distal lateral side 165b of a fretting appendage 140. A front lateral fastener 124a, in the form of a set screw, may insert laterally into a front lateral fastening opening 160e in the laterally proximal barrier and contact the proximal lateral side of the fretting appendage, locking the distal lateral side of the fretting appendage against the laterally distal guide surface. A rear lateral fastener 124b, in the form of a set screw, may insert laterally into a rear lateral fastening opening 160f in the fretting appendage and contact the laterally proximal guide surface, locking the proximal lateral side of the fretting appendage against the laterally distal guide surface. With the fasteners in a non locking configuration, a longitudinal position of the fretting appendage may be adjusted by sliding it in the channel, and the vertical position of the fretting end, including the fretting crown, may be adjusted with the fretting appendage in the channel. A pivot 210 of a supporting end of the fretting appendage may insert into the channel. The fretting appendage may include a substantially vertical longitudinally rearward fastening opening 160b for a longitudinally rearward fastener 122 inserting upward through a through slot 230 in the support. The assembly may include other features similar to those of an instrument as shown and described in FIG. 47.

In combination, FIGS. 61 and 62 illustrate the following: An assembly 12 may include a common support 83 of a fretting appendage 140 and a saddle means. The fretting appendage may include a height adjustment hole 200 into which a height screw 205 is inserted. A fretting crown 185, including a proximal lateral end 190a and a distal lateral end 190b, may be longitudinally rearward of the height screw. The fretting crown may be a one string fretting crown with one fretting crown segment 370 under a proto string 70b. The common support may include a rear wall 310. The saddle means may include a saddle 95 for each string.

As illustrated in FIG. 62, a pivot 210 (in the form of a linear edge) positioned above a through slot 230 may support a fretting appendage at a first point, laterally proximal to the through slot, and at a second point, laterally distal to the through slot. The lateral ends of the linear edge may act as lateral contact projections when the pivot is above the through slot.

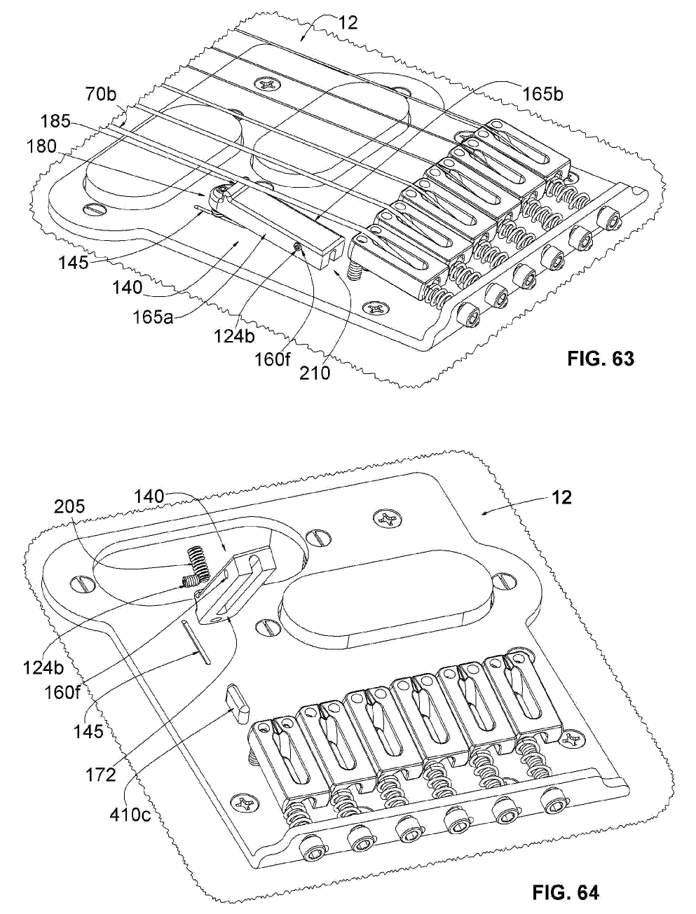

In combination, FIGS. 63 and 64 illustrate the following: An assembly 12 may include a support, which may include a central barrier 410c centered under and aligned with a laterally outermost proximal string 70b. The central barrier may include two planar lateral sides and may extend along the line of the string. A fretting appendage 140 may include a deep longitudinal slot in a downward surface 172, centered between a proximal lateral side 165a and a distal lateral side 165b of the fretting appendage, which may form a channel into which the barrier is inserted. The fretting appendage may be positioned on (over) the barrier. A laterally proximal guide surface of the channel and a laterally distal guide surface of the channel, which may be interior surfaces of the channel, may contact the lateral sides of the barrier. A rear lateral fastener 124b, in the form of a set screw, may insert laterally into a rear fastening opening 160f in the fretting appendage and contact the barrier, locking the laterally distal guide surface of the channel against the barrier. With the fastener(s) in a non locking configuration, the longitudinal position of the fretting appendage may be adjusted by sliding it along the barrier. With the fasteners in a non locking configuration, a vertical position of the fretting appendage (including the fretting crown 185 of a fretting end 180) may be adjusted using a pivot 210 included by the fretting appendage, and using a height screw 205, which is captured by a guide groove 145 of the support. The channel may slide along the barrier during vertical repositioning of the fretting appendage. In a non locking configuration, the rear lateral fastener may allow vertical and longitudinal adjustment of the fretting appendage, including the fretting crown. In a locking configuration, the rear lateral fastener may lock the vertical, lateral, and longitudinal position of the fretting appendage.

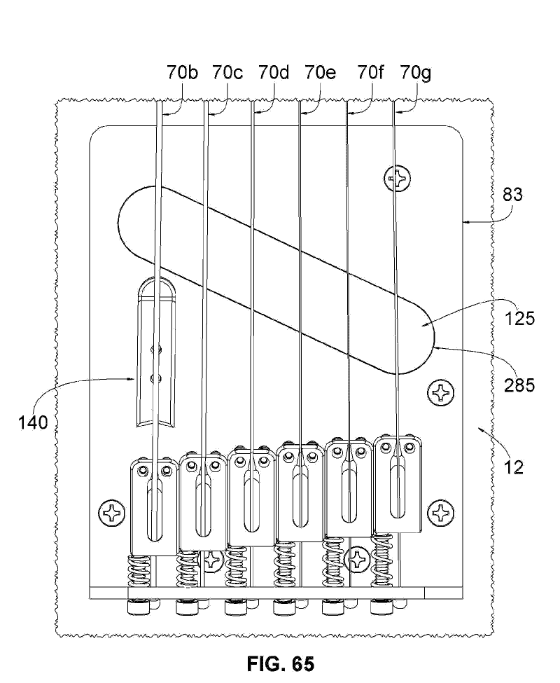

As illustrated in FIG. 65, an assembly 12 may include a common support 83 of a fretting appendage 140 and a saddle means. A pickup 125 may be inserted into a pickup opening 285 in the common support. A proto string 70b, a deutero string, 70c, a trito string, 70d, a tetarto string 70e, a pempto string 70f, and a hecto string 70g, may contact a saddle means on the common support. The pickup and pickup opening may be in a “slanted” orientation. A laterally proximal end of the pickup and the pickup opening may be longitudinally farther forward than a laterally distal end of the pickup and the pickup opening. The fretting appendage may be between the pickup and the saddle means, under the proto string. The portion of the pickup under the proto string may be farther longitudinally forward than the portion of the pickup under the hecto string. The laterally distal end of the pickup may be laterally distal to the fretting appendage, while the laterally proximal end of the pickup is longitudinally forward of the fretting appendage. This position of the pickup may allow the pickup to be near to the saddle means while also allowing the fretting appendage to be positioned to define a wrist fretable note a semitone above the open note of the proto string. Any assembly may include a pickup in this orientation; a pickup opening may alternatively be in a body or a pickguard. The assembly illustrated in FIG. 65, though having a single fretting appendage and a different pickup configuration, may include features that are similar to those in additional or alternative embodiments as illustrated in FIGS. 36-45.

A fretting appendage 140 may be a shaped block of a material. In some embodiments, the features of the fretting appendage are shaped into the block. Thus, the block may include a fretting end, a fretting crown, a supporting end, a height tab, a height adjustment hole, a through slot, a guide groove, a recess, a gap, a pivot, a lateral contact projection, a lateral fastening opening, a channel, and/or other features. Features of the fretting appendage may be integral to the block, and/or the block may include multiple components (such as a piece of fretwire), which may be attached. A block may be shaped in varied ways, including blocky shapes, rectilinear shapes, non rectilinear shapes, flattened shapes, and shapes with curved or decorative surfaces. A block may be solid, hollow, skeletonized, or include a flat or a bent surface, such as may be made from a sheet of a material, such as sheet metal.

A fretting appendage or a fretting crown may include a rigid and hard material such as a metal, a polymer, a composite, or a natural substance. A pivot, a through slot, a gap for a fastener head, a guide groove, a height tab, a height adjustment hole, a fretting crown, and/or a fastening opening may be cast, moulded, milled, and/or tapped into the material of the fretting appendage (which may be the material of a block making up the fretting appendage). A fretting appendage may include multiple components. A fretting appendage may include a threaded insert. In additional or alternative embodiments, some features, such as a pivot or a height tab, may be omitted; for example, a shim may be used to adjust the vertical position of a fretting appendage instead of a height screw, height tab, and/or pivot. A fretting appendage may have a shorter or longer longitudinal length, a wider or narrower lateral width, or a larger or smaller vertical thickness than illustrated. A fretting crown may be formed from fretwire or another firm material and attached to a fretting appendage. A fretting crown may be a vertically or longitudinally movable component of a fretting appendage. All features and functions of a fretting appendage described in this document may be included by a block which makes up the fretting appendage.

For common curved fingerboard radii, a fingerboard matching angle may be from zero to ten degrees, depending on a lateral position of a string and a radius of a neck. However, for an instrument with a small fingerboard radius and a wide neck, a fingerboard matching angle may be as large as twenty degrees. Although some buzz may result, a generic fretting appendage with a fingerboard matching angle of zero degrees may be positioned under any string of an instrument with a radiused fingerboard. Similarly, a generic fretting appendage with an averaged or estimated fingerboard matching angle may be used to approximately match one or more fingerboard angles.

A saddle means may contact a string 70. The saddle means may establish a vertical position, a longitudinal position, and a lateral position of a longitudinally rearward critical contact point 100a of the string at a body 10. A saddle means may perform this function for a single string or for multiple strings, and may include one or more saddles, each of which may contact one or more strings. A saddle means and a nut 55 may direct a string at a wrist fretable vertical distance above a fretting crown 185 of a fretting appendage 140, and the fretting appendage may be adjusted such that the fretting crown is at a wrist fretable vertical distance under the string; in adjusting an assembly, a user may adjust the saddle means, the fretting appendage, or both. A saddle means may position a longitudinally rearward critical contact point of a string in an intonated position, in a nominal position, or in another position. A saddle means, in conjunction with a support of the saddle means, may establish a lateral string spacing 75.

A support may be a saddle support 81, a fretting appendage support 82, or a common support 83 (of a fretting appendage and a saddle means). A support may include a pickup opening 285. A support may be mounted in conjunction with a pickguard 275. A support may include other features such as a shim 245. A support may include a metal (i.e., sheet metal), a polymer, a composite, or a natural substance (i.e., wood). A support may be shaped, such as by casting, milling, bending, or welding. A support may be attached to a body with support screws 300, with adhesive, or by another method. A support may include multiple components. A support may be contacted by a fretting appendage 140, including by a downward surface 172 or a pivot 210 of the fretting appendage.

A fretting appendage may be coupled to and adjustably positioned on a support, and the support may couple the fretting appendage to, and adjustable position the fretting appendage on, a body. A fastener may couple and position the fretting appendage on the support and on the body by way of the support.

A saddle support may be positioned on and coupled to a body. A saddle means may be coupled to the saddle support. The saddle means may be positioned on and coupled to the body by the saddle support. A saddle support may be an acoustic saddle support 81bor a vibrato mechanism saddle support 81a, or any other type of saddle support.

A saddle support or a saddle means may incorporate bridge features, such as saddles, of electric, acoustic, flat top, or arched top guitars and bass guitars. A saddle support or a saddle means may incorporate bridge features of fixed or vibrato bridges. A saddle support or a saddle means may be adapted for use with a string bending device, headless tuners which may mount on a body, fine tuners, a string retainer, or other features which may be included by an assembly. A saddle means may be fully or partly integrated with a saddle support. Two saddles may be supported by two separate saddle supports. A saddle means may include one or more saddles. Any saddle form, whether acoustic or electric, may be included in a saddle means. Each saddle of a saddle means may be configured for one string or for multiple strings.

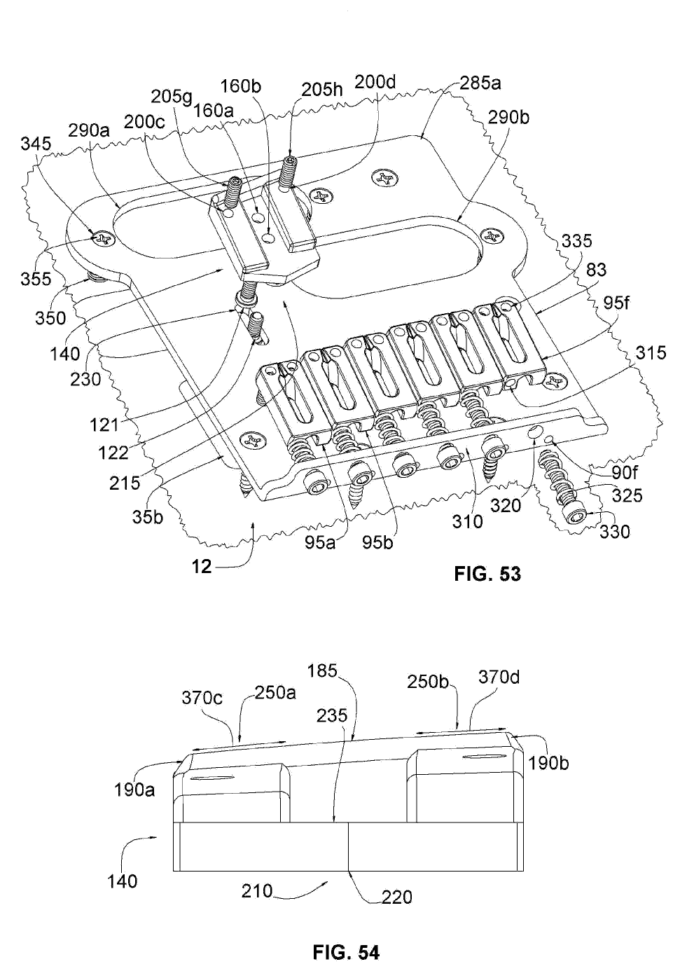

In additional or alternative embodiments, a fretting appendage including a one string fretting crown may include a pivot including a single contact projection. The fretting appendage may be used with two height screws, which may insert into two height adjustment holes and adjust a vertical position of a fretting end of the fretting appendage. This may be accomplished in a manner similar to a fretting appendage in FIG. 53.

In additional or alternative embodiments, a screw or another component may serve as a part of a pivot.

An assembly 12 may include a fastening means, which may include a fastener and a fastening opening 160. A fastening opening may be included by a fretting appendage 140. A fastening opening may be included by a support. A fretting appendage may be used with a single fastener or with more than one fastener. A fretting appendage may be used with one of its respective fasteners in place and another fastener removed. The use of a second fastener may assist with alignment and centering. A fastener may be threaded, and may be a screw. A fastening opening may be a threaded hole.

A fastener, by itself (without the use of an additional fastener), may couple a fretting appendage 140 to a support, which may couple the fretting appendage to a body 10. The fretting appendage may be detached from the support and the body by removing the fastener. The fastener may have a non locking configuration and a locking configuration. In a non locking configuration, a longitudinal position of the fretting appendage (including a fretting crown 185) may be adjustable relative to a saddle means, a string 70 (and its longitudinally rearward critical contact point 100a), the body, and the support. In a non locking configuration, a vertical position of the fretting position of the fretting appendage may be adjustable relative to the body, the support, and the string. In a non locking configuration, a vertical position of a fretting end 180 (including the fretting crown) of the fretting appendage may be adjustable relative to the string, the body, and the support. In a locking configuration, the fastener may lock the longitudinal position of the fretting appendage (including the fretting crown) relative to the saddle means, the string (and its longitudinally rearward critical contact point), the body, and the support, and may lock the vertical position of the fretting end (including the fretting crown) relative to the string, the body, and the support. In a locking configuration, the fastener may lock the vertical position of the fretting appendage. In a locking configuration, the fastener may lock a lateral position of the fretting appendage. The fastener may lock the fretting appendage against a guide surface of the support. The fastener may be configured between locked or non locked configurations by turning it. A body cavity 35 may provide space to allow insertion of the fastener. When fixed in position by the locking action of the fastener, the fretting appendage may allow the wrist or another part of the hand to rest against it during play. For stability, a fastener may be longitudinally between a height screw and a pivot. A fastener may lock a fretting appendage against a surface of a support.

A body cavity 35 may include an aperture. A body cavity may provide access to a support for positional adjustment of a fretting appendage, including the fretting end and fretting crown. The support, a height screw, a fastener, or the fretting appendage may be accessed through the aperture of the body cavity, and adjusted.

Using a height screw, a vertical position of a fretting end of a fretting appendage may be adjusted with a fastener in a non locking configuration. Using a shim, a vertical position of both the supporting end and the fretting end may be adjusted with the fastener in a non locking configuration. The fastener may lock the vertical position of the fretting appendage after the vertical position of one or both ends is adjusted.

In additional or alternative embodiments, a fastener may include a threaded nut, a latch, a hook, a clip, a pin, a washer, a bracket, a wire, a snap, or another fastening feature. A fastener may include multiple components. A fastener may be formed or attached as a part of a fretting appendage or a support. A fastening opening may be varied or omitted with a varied fastener form. A position of a fastener or fastener opening may be varied. A fastener may fasten directly into the material of a body. Multiple fasteners may separately lock longitudinal positions, vertical positions, or lateral positions of a fretting appendage, of a fretting end, of a fretting crown, or of a combination of the three.

A position of a fretting appendage 140 may be established and adjusted using one or more longitudinal slots. A support, the fretting appendage, or both, may include a longitudinal slot. A longitudinal slot may restrict lateral movement of the fretting appendage, while allowing vertical and longitudinal repositioning. One or more longitudinal slots may restrict lateral movement of a fretting appendage at one or more points. A longitudinal slot may be a through slot 230, a guide groove 145, or a channel. A longitudinal slot may be centered under, or aligned with, a string. A longitudinal slot, a fastener, or a fastening opening may establish a lateral position of a fretting appendage. In additional or alternative embodiments, a longitudinal slot may be aligned with a centerline of the neck. In some embodiments, a longitudinal slot is centered between two strings.

An insert may insert, or partly insert, into a longitudinal slot in a fretting appendage 140, and may connect to a support. An insert connecting to a support (such as a height screw, fastener, a bracket, or a portion of the support) may be included by the support. A longitudinal position of the fretting appendage may be adjusted by manipulating (for example, by sliding) the fretting appendage along the insert, which may be in the longitudinal slot and may contact a guide surface of the longitudinal slot during movement. An insert may be a height screw 205, a fastener, a portion of the support (such as a barrier), or another feature. The insert may be coupled to or integrated with the support. For example: i) A height screw may insert into a guide groove 145 in a fretting appendage and into a height adjustment hole 200 in a support. ii) A fastener may insert through a through slot 230 in a fretting appendage into a fastening opening 160 in a support. iii) A barrier 410 of a support may insert into a channel in a fretting appendage.

An insert may insert, or partly insert, into a longitudinal slot in a support, and may connect to a fretting appendage 140. An insert connected to a fretting appendage (such as a height screw, fastener, a bracket, or a portion of the support) may be included by the fretting appendage. A longitudinal position of the fretting appendage may be adjusted by manipulating (for example, by sliding) the fretting appendage along the longitudinal slot. The insert may be in contact with a guide surface of the longitudinal slot during movement. An insert may be a height screw 205, a fastener, a portion of the fretting appendage (such as a supporting end; a portion of the fretting appendage may insert into a longitudinal slot and act as an insert), or another feature. The insert may be coupled to, or integrated with the fretting appendage. For example: i) A height screw may insert into a guide groove 145 in a support and into a height adjustment hole 200 in a fretting appendage. ii) A fastener may insert through a through slot 230 in a support into a fastening opening 160 in a fretting appendage. iii) A supporting end 215 (including a pivot 210) of a fretting appendage may insert into a channel in a support.

In additional or alternative embodiments, a single longitudinal slot may contain or position two or more fretting appendages. For example, lateral sides of a proximal fretting appendage and a distal fretting appendage might be locked against one another by a longitudinal slot and a fastener, locking a longitudinal or vertical position of one or both fretting appendages on a support on a body. Thus, the laterally proximal fretting appendage and the laterally distal fretting appendage may be vertically and longitudinally repositionable, may support one another during repositioning, and may be locked against one another by a fastener.

A longitudinal positioning range of a fretting appendage 140 and a vertical positioning range of its fretting end 180 (including a fretting crown 185) may enable the fretting end to define an intonated, wrist fretable note a semitone above an open note of a respective string 70. The fretting appendage may be positionable with its fretting end defining an intonated, wrist fretable note a semitone (or other interval) above the open note of the string.

A length of a through slot 230 or a guide groove 145, and a longitudinal position of a fastening opening or height adjustment hole 200 may establish a longitudinally foremost fretting appendage position and/or a longitudinally rearmost fretting appendage position.

A height screw 205 may extend between a fretting appendage 140 and a support (and thus a body 10) to raise and lower a fretting end 180 of the fretting appendage. An upper end of the height screw may contact and interface with the fretting appendage and a lower end may contact and interface with the support. The height screw may cooperate with a fastener in locking a position of the fretting appendage. The fastener, in a locking configuration, may apply force through the support and the fretting appendage to the height screw. The height screw may adjust a vertical position of the fretting end (including a fretting crown 185) relative to a string 70, the body, and the support, by pivoting the fretting appendage on a pivot 210. Thus, the height screw may adjust the vertical distance between i) the fretting end (including the fretting crown) and ii) the string, the body, and the support. The height screw may insert into a height adjustment hole 200, which may be threaded. The height screw may be used by turning it. A height tab 195 may be located on a fretting appendage such that the string is farther from the height tab than from a fretting crown of the fretting appendage. A height adjustment hole may be longitudinally spaced from a through slot 230 or a fastening opening 160 such that the height screw does not fall into the through slot or the fastening opening or collide with a fastener. A height screw may support a vertical position of a fretting appendage, (including supporting a vertical position of a fretting end and including supporting a vertical position of a fretting crown) during adjustment of a longitudinal position of the fretting appendage. Turning the height screw in a first direction may adjust the fretting end (including the fretting crown) upward toward a respective string. Turning the height screw in a second direction may adjust the fretting end (including the fretting crown) downward, away from the string.

In some embodiments, a height adjustment hole may be located in a fretting appendage, and above a support; a height screw may raise the fretting end by pushing against the support. A fastener may be configured to lock the height screw to the support. In some embodiments, a height adjustment hole may be located in a support, under a downward surface of a fretting appendage; a height screw may raise the fretting appendage by pushing against a downward surface of the fretting appendage. A fastener may be configured to lock the height screw to the fretting appendage.

A vertical position adjustment means of a fretting appendage may include a height screw 205 and a height adjustment hole 200. A fretting appendage including a height adjustment hole may pivot on a height screw and the height screw may pivot against the support during height adjustment. A fretting appendage may pivot on and against a height screw inserted into a height adjustment hole in a support during height adjustment. A height screw may be a headless set screw or other screw form, such as one with a head. A height screw of a longer or shorter length may be used. In additional or alternative embodiments, an alternative vertical adjustment means (such as a single shim, a stack of shims, or a sliding shim) for a fretting appendage, a fretting end, and/or a fretting crown may be included in an assembly. A position of a height adjustment hole in a fretting appendage or in a support may be shifted, and a height tab of a fretting appendage may be omitted or moved. In additional or alternative embodiments, a single height adjustment hole for use with a fretting appendage may be off-center from a respective string.

Features of an assembly 12 may align a fretting appendage 140 with a string 70. A channel and a lateral fastener 124 may limit lateral movement of a fretting appendage at multiple points. A height screw 205 and a guide groove 145 may limit lateral movement of a fretting appendage at a first point. A through slot 230, a longitudinally forward fastener 121, and a longitudinally forward fastening opening 160a may limit lateral movement of a fretting appendage at a second point. The through slot, a longitudinally rearward fastener 122, and a longitudinally rearward fastening opening 160b, may limit lateral movement of a fretting appendage at a third point. These points may be spaced longitudinally, laterally, or vertically from one another. These features may align the fretting appendage with a string, center the fretting appendage and a fretting crown 185 of the fretting appendage under the string, and assist in maintaining a fingerboard matching angle 250 of the fretting crown. A fretting appendage may be visually aligned with a string. Features of a fretting appendage along a centerline of the fretting appendage may aid in visual alignment of the fretting appendage with a string. A fretting appendage may be laterally symmetrical when viewed from above, which may assist with visual alignment.

Several factors may act to increase the pitch of a fretted fingerboard note during a fretting action at a fingerboard fret 65. A few of these factors may include: i) the force required to fret the string 70 due to the height of the string above the fingerboard fret, ii) the thickness and material of the string, and iii) excess force of the player’s finger on the string. If a longitudinally rearward critical contact point 100a of a string on a saddle 95 were positioned exactly as suggested by a neck scale length, fingerboard frets might produce pitches that were sharp and out of tune. To correct this, the longitudinally rearward critical contact point of the string may be moved longitudinally rearward, away from the nut 55, increasing the sounding lengths of the string’s open note and the string’s fretted fingerboard notes. This adjustment may be called “intonating” the string. Intonating a string may be done several ways. For example, intonation may be accomplished by i) angling a saddle in a saddle slot, ii) shaping a saddle, and/or iii) mechanically adjusting a longitudinal position of a saddle. The lengthened sounding lengths of an intonated string may counteract the sharpness due to the factors listed above, making fretted fingerboard notes play in tune.

When wrist fretting, a player may use the picking hand 400 to change a note of a string 70. The pisiform bone wrist area 395 of the picking hand may be used to depress the string between a fretting crown 185 and a saddle 95 until the string contacts the fretting crown, shortening the sounding length of the string. The string may be directly contacted with the skin of the wrist, immediately longitudinally to the rear of the fretting crown. A shortened sounding length of the string between the fretting crown and a nut 55 may then be plucked with the picking hand thumb to produce sound. When wrist fretting, the wrist may move the string to the fretting crown, and the fretting crown may remain stationary. When using the pisiform bone wrist area of the picking hand to wrist fret, the thumb and fingers of the picking hand may be free to pluck any string, and the fretting hand may be left free. While wrist fretting with the picking hand, the fretting hand may be used to fret fretted fingerboard notes on strings which are laterally distal to the wrist fretting string. This may enable new combinations of low pitched wrist fretted notes and higher pitched fretted fingerboard notes.

A player may play a wrist fretted note on a wrist fretting string, play an open note on the wrist fretting string, or play a fretted fingerboard note on the wrist fretting string. These actions may be performed rapidly; the player may switch from one to another in a fraction of a second.

While playing a wrist fretted note, strings 70 which may be laterally distal to the wrist fretting string may be used to play fretted fingerboard notes and open notes. When using an assembly which includes a first fretting crown segment 370c and a second fretting crown segment 370d (or more fretting crown segments) a player may change from a first wrist fretted note to a second wrist fretted note by repositioning the wrist.

Adjustable longitudinal and vertical positioning of a saddle 95 or of a fretting appendage 140 may accommodate for small errors that a user or a manufacturer may make in positioning an assembly 12 on an instrument 5.

A vertical position and a longitudinal position of a fretting crown 185 may be adjusted such that the fretting crown defines a wrist fretable note a semitone (or another interval) above an open note of a respective string 70.

A fretting crown 185, which defines a wrist fretable note, may be at a wrist fretable vertical distance under a respective string 70; the string may be at a wrist fretable vertical distance above the fretting crown. To define a wrist fretable note, a fretting crown may be adjusted in a position in which it is vertically high enough to be used for wrist fretting with a respective string and vertically low enough that the string may be used to play an open note.

A fretting crown 185 may be positioned, relative to a respective string 70, in a position such that it defines a wrist fretable note and such that a fingerboard fret 65 may be used to play a fretted fingerboard note with the string. A fretting crown may be positioned relative to a respective string such that a fretted fingerboard note may be played with each fingerboard fret under the string, such that the open string may be played, and such that a wrist fretted note may be played with the fretting crown.

In some higher vertical positions, a fretting crown 185 defining a wrist fretable note above an open note of a respective string 70 may prevent one or more fingerboard frets 65 from being used to play their respective fretted fingerboard notes; with the fretting crown in these vertical positions, if the fretting hand 405 presses the string against a fingerboard fret, the string may come into contact with the fretting crown. Slightly lowering the vertical position of the fretting crown may make the fingerboard fret playable.

Although it may prevent a fretting crown 185 from being used for wrist fretting, a vertical position of a fretting crown may be adjusted upward, such that the fretting crown contacts a respective string 70, or downward, such that depressing the string between a saddle 95 and the fretting crown brings the string into contact with a fingerboard fret 65.

A longitudinal position of a fretting crown 185 may be adjusted such that the distance from the fretting crown to a longitudinally forward critical contact point 100b of a respective string 70 is less than, equal to, or greater than a nominal semitone sounding length. The longitudinal position of the fretting crown may be adjusted such that the distance from the fretting crown to the longitudinally forward critical contact point of the string is less than, equal to, or greater than the distance from a first fingerboard fret 65a to a longitudinally rearward critical contact point 100a of the string.

An adjustable longitudinal position of a fretting crown 185 may enable a user to begin a setup process with the fretting crown at a nominal semitone sounding length from a nut 55 and then adjust the position of the fretting crown until a wrist fretable note is intonated.

To correct a sharp wrist fretted note, a fretting crown 185 may be moved away from a nut 55, lowering the pitch of the wrist fretted note. To correct a flat wrist fretted note, the fretting crown may be moved toward the nut, raising the pitch of the wrist fretted note.

A longitudinally and vertically adjustable fretting appendage allows a user to intonate a wrist fretable note, compensating for a previously unknown set of factors may affect the pitch of the wrist fretted note, such as: 1) Pressure of the wrist on a string 70 when wrist fretting may increase the amount of tension on the string. 2) The longitudinal position of a longitudinally rearward critical contact point 100a of a string may be adjusted to intonate fingerboard frets 65. 3) To enable twelve or more fingerboard frets to be playable, a vertical distance from a string to a fretting crown 185 may be adjusted to be greater than a vertical distance from the string to a fingerboard fret intended to produce the same note as the fretting crown; as a result, it may take more force to wrist fret at the fretting crown than to fret at the respective fingerboard fret.

One way of setting up an instrument is as follows: A string 70 may be set up to play an open note, intonated fretted fingerboard notes, and an intonated wrist fretted note. To intonate the string’s fretted fingerboard notes, a longitudinally rearward critical contact point 100a of the string may be adjusted such that the sounding length of the open string is longer than a neck scale length. Then, a vertical position of a fretting crown 185 may be adjusted low enough that twelve or more fingerboard frets 65 may be used to play fretted fingerboard notes with the string (some players may enjoy adjusting it low enough that all of the fingerboard frets are playable). Then, the fretting crown may be adjusted to be farther from the longitudinally forward critical contact point 100b of the string than the first fingerboard fret 65a is from the longitudinally rearward critical contact point; the distance from the fretting crown to the longitudinally forward critical contact point may be greater than a nominal semitone sounding length. The distance from the fretting crown to the longitudinally rearward critical contact point may be less than a nominal semitone oddment length, and may be less than the distance from the first fingerboard fret to the longitudinally forward critical contact point. The fretting crown and the first fingerboard fret may produce the same pitch, but may do so with unequally long sounding lengths of the string. Specific positioning may be determined by ear and by checking pitches with an electronic tuning device.

A position of a longitudinally rearward critical contact point 100a of a string 70 may be adjusted by shaping a saddle 95 or by adjustably longitudinally positioning a saddle with a saddle intonation screw 330 and vertically positioning the saddle with an action screw 340. This may intonate fingerboard fretted notes of the string. An adjustable saddle or a shaped saddle may allow a longitudinally rearward critical contact point of a string to be positioned at a distance less than, equal to, or greater than a neck scale length from a longitudinally forward critical contact point 100b of the string. A position of a longitudinally rearward critical contact point of a string may be adjusted relative to a body 10, a support, a neck 40, a fingerboard 60, a sequence of fingerboard frets, a fretting appendage 140 (including a fretting crown 185), a nut 55, and a longitudinally forward critical contact point of the string.

In a right handed seated playing posture, a laterally distal body side 20 may contact the leg of the player, and a laterally proximal body side 15 may be nearer to the chest of the player. The teachings in this document are applicable to right and left handed instruments 5. The instruments in this document may be illustrated as right handed instruments; if a six string instrument were tuned to standard guitar tuning, a laterally outermost proximal string might be a “low E” string, and a laterally outermost distal string might be a “high E” string. An instrument may be illustrated or described with right handed form and function; however, left handed form and function may be substituted for right handed form and function. Thus, if a left handed instrument were tuned to standard guitar tuning, a laterally outermost proximal string might be a “low E” string, and a laterally outermost distal string might be a “high E” string, although the instrument might be a mirror image of a right handed instrument.

A fretting appendage 140 may be positionable to define a wrist fretable note a semitone, whole step, minor third, major third, or other interval above an open note of a string 70. A player may find it advantageous to play a wrist fretable note of a particular interval above an open note of the string, and may prefer that interval to other intervals. A longitudinally forward extent of a fretting appendage 140 and/or a forward longitudinal end of a fretting appendage support 82 may be positioned at a distance which is about (it may be a little more or a little less) a nominal sounding length (respective to the desired interval) from the nut 55.

In some embodiments, a longitudinally forward extent of a fretting appendage 140 is the foremost point of a fretting end; for example, the tip of a height tab 195 of a fretting end 180 of the fretting appendage. In some embodiments, a longitudinally forward extent of a fretting appendage may be a foremost longitudinal point of a fretting end of a fretting appendage which does not have a height tab.

For some players, certain lateral widths and longitudinal lengths of features of an assembly 12 may enable wrist fretting while minimizing unintentional contact with the picking hand 400. Some players may find a fretting appendage 140 with a narrower lateral width or a shorter longitudinal length minimizes unintentional contact with the hand. Some players may find that a longitudinally forward extent of a fretting appendage which is nearer to a saddle means minimizes unintentional contact with the hand. A laterally narrow and longitudinally short fretting appendage may be light in weight, and may be positioned near or next to other parts of an assembly such as one or more consecutive fretting appendages under consecutive strings, a pickup 125, or a saddle means. By making fretting appendages laterally narrow, they may be adjustably positioned under consecutive strings each in a semitone position, without interfering with one another.

A fretting appendage with a one string fretting crown, which has a lateral width of less than 200% of a lateral string spacing, when centered under a string, may not laterally protrude under a consecutive string. A fretting appendage, or fretting crown, which has a lateral width of less than 100% of a lateral string spacing, when centered under a string, may allow a similar fretting appendage to be centered under a consecutive string such that each fretting appendage may be adjusted without interfering with the movement of the other.

A fretting appendage with two fretting crown segments, which has a lateral width of less than 200% of a lateral string spacing, when centered between a proto and a deutero string, may allow a fretting appendage to be positioned under a trito string such that each fretting appendage may be adjusted without interfering with the movement of the other. A fretting appendage with two fretting crown segments, which has a lateral width of less than 300% of a lateral string spacing, may be positioned under two strings without protruding under another string.

A player may switch among playing a wrist fretted note on a wrist fretting string, playing a fretted fingerboard note on that string, and playing that string as an open string. A simultaneous wrist fretting and fingerboard fretting action on the same string may be possible, but may result in unorthodox pitches.

A string 70 may be brought into contact with a fretting crown by a finger of the picking hand 400, or by another part of the picking hand.

Wrist fretting may be combined with slide guitar, flat picking, slapping, tapping, and other techniques.

An instrument 5 may be strung with steel, nylon, and other strings 70.

An instrument 5 may be tuned to a standard tuning or an alternate tuning.

An assembly 12 may include a piezoelectric pickup.

An instrument 5 may include a fretted fingerboard 60. In additional or alternative embodiments, an instrument may include a fretless fingerboard; an instrument with a fretless fingerboard may be otherwise similar to fretted instruments.

An illustrated instrument may include features of an electric guitar or an acoustic guitar. In additional or alternative embodiments, an instrument may include features of a four; five; or six string bass guitar, seven or eight string guitar, banjo, ukulele, steel guitar, zither, or other instrument. In further additional or alternative embodiments, the instrument may include features of a fretless variant of one of these.

In additional or alternative embodiments, fingerboard frets of an instrument may have a diatonic or a microtonal spacing. A fretting crown may be positioned to define a microtonal wrist fretable note. A described intonation method may be used to intonate a saddle or a fretting crown of an instrument with a diatonic or a microtonal spacing.

In additional or alternative embodiments, an instrument may include fanned fingerboard frets. Ranges of positional location of features may be adapted for this configuration.

In additional or alternative embodiments, an instrument may include a varied number of strings. An instrument may include an extra neck or harp guitar strings.

In additional or alternative embodiments, a supporting end of a fretting appendage may be longitudinally forward of a fretting end of the fretting appendage. The fretting end may be positioned between a pivot of the fretting appendage and a saddle means. The pivot and the fretting end may be centered under a respective string. In some embodiments, a pivot is located longitudinally between a fretting crown and a respective saddle of a saddle means. In additional or alternative embodiments, a pivot is located between the fretting crown and the neck.

In additional or alternative embodiments, two or more longitudinally consecutive fretting appendages may be positioned under a single string to define a lower pitched wrist fretable note and a higher pitched wrist fretable note.

In additional or alternative embodiments, one or more braces may be shaped in alternative shapes and may be positioned in alternative positions; for example: like in classical guitars or in steel string guitars.

Some positions and dimensions may be understood by comparing them with a lateral string spacing 75. Some positions and dimensions may be understood by comparing them with a neck scale length, a nominal sounding length, or a nominal oddment length. Some positions and dimensions of a feature may be understood by comparison with positions of other features.

As illustrated, a neck scale length and a lateral string spacing 75 included by an instrument 5 may be typical of a guitar. However, an instrument may include a neck scale length as long or longer than a neck scale length of a double bass or as short or shorter than a neck scale length of a ukulele. Strings of an instrument may have a lateral string spacing as wide or wider than a lateral string spacing of a double bass or as narrow or narrower than a lateral string spacing of a ukulele.

In some embodiments, a neck scale length is less than 300 mm. In some embodiments, a neck scale length is more than 1200 mm. In some embodiments, a neck scale length is from 300 mm to 1200 mm. In some embodiments, a neck scale length is from 500 mm to 900 mm.

In some embodiments, a lateral string spacing is less than 7.5 mm. In some embodiments, a lateral string spacing is more than 40 mm. In some embodiments, a lateral string spacing is from 7.5 mm to 40 mm. In some embodiments, a lateral string spacing is from 9 mm to 25 mm.

In some embodiments, a longitudinal length of a fretting appendage is more than 25% of a neck scale length. In some embodiments, a longitudinal length of a fretting appendage is less than or equal to 25%, 21%, 16%, 11%, and/or 6% of a neck scale length.

In some embodiments, a longitudinal distance from a fretting crown to a pivot is more than 21% of a neck scale length. In some embodiments, a longitudinal distance from a fretting crown to a pivot is less than or equal to 21%, 16%, 11%, 6%, 4%, and/or 3% of a neck scale length.

In some embodiments, a longitudinal distance from a height adjustment hole to a pivot is more than 21% of a neck scale length. In some embodiments, a longitudinal distance from a height adjustment hole to a pivot is less than or equal to 21%, 16%, 11%, and/or 6% of a neck scale length.

In some embodiments, at least a portion of a pickup is coupled to a body, under a string, less than 75% of a neck scale length from a nut. In some embodiments, at least a portion of a pickup is coupled to a body, under a string, at a distance greater than or equal to 75%, 80%, 85%, and/or 90% of a neck scale length from a nut. A fretting appendage may be between the pickup and a saddle means. In some embodiments, a pickup including a laterally distal coil and a laterally proximal coil is positioned on the body, longitudinally forward of the saddle means, at least party within 70 mm of the saddle means, with the laterally proximal coil under a laterally outermost proximal string of the plurality of strings, with the laterally distal coil under a laterally outermost distal string of the plurality of strings, and such that a distance from the nut to the laterally proximal coil is less than a distance from the nut to the laterally distal coil. The fretting appendage may be adjustably positionable on the body with the fretting crown longitudinally rearward of the laterally proximal coil and laterally proximal to the laterally distal coil.

In some embodiments, a longitudinal distance between a nut and a forward longitudinal end of a support of a fretting appendage is less than 79% of a neck scale length. In some embodiments, a longitudinal distance between a nut and a forward longitudinal end of a support of a fretting appendage is greater than or equal to 79%, 84%, 89%, and/or 94% of a neck scale length.

In some embodiments, a longitudinal distance from a nut to a longitudinally forward extent of a fretting appendage is less than 75% of a neck scale length. In some embodiments, a longitudinal distance from a nut to a longitudinally forward extent of a fretting appendage is greater than or equal to 75%, 79%, 84%, 89%, and/or 94% of a neck scale length.

In some embodiments, a longitudinal distance from a nut to a fastener coupling a fretting appendage to a body and/or a support is less than 79% of a neck scale length. In some embodiments, a longitudinal distance from a nut to a fastener coupling a fretting appendage to a body and/or a support is greater than or equal to 79%, 84%, 89%, and/or 94% of a neck scale length. In some embodiments, the fastener may couple the fretting appendage to a soundboard included by a top included by a hollow body. In some embodiments, a fastener couples a fretting appendage to a soundboard of a hollow body within 70 mm of a longitudinally rearward critical contact point of a respective string on a saddle means.

In some embodiments, a lateral width of a fretting appendage is more than 500% of a lateral string spacing. In some embodiments, a lateral width of a fretting appendage is less than or equal to 500%, 400%, 300%, 200%, 100%, 75%, 50%, and/or 45% of a lateral string spacing. In some embodiments, a lateral width of a fretting appendage is greater than 50 mm. In some embodiments, a lateral width of a fretting appendage is less than or equal to 50 mm, 40 mm, 30 mm, 20 mm, 15 mm, 10 mm, or 8 mm.

In some embodiments, a lateral width of a fretting crown is more than 500% of a lateral string spacing. In some embodiments, a lateral width of a fretting crown is less than or equal to 500%, 400%, 300%, 200%, 100%, 75%, 50%, and/or 45% of a lateral string spacing. In some embodiments, a lateral width of a fretting crown is greater than 50 mm. In some embodiments, a lateral width of a fretting crown is less than or equal to 50 mm, 40 mm, 30 mm, 20 mm, 15 mm, 10 mm, or 8 mm.

In some embodiments, a lateral distance between a first point and a second point at which a support is contacted by a pivot is greater than a lateral string spacing. In some embodiments, a lateral distance between a first point and a second point at which a support is contacted by a pivot is less than or equal to a lateral string spacing. In some embodiments, a pivot contacts a surface on the body, such as a support, and supports the block on the body, within 80 mm of a longitudinally rearward critical contact point of a respective string on a saddle means. In some embodiments, a pivot contacts a surface on the body, such as a support, and supports the block on the body, at a distance equal to or greater than 80 mm from a longitudinally rearward critical contact point of a respective string on a saddle means. In some embodiments, the pivot supports a fretting appendage on a body at least a first point and a second point, and the first point is 2 mm or more away from the second point. In some embodiments, a pivot supports a fretting appendage at a single point, or at two points closer together than 2 mm. In additional or alternative embodiments, a fretting appendage includes a block having a pivot in the form a hinge.

In some embodiments, a proximal lateral side of a fretting appendage and a proximal lateral end of a fretting crown of the fretting appendage under a string are, measured in a lateral direction only (ignoring any difference in vertical position), less than 100% and/or 60% of a lateral string spacing from that string in a laterally proximal direction.

A fretting appendage may include a fretting crown under a respective string. In any embodiment, a lateral side of the fretting appendage and a lateral end of the fretting crown may be laterally between the respective string and a consecutive string. Some embodiments may include consecutive strings to the respective string in both lateral directions; a proximal lateral side of fretting appendage and a proximal lateral end of the fretting crown may be laterally between the respective string and a proximally consecutive string; a distal lateral side of the fretting appendage and a distal lateral end of the fretting crown may be laterally between the respective string and a distally consecutive string.

In some embodiments, a distal lateral side of a fretting appendage and a distal lateral end of a fretting crown of the fretting appendage under a string are, measured in a lateral direction only (ignoring any difference in vertical position), less than or equal to 100% and/or 60% of a lateral string spacing from that string in a laterally distal direction.

In some embodiments, a fastener or the height screw tilts (is angled) from 0 degrees to about 17 degrees. In additional or alternative embodiments, the fastener or the height screw tilts more than 17 degrees.

At a point under a fretting appendage, a vertical thickness of the support to which it is coupled may be greater than 3 mm. At a point under a fretting appendage, a vertical thickness of the support to which it is coupled may be less than or equal to 3 mm, 2.5 mm, 2 mm, 1.5 mm, and/or 1 mm.

An intonated note, above an open note of a string tuned to concert pitch, may be within 20 cents, 15 cents, 10 cents, and/or 7 cents of concert pitch.

A change of .127 mm of a position of a fingerboard fret, a fretting crown, or a critical contact point of a string may be noticeable to some users. A position of a feature may be adjusted by less than .127 mm. For example, an assembly may include a M3x0.5 screw as a saddle intonation screw; turning the M3x0.5 screw a quarter of a turn may adjust a longitudinal position of a respective saddle by about .125 mm.

In some embodiments, a first saddle is positionable at a distance from a nut which is greater than, equal to, or less than a distance between a second saddle and the nut. In some embodiments, a first saddle is positionable at least 0 mm, .127 mm, .25 mm, .5 mm, 1 mm, 2 mm, 4 mm, and/or 6 mm longitudinally rearward of a second saddle.

In some embodiments, a fretting crown of a first fretting appendage is positionable at a distance from a nut which is greater than, equal to, or less than a distance between a fretting crown of a second fretting appendage and the nut. In some embodiments, a fretting crown of a first fretting appendage is positionable at least 0 mm, .127 mm, .25 mm, .5 mm, 1 mm, 2 mm, 4 mm, and/or 6 mm longitudinally rearward of a fretting crown of a second fretting appendage.

An assembly may include a first fretting crown segment and a second fretting crown segment. The first fretting crown segment may be positioned under a proto string. The second fretting crown segment may be positioned under a deutero string. The first fretting crown segment may be included by a fretting crown of a first fretting appendage, and the second fretting crown segment may be included by a fretting crown of a second fretting appendage. Alternatively, the first and second fretting crown segments may be included by a single fretting appendage. A first distance may be longer than a second distance by an amount greater than or equal to: 0 mm, .127 mm, .25 mm, .5 mm, .75 mm, 1 mm, 1.5 mm, 2 mm, 3 mm, 4 mm, and/or 5 mm. This may include one or more of the following pairs: i) First distance: From a longitudinally rearward critical contact point of the proto string to a twelfth fingerboard fret. Second distance: From a longitudinally forward critical contact point of the proto string to the twelfth fingerboard fret. ii) First distance: From a longitudinally rearward critical contact point of the deutero string to the twelfth fingerboard fret. Second distance: From a longitudinally forward critical contact point of the deutero string to the twelfth fingerboard fret. iii) First distance: From the longitudinally forward critical contact point of the proto string to the longitudinally rearward critical contact point of the proto string. Second distance: From the longitudinally forward critical contact point of the deutero string to the longitudinally rearward critical contact point of the deutero string. iv) First distance: From the first fretting crown segment to the longitudinally forward critical contact point of the proto string. Second distance: From a first fingerboard fret to the longitudinally rearward critical contact point of the proto string. v) First distance: From the second fretting crown segment to the longitudinally forward critical contact point of the deutero string. Second distance: From the first fingerboard fret to the longitudinally rearward critical contact point of the deutero string. vi) First distance: From the first fretting crown segment to the longitudinally forward critical contact point of the proto string. Second distance: From the second fretting crown segment to the longitudinally forward critical contact point of the deutero string.

The numerals of Greek origin: proto, deutero, trito, tetarto, pempto, and hecto may be sometimes used to indicate repeated elements. They may be understood to function as first, second, third, fourth, fifth, and sixth, as ordinarily used in technical writing. Lateral position is not implied by the numerals of Greek origin, and may be indicated in another manner. The numerals of Greek origin may avoid confusion that might result from the use of “first string,” “second string,” “third string,” and so forth, as these phrases may have traditional meanings which imply lateral positions. Where “first string,” “second string,” “third string” etc. are used, they may be understood to have their traditional meanings. In some embodiments, a plurality of consecutive laterally spaced strings includes a proto string, a deutero string, a trito string, a tetarto string, etc., and the proto string is a laterally outermost proximal string. Described embodiments may be interpreted to include these configurations, while not excluding other possible string configurations. Because the figures show certain instruments, for the convenience of the reader, proto string, deutero string, trito string, tetarto string, pempto string, and hecto string may be associated with specific reference numerals. However, the reader should keep in mind that any embodiment may have a varied number of strings, and that the numerals of Greek origin may be used to describe strings in lateral positions other than those illustrated. For example, a proto string may consistently be illustrated in the figures as a laterally outermost proximal string; however, it may be understood that, in a claim in which relative lateral position of strings is not indicated, a proto string may have this lateral position or a different lateral position in relation to another string. Relative to one another, two consecutive strings may be a laterally distal string and a laterally proximal string.

The word “consecutive” may be understood to indicate that two elements are adjacent. However, the word “consecutive” is not intended to indicate which element is sequentially previous or sequentially subsequent to the other.

The phrases “proximal” and “distal” may be understood to indicate spatial relationships. However, these phrases are not intended to indicate whether or not features are consecutive.

The lateral distance, center to center, at the saddle means, between two consecutive strings, may be understood to be a lateral string spacing. The lateral string spacing may typically be the same for any two consecutive strings; however, if the strings are spaced unevenly, an average may be used. In the case of coursed strings, such as on a twelve string guitar, a course of strings may be considered to be functionally a single string, with respect to this document.

A string, a fingerboard fret, a note, a fretting crown segment, another feature, a position of a feature, or a distance from one feature to another may be described as “intonated;” this may be descriptive of a set up with in tune function. “Intonation” and “intonate” may be understood to be a property or process related to in tune function. “To intonate” may be understood to mean locating features such that fingerboard frets and/or a fretting crown segment are in tune relative to a string.

A saddle means may be called a “saddle feature.” A fastener in the form of a screw may be called a “clamping screw.” A fastening opening in the form of a threaded hole may be called a “clamping hole.” A longitudinal slot cooperating with a fastener to lock a position of a fretting appendage may be called a “clamping slot.” An action similar to wrist fretting performed with a finger of the picking hand may be called “pinkie fretting;” both actions and other similar picking hand actions may be called “counter fretting.” An assembly may be called a “wrist fretting assembly” or a “counter fretting assembly.” A central longitudinal recess may be called an “elongated longitudinal depression.” A back of a body may be called a “backside.” A pivot may be called a “pivot feature.” A fretting appendage may be called a “fret appendage.” A freeting appendage may be called a “block,” or a “fretting block.” A fretting appendage including two fretting crown segments may be called a “tandem fret appendage.” Nominal sounding lengths and nominal oddment lengths may be called “standard calculated distances.” “Height adjustment” may be understood to mean vertical adjustment. “Height position” and “height” may be understood to mean vertical position. “Height distance” may be understood to mean vertical distance. A height adjustment hole may be called a “height positioning hole.” A nut may be called a “nut feature.” A soundboard may be called an “acoustic top,” “Longitudinally rearward critical contact point,” “rearward critical contact point,” and “critical saddle contact point” may be used interchangeably. A support may be called a “base.” A guide surface may, in some contexts, be a surface of a “guidance feature.” A body cavity may be called a body “recess.” A pickup including a distal coil and a proximal coil may be called a “divided pickup.” “Laterally adjacent” features may be understood to be laterally consecutive. A sounding length may be called a “vibrating length” or a “vibration length.” A guide surface of a longitudinal slot such as a channel may be called an “interior wall.”

Contextually, a fretting crown segment may be called a “one string fretting segment” or a “wrist-fretting crown segment;” a fretting crown may be called a “wrist fretting crown,” a “one string fret,” a “two string fret,” etc.

To avoid confusion, what may be conventionally called a “fret” on a fingerboard may be referred to as a “fingerboard fret;” a part of an assembly for use in the opposite direction may be called a “fretting crown.” A note produced at a fingerboard fret may be called a “fretted fingerboard note.” A note produced at a fretting crown may be called a “wrist fretable note” or a “wrist fretted note.”

“Rearward” and “longitudinally rearward” may be used interchangeably. “Forward” and “longitudinally forward” may be used interchangeably. “Distal” and “laterally distal” may be used interchangeably. “Proximal” and “laterally proximal” may be used interchangeably. The words “tilted” and “angled” may be understood contextually and may be used interchangeably.

For brevity, “instrument” and “strings” may be used instead of “stringed musical instrument” and a “plurality of strings.” The words “and” and “or” may be used with a full range of traditional functions including “and/or.” The term “and/or” may be used for clarity or to avoid redundancy. The words to “be,” to “comprise,” to “include,” and to “have” may be understood in a non-limiting manner.

If an illustration of a right handed instrument in a six string guitar form (tuned to standard tuning) were viewed with a forward end of its neck at the top of a page, its rearward bout at the bottom of the page, and with its strings facing the reader, its “low E” string may be the laterally leftmost of its strings, and its “high E” string may be the laterally rightmost of its strings. As understood from this orientation, strings may be indicated as “leftmost,” “second from the left,” etc.

A feature, function, or position may be described as “about,” “substantially,” or “approximately.” These may be understood to imply functionality exactly in a described position and/or orientation and within a range of variance from the described position and/or orientation. The description of some features, functions, positions, or orientations as “about,” “substantially,” or “approximately,” is not intended to imply that other features, functions, positions, or orientations not described in this manner may be differently precise. Nor is the use of these descriptions intended to imply a lack of precision; they are intended to teach the reader that a range of variations may work.

Broadly, a feature, function, position, or orientation may be understood to be “about,” “substantially,” or “approximately” as described if an associated string is playable as an open string, and/or a fingerboard fret is usable to play a fingerboard fretted note, and/or a fretting crown is usable to play a wrist fretted note. The terms “about,” “substantially,” or “approximately” refer to less than or equal to +/−1%, +/−2%, +/−3%, +/−4%, +/−5%, +/−6%, +/−7%, +/−8%, +/−9%, +/−10%, +/−11%, +/−12%, +/−14%, +/−15%, +/−20%, +/−25%, or +/−30% variation. As a non-limiting example, substantially parallel represents a range of −1 to 1 degree difference, −10 to 10 degree difference, or −30 degrees to 30 degrees of difference from being parallel, depending on the embodiments.

A first feature which is aligned with a second feature may be substantially aligned with the second feature. A first feature which aligns a second feature with a third feature may substantially align the second feature with the third feature.

A first feature which is centered under a second feature may be substantially centered under the second feature. A first feature which is centered between a second feature and a third feature may be substantially centered between the second feature and the third feature. A first feature which centers a second feature under a third feature may substantially center the second feature under the third feature. A first feature which centers a second feature between a third feature and a fourth feature may substantially center the second feature between the third feature and the fourth feature.

A feature, function, or position described as longitudinal may be understood to be substantially longitudinal. A feature which is longitudinally between two points may be exactly between the two points, or may be vertically higher or lower than and/or laterally proximal or distal to one or both of the points.

A feature, function, or position described as lateral may be understood to be substantially lateral. A feature which is laterally between two points may be exactly between the two points, or may be vertically higher or lower than and/or longitudinally forward or rearward of one or both of the points.

A feature, function, or position described as vertical may be understood to be substantially vertical. A feature which is vertical with respect to two points may be vertical with respect to both points, or may include some overlap in the vertical dimension with one or both points.

Some non-limiting examples are presented here for the convenience of the reader. In an example, a substantially longitudinal slot may run at a slight angle to a centerline of a neck or to a string. In some embodiments, a lateral end of a fretting crown is laterally between two strings; the lateral end of the fretting crown may be vertically lower than both strings and nearer to one string than the other string. In a further example, a vertical height screw or fastener may be substantially vertical; however, it may be tilted or angled as respective features, such as a fretting appendage, are tilted or angled. In another example, a pickup opening which is longitudinally between a fretting crown and fingerboard may be vertically lower than the fretting crown and the fingerboard. In a further example, a fretting crown which is centered under a string may be substantially centered under the string; it may stick out farther laterally from under one side of the string than the other, but still function for wrist fretting.

Not every feature may be visible in every figure. Some descriptions may describe features which may be distributed among several figures illustrating one or more embodiments. When a feature is described with respect to an embodiment, that description may be used to understand a similar feature in another embodiment. Some embodiments may include repeated elements. A description of a first element may be used to understand the similar nature of a second element. Some descriptions include figure numbers which are specified for teaching purposes, and other embodiments share features described with respect to the specified figures; repeated descriptions of those features may be shortened or omitted for brevity. Features described as similar may be understood to be similar to or the same as features to which they are compared. Sections organized by topic may be understood to include information on other topics. Some ranges, when comparing locations of features, may overlap and/or have different endpoints; these ranges are given as examples, to help the reader understand the embodiments; other ranges are both possible and envisioned.

Illustrations and descriptions are detailed and specific for the purpose of teaching; however, they may be understood to illustrate and inform in a non-limiting manner. Dimensions and measurements have been presented by way of example, and are not intended to limit the scope of the inventions disclosed herein. Alternatives and variations have been presented; even so, an illustration or description of every possible combination, alternative, or variation is beyond the scope of this document. Outlining some changeable characteristics is not intended to convey that all possible changes have been covered. Without departing from the teachings of this document, features, structures, devices, parts, components, and elements may be combined, omitted, substituted for one another, rearranged, added to, configured differently, altered, varied, or used independently. Without departing from the teachings of this document, steps, methods, processes, and systems may be combined, omitted, added to, substituted for one another, altered, varied, or performed in other orders. A portion or a part of a step or a feature described or illustrated in an embodiment or in an example may be combined with or used instead of a portion or a part of a step or a feature in a different embodiment or in a different example. Changes may be made to the embodiments while remaining within the scope and spirit of the teachings. The embodiments and examples provided herein are not intended to be discrete and separate from each other. All possible combinations and subcombinations of steps and features are intended to fall within the scope of this disclosure.

I claim:

1. A stringed musical instrument comprising:
a body;
a neck comprising a longitudinally rearward end connected to the body and a longitudinally forward end located away from the body;
a fingerboard connected to the neck;
a sequence of fingerboard frets on the fingerboard;
a nut disposed on the longitudinally forward end of the neck;
a saddle means positioned on the body;
a block adjustably positionable on the body, wherein the block comprises a fretting crown and a pivot longitudinally spaced from the fretting crown; and
a string contacting the nut, extending above the fingerboard and the fretting crown, and contacting the saddle means,
wherein a vertical position of the fretting crown is adjustable relative to the string by pivoting the block on the pivot, and
wherein the fretting crown is positionable to define a wrist fretable note a semitone above an open note of the string.

2. The stringed musical instrument of claim 1, wherein the pivot is located longitudinally between the fretting crown and the saddle means.

3. The stringed musical instrument of claim 1, wherein the pivot is configured to support the block on the body at least at two points.

4. The stringed musical instrument of claim 1, wherein the pivot is configured to support the block on the body at least at a first point, and
wherein the first point is within 80 millimeters (mm) of a longitudinally rearward critical contact point of the string on the saddle means.

5. The stringed musical instrument of claim 1, wherein a longitudinal position of the block is adjustable relative to the saddle means.

6. The stringed musical instrument of claim 1, further comprising a height screw configured to adjust the vertical position of the fretting crown by pivoting the block on the pivot.

7. The stringed musical instrument of claim 1, further comprising a fastener configured to lock the vertical position of the fretting crown.

8. A stringed musical instrument comprising:
a body;
a neck comprising a longitudinally rearward end connected to the body and a longitudinally forward end located away from the body;
a fingerboard connected to the neck;
a sequence of fingerboard frets on the fingerboard;
a nut disposed on the longitudinally forward end of the neck;
a saddle means positioned on the body;
a block comprising a fretting crown, wherein the block is adjustably positionable on the body;
a string contacting the nut, extending above the fingerboard and the fretting crown, and contacting the saddle means; and
a fastener configurable in a non locking configuration and in a locking configuration,
wherein, when the fastener is in the non locking configuration, i) a longitudinal position of the block is adjustable relative to the saddle means, and ii) a vertical position of the fretting crown is adjustable relative to the string,
wherein, when the fastener is in the locking configuration, the fastener fixes the longitudinal position of the block and the vertical position of the fretting crown, and
wherein the fretting crown is positionable to define a wrist fretable note a semitone above an open note of the string.

9. The stringed musical instrument of claim 8, further comprising a support and an insert connected to the support,
wherein the support is coupled to the body,
wherein the block further comprises a slot configured to receive the insert, and
wherein, with the insert inserted in the slot and with the fastener in the non locking configuration, the longitudinal position of the block is adjustable by manipulating the block, via the slot, along the insert.

10. The stringed musical instrument of claim 8, further comprising a support coupled to the body,
wherein the support comprises a substantially longitudinal slot, and
wherein, when the fastener is in the non locking configuration, the longitudinal position of the block is adjustable by manipulating the block along the slot.

11. The stringed musical instrument of claim 8, wherein the body is hollow and comprises a soundboard, and
wherein the fastener is configurable to couple the block to the soundboard.

12. The stringed musical instrument of claim 8, further comprising a shim configured to adjust the vertical position of the fretting crown by being inserted between the body and the block.

13. The stringed musical instrument of claim 8, further comprising a support coupled to the body, wherein the support comprises an opening configured to receive the fastener.

14. The stringed musical instrument of claim 8, wherein the block further comprises an opening configured to receive the fastener.

15. A stringed musical instrument comprising:
a body;
a neck comprising a longitudinally rearward end connected to the body and a longitudinally forward end located away from the body;
a fingerboard connected to the neck;
a sequence of fingerboard frets on the fingerboard;
a nut disposed on the longitudinally forward end of the neck;
a saddle means positioned on the body;
a block comprising a fretting crown,
a plurality of strings, each i) contacting the nut, ii) extending above the fingerboard, and iii) contacting the saddle means,
wherein the plurality of strings are laterally spaced from one another,
wherein a lateral string spacing is defined by a spacing, at the saddle means, between two consecutive strings of the plurality of strings,
wherein the block is adjustably positionable on the body, with the fretting crown disposed i) longitudinally forward of the saddle means and ii) under a proto string of the plurality of strings,
wherein the block has a lateral width less than 200% of the lateral string spacing,
wherein the block is positionable such that the fretting crown defines a wrist fretable note a semitone above an open note of the proto string, and
wherein a vertical position of the fretting crown is adjustable relative to the proto string.

16. The stringed musical instrument of claim 15, wherein the block is a first block, and the fretting crown is a first fretting crown,
wherein the stringed musical instrument further comprises a second block,
wherein a deutero string of the plurality of strings is consecutive to the proto string,
wherein the second block comprises a second fretting crown, and
wherein the second block is adjustably positionable i) on the body, ii) with the second fretting crown under the deutero string, and iii) such that the second fretting crown defines a wrist fretable note a semitone above an open note of the deutero string.

17. The stringed musical instrument of claim 15, wherein a deutero string of the plurality of strings is consecutive to the proto string,
wherein the block comprises a first lateral side and a second lateral side opposite the first lateral side, and
wherein the first lateral side is laterally between the proto string and the deutero string.

18. The stringed musical instrument of claim 15, further comprising a support coupled to the body and an insert connected to the support,
wherein the block further comprises a slot configured to receive the insert, and
wherein, with the insert inserted in the slot, a longitudinal position of the block is adjustable by manipulating the block, via the slot, along the insert.

19. The stringed musical instrument of claim 15, further comprising a support coupled to the body,
wherein the support comprises a substantially longitudinal slot, and
wherein a longitudinal position of the block is adjustable by manipulating the block along the slot.

20. The stringed musical instrument of claim 15, wherein the body is hollow and comprises a soundboard, and
wherein the block is configured to couple to the soundboard.

21. The stringed musical instrument of claim 15, further comprising a fastener configurable in a non locking configuration and in a locking configuration,
wherein, when the fastener is in the non locking configuration, a longitudinal position of the block is adjustable relative to the saddle means,
wherein, when the fastener is in the locking configuration, the fastener fixes the longitudinal position of the block.

22. The stringed musical instrument of claim 15, wherein a longitudinal position of the block is adjustable relative to the saddle means.

23. The stringed musical instrument of claim 15, further comprising a height screw configured to adjust the vertical position of the fretting crown relative to the proto string.

24. A stringed musical instrument comprising:
a body;
a neck comprising a longitudinally rearward end connected to the body and a longitudinally forward end located away from the body;
a fingerboard connected to the neck;
a sequence of fingerboard frets on the fingerboard;
a nut disposed on the longitudinally forward end of the neck;
a saddle means positioned on the body;
a block comprising a fretting crown, wherein the block is adjustably positionable on the body;
a string contacting the nut, extending above the fingerboard and the fretting crown, and contacting the saddle means; and
a height screw configured to adjust a vertical position of the fretting crown,
wherein turning the height screw in a first direction adjusts the vertical position of the fretting crown upward, moving the fretting crown toward the string,
wherein turning the height screw in a second direction adjusts the vertical position of the fretting crown downward, moving the fretting crown away from the string,
wherein a longitudinal position of the block is adjustable relative to the saddle means,
wherein the height screw is further configured to support the vertical position of the fretting crown during adjustment of the longitudinal position of the block; and
wherein the fretting crown is positionable to define a wrist fretable note a semitone above an open note of the string.

25. The stringed musical instrument of claim 24, wherein the block further comprises a height adjustment hole configured to receive the height screw.

26. The stringed musical instrument of claim 24, further comprising a support coupled to the body,
wherein the support further comprises a height adjustment hole configured to receive the height screw.

27. The stringed musical instrument of claim 24, further comprising a support and an insert connected to the support,
wherein the support is coupled to the body,
wherein the block further comprises a slot configured to receive the insert, and
wherein, with the insert inserted in the slot, the longitudinal position of the block is adjustable by manipulating the block, via the slot, along the insert.

28. The stringed musical instrument of claim 24, further comprising a support coupled to the body,
wherein the support comprises a substantially longitudinal slot, and
wherein the longitudinal position of the block is adjustable by manipulating the block along the slot.

29. The stringed musical instrument of claim 24, further comprising a fastener,
wherein the fastener has a non locking configuration and a locking configuration,
wherein, when the fastener is in the non locking configuration, the longitudinal position of the block is adjustable relative to the saddle means, and
wherein, when the fastener is in the locking configuration, the fastener fixes the longitudinal position of the block.

30. The stringed musical instrument of claim 24, further comprising a fastener,
wherein the fastener has a non locking configuration and a locking configuration,
wherein, when the fastener is in the non locking configuration, the vertical position of the fretting crown is adjustable relative to the string, and
wherein, when the fastener is in the locking configuration, the fastener fixes the vertical position of the fretting crown.
